(19) United States
(12) Patent Application Publication
(10) Pub. No.: US 2016/0182667 A1
(43) Pub. Date: Jun. 23, 2016

(54) Management Application for an Application Router

(71) Applicants: Tobias Gregor Oberstein, Herzogenaurach (DE); Alexander Goedde, Furth (DE)

(72) Inventors: Tobias Gregor Oberstein, Herzogenaurach (DE); Alexander Goedde, Furth (DE)

(21) Appl. No.: 14/576,307

(22) Filed: Dec. 19, 2014

(51) Int. Cl. H04L 29/08; H04L 12/58; H04L 12/917; H04L 12/721

(52) U.S. Cl. CPC H04L 67/2809; H04L 45/44; H04L 51/32; H04L 47/76; H04L 67/1087

(57) ABSTRACT

Computing systems, methods and other implementations for a management application for application routers are described herein. Application routers route messages between application components. The messages employ a protocol which offers both the Publish-and-Subscribe (PubSub) and the Call-and-Register (CallReg) messaging pattern. A management application issues and receives messages which initiate a management operation on an application router and provide feedback on a management operation on an application router.

### FIELD OF THE INVENTION

The embodiments described herein relate to a management application for application routers.

### BACKGROUND

Application functionality is often spread across application components on multiple systems, and may be implemented using several programming environments.

These application components need to communicate with each other in order to exchange information and give access to their functionality.

### SUMMARY

Computing systems, methods and other implementations for a management application for application routers are described herein. Application routers route messages between application components. The messages employ a protocol which offers both the Publish-and-Subscribe (PubSub) and the Call-and-Register (CallReg) messaging pattern. A management application issues and receives messages which initiate a management operation on an application router and provide feedback on a management operation on an application router.

### BRIEF DESCRIPTION OF THE DRAWINGS

FIG. 1 is a diagram of a computing system suitable for an embodiment.

FIG. 2 is a diagram of an application which comprises application components.

FIG. 3 is a diagram of a registration as part of a Call-and-Register pattern.

FIG. 4 is a diagram of a call and invocation as part of a Call-and-Register pattern.

FIG. 5 is a diagram of a yield and a result as part of a Call-and-Register pattern.

FIG. 6 is a diagram of two subscribes as part of a Publish-and-Subscribe pattern.

FIG. 7 is a diagram of a publish as part of a Publish-and-Subscribe pattern.

FIG. 8 is a diagram of two events as part of a Publish-and-Subscribe pattern.

FIG. 9 is a diagram of a register of a procedure with a dealer.

FIG. 10 is a diagram of calling a procedure via a dealer.

FIG. 11 is a diagram of the return of a procedure result via a dealer.

FIG. 12 illustrates a caller and callee system.

FIG. 13 illustrates a caller and callee system including a dealer.

FIG. 14 is a diagram of subscribing with a broker.

FIG. 15 is a diagram of publishing via a broker.

FIG. 16 is a diagram of dispatching events by a broker.

FIG. 17 is a diagram of calling a procedure via an application router, where the application router forwards the call to a callee.

FIG. 18 is a diagram of publishing an event to an application router, and the application router dispatching the event to subscribers.

FIG. 19 is a diagram of an application router comprising a database.

FIG. 20 is a diagram of an application router contained in an application.

FIG. 21 is a diagram of WAMP clients connected to a WAMP router.

FIG. 22 is a diagram illustrating WAMP roles.

FIG. 23 is a diagram of a WAMP connection over a transport.

FIG. 24 is a message sequence chart for a Call-and-Register sequence.

FIG. 25 is a message sequence chart for a Publish-and-Subscribe sequence.

FIG. 26 is a diagram of a management application communicating with an application router.

FIG. 27 is a diagram of a management application communicating with several application routers.

FIG. 28 is a diagram showing various user interfaces and controllers communicating with a management application.

FIG. 29 is a diagram of a single controller connected to two management applications.

FIG. 30 is a diagram of various parts of a system of an application, application router and management application with frontends and a controllers distributed across computing systems.

FIG. 31 illustrates Publish-and-Subscribe events between components.

FIG. 32 illustrates a configuration event between a management application and an application router.

FIG. 33 illustrates Publish-and-Subscribe events between components post a configuration event.

FIG. 34 is a flow chart for a configuration event in a management application.

FIG. 35 illustrates Publish-and-Subscribe events between components.

FIG. 36 illustrates a monitoring start event between a management application and an application router.

FIG. 37 illustrates Publish-and-Subscribe events and monitoring events between components post a monitoring start event.

FIG. 38 is a flow chart for a monitoring start event in a management application.

FIG. 39 is a flow chart for the reception of monitoring data in a management application.

FIG. 40 is a diagram showing part of a configuration change.

FIG. 41 is a diagram showing part of a configuration change.

FIG. 42 is an illustration for a user interface for setting permissions.

FIG. 43 is a diagram of a Crossbar.io node.

FIG. 44 is a diagram of a Crossbar.io node.

FIG. 45 is a diagram of a Crossbar.io node.

FIG. 46 is a message sequence chart for a procedure call.

FIG. 47 is a diagram of a Crossbar.io node and management application.

FIG. 48 is a message sequence chart for a procedure call.

FIG. 49 is a diagram of a Crossbar.io node and management application.

FIG. 50 is a message sequence chart for a procedure call.

FIG. 51 is a diagram of a Crossbar.io node and management application.

FIG. 52 is a diagram of a Crossbar.io node and management application.

FIG. 53 is a message sequence chart for a forwarded procedure call.

FIG. 54 is a message sequence chart for a procedure call relayed via an adapter.

FIG. 55 is a diagram of applications running in a virtual machine.

FIG. 56 is a diagram of applications running in containers.

FIG. 57 is a diagram of application components running in containers.

FIG. 58 is a diagram of application components running in containers on a system running Crossbar.io.

FIG. 59 is a diagram of containers and a container management component.

FIG. 60 is a diagram of a Crossbar.io node.

FIG. 61 is a diagram of a Crossbar.io node and an application component.

### DETAILED DESCRIPTION

Described herein are a computing system and a method suitable for a management application for an application router. In the course of this description, reference is made to the accompanying drawings that form a part hereof. Like reference numerals are used to refer to like elements throughout.

While specific configurations, features and arrangements are shown in the drawings and discussed, this is done for illustrative purposes only. A person skilled in the art will recognize that they may practice other embodiments of the invention without one or more of the steps, features or components described below, and that other configurations, features and arrangements may be used without departing from the spirit and scope of the invention.

For the sake of brevity, certain well-known details often associated with computing and software technology are not set forth in the following disclosure. In some cases, well-known structures and devices are shown in block diagram form in order to facilitate describing these elements.

In addition, the embodiments described herein may be implemented as a method or apparatus using commonly known programming and/or engineering techniques to produce software, firmware, hardware or any combination thereof to control a computer to implement the disclosed embodiments.

### Computing System

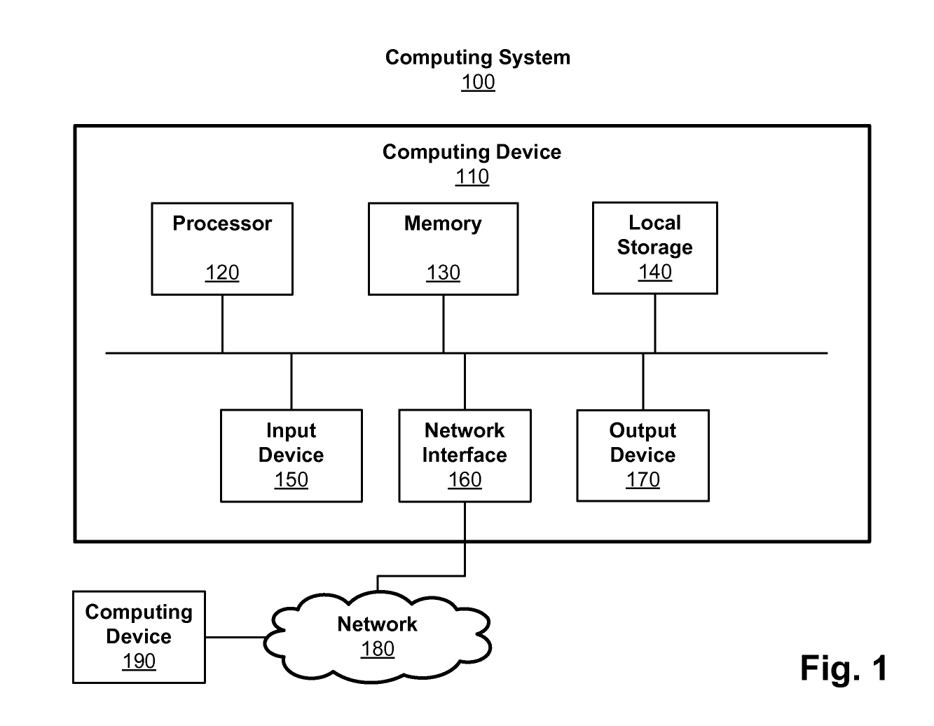

FIG. 1 is a block diagram of a suitable computing system 100 for implementing embodiments. The computing system includes at least one computing device 110 that may be connected to one or more remote computing devices 190 via a network interface 160 and network 180. This network can be any type of network including an INFINIBAND® connection, Ethernet network, Wi-Fi network, GSM network, 3G network or 4G network. Network interface 160 may be a physical device within the computing system, or may be virtualized, e.g. be a TCP loopback device.

Computing device 110 includes at least one processor 120 and a memory 130. Computing device 110 may further include a local storage 140, which can be a computer-readable medium. The term “computer-readable medium” refers to any medium that can be part of the process of providing instructions to a processor for execution. This can, amongst others, include non-volatile media (e.g. magnetic or optical disks, flash memory), but excludes transitory signals. The computer readable medium does not need to be locally connected to the computing device, but may also reside on a remote computing device connected via a network. Computing device 110 may also include an input device 150 and an output device 170. Examples of input devices include keyboards, mice, touch screens and voice input, while examples of output devices include graphical displays and audio speakers.

It will be appreciated that while here a single processor, memory, local storage, input device, output device and network interface are shown, computing devices suitable for implementing embodiments may contain multiple instances of each.

It will further be appreciated that computing devices such as 110 may be physical devices as well as a virtualized devices. Virtualization may occur as a simulation of the components of a computing device on another computing device, via an access mechanism for the underlying hardware of the virtualization host, as a combination of both, or using other mechanisms known in the art.

### Application Components

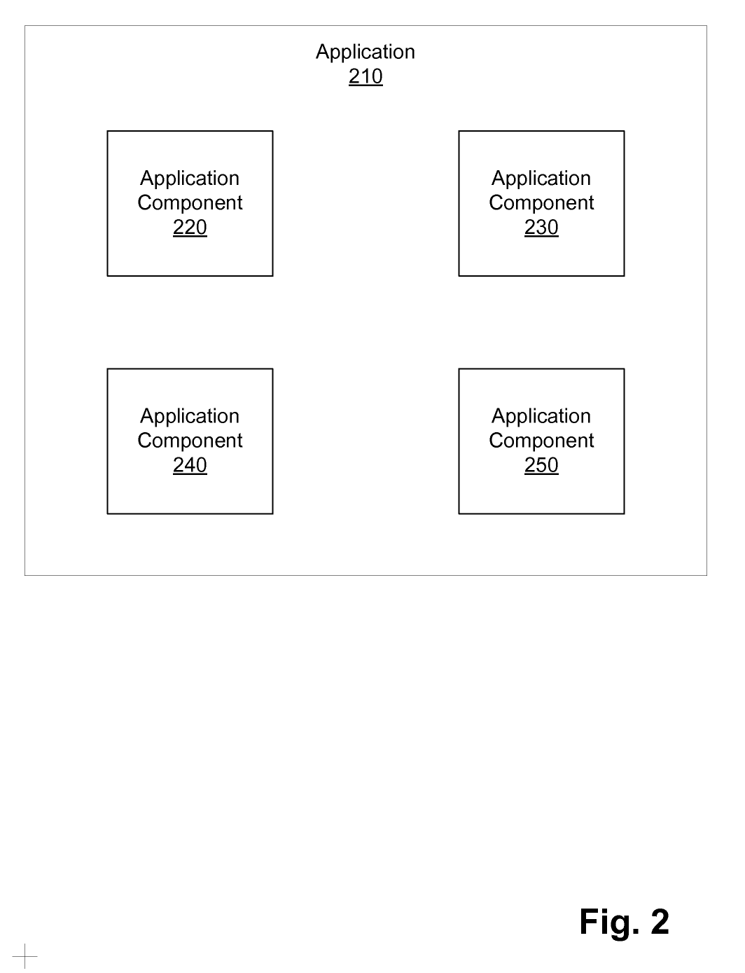

FIG. 2 illustrates an application 210 which comprises application components. An application can be any collection of computer code which, as a whole, provides a set of functionality. Application 210 comprises application components 220, 230, 240 and 250. Application components are collections of computer code which provide a set of functionality to the application. As an example, in an electronic sales application, individual application components could handle accepting user input, parsing and filtering said user input, creating orders based on the parsed data, sending the orders to an order fulfillment system, and storing the orders for archival and auditing purposes. To stay within this example, if the application were to run on a device with multiple input devices, e.g. a touch screen and a keyboard, then handling user input from each of these input devices could be handled by separate application components. The preceding example is given only in the way of illustration. The distribution of application functionality to application components may be decided taking various factors into consideration, such as how application functionality is logically connected, the system or systems the application is being executed on, the language or languages the application is being written in, frameworks, libraries or other tools used in the development, and general or specific architectural and design principles followed during development. For any given application, there are a large number of different ways of structuring application components it comprises.

### Call-and-Register

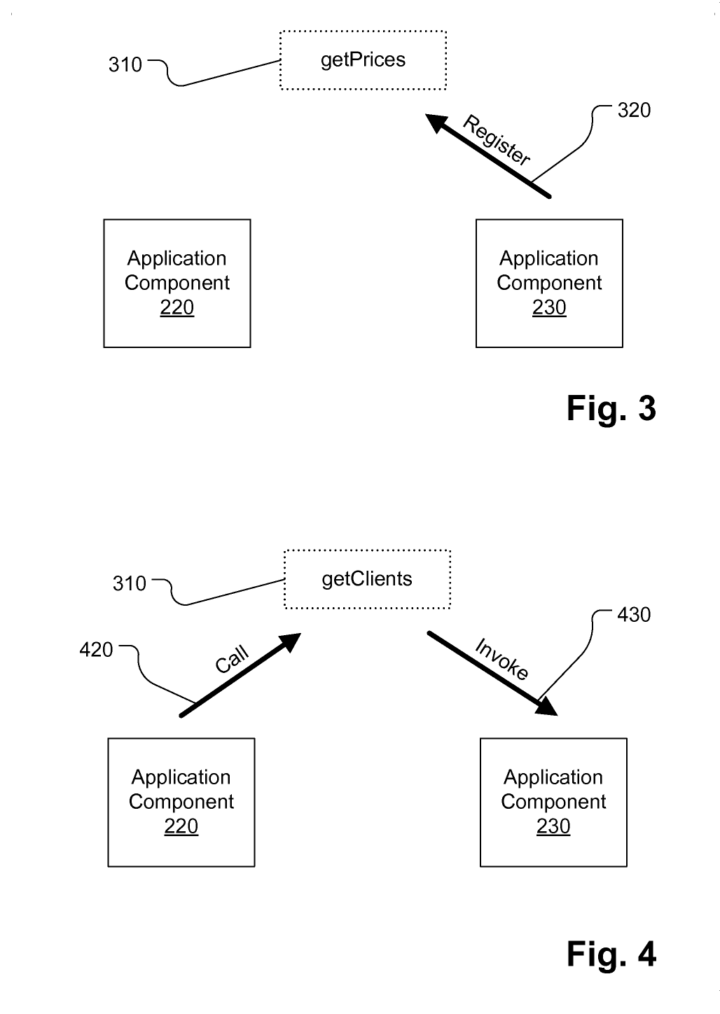

FIGS. 3 to 5 are diagrams illustrating a Call-and-Register communication pattern for application components. A procedure is a set of instructions which is executed when called, and which returns a result to the caller. Call-and-Register is generally a 1-to-1 communication pattern, connecting a single caller and callee. It is further a request and response pattern, i.e. there is a single response for each request.

In FIG. 3, an application component 230 (the ‘callee’) sends a registration 320 for a procedure. Based on the registration, an identifier 310 is assigned which can be used to call the procedure. The identifier here is the string “getPrices”. This is only by way of example. The particular means of identification chosen in an embodiment may be any which is technically available within the technical environment in which the embodiment is implemented.

In FIG. 4, an application component 220 ('caller') sends a call 420 for a procedure. This call uses the identifier 310. Based on this call, application component 230 ('callee') receives an invocation 430 of the registered procedure.

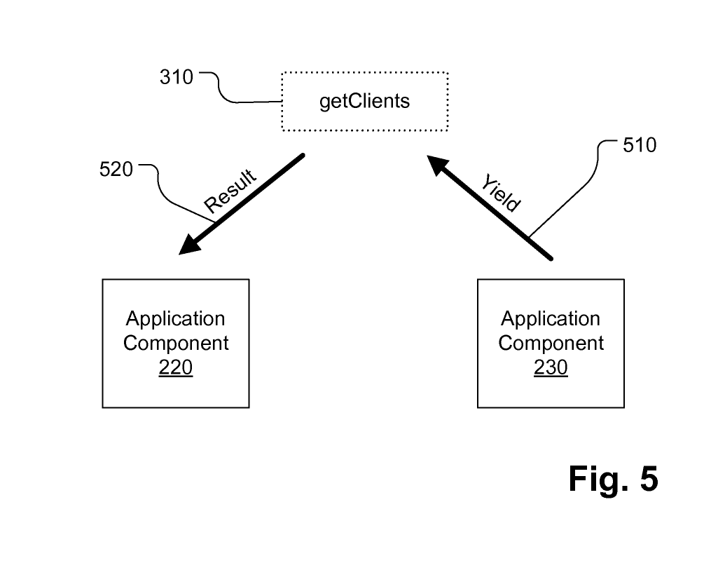

In FIG. 5, application component 230 sends a yield 510 of a result based on the execution of the registered procedure, and based on this yield 510, application component 220 receives a result 520.

It will be appreciated that details of implementations of the Call-and-Register pattern may depend on factors including the system or systems the participating application components are being executed on, the language or languages the application components are implemented in, the type or types of connecting mechanisms available, and the specifics of the procedures called and the data sent and received as part of the call.

It will further be appreciated that while here the Call-and-Register pattern is illustrated between application components which are comprised in a single application, this is only by way of example. The pattern may be employed in other environments. This includes using the Call-and-Register pattern where application components are part of different applications.

### Publish-and-Subscribe

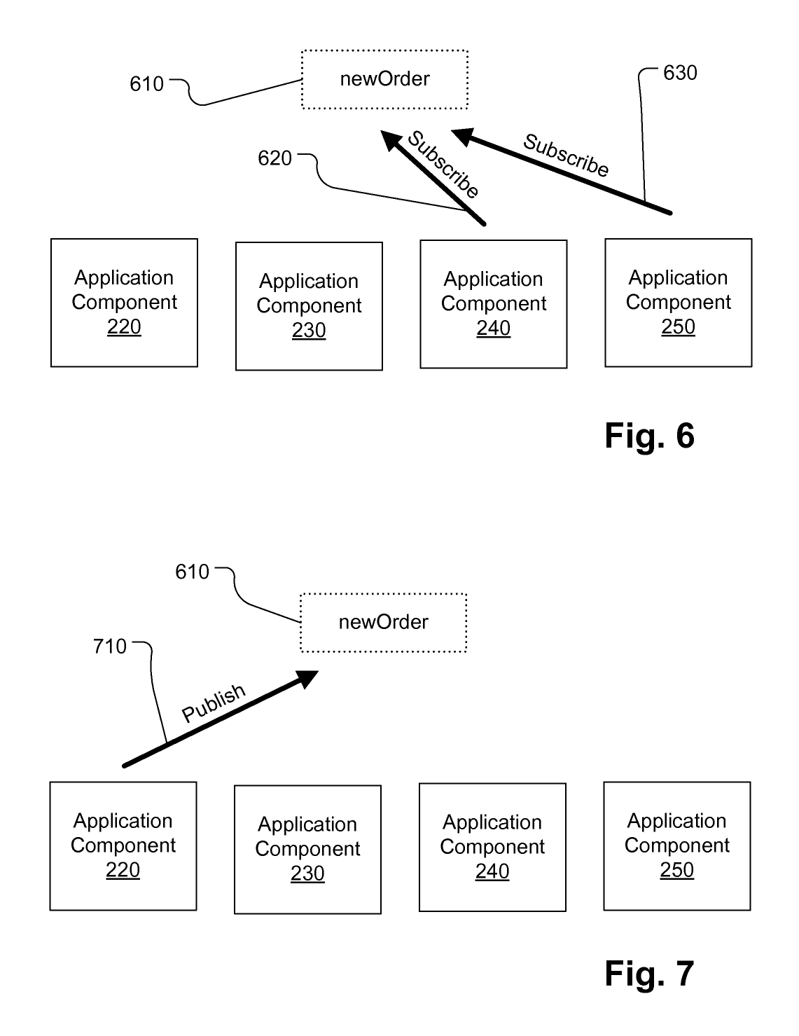

FIGS. 6 to 8 are diagrams illustrating a Publish-and-Subscribe (PubSub) communication pattern for application components. Publish-and-Subscribe is a 1-to-many communication pattern, i.e. a single publication event by a single publisher can be received by any number of subscribers. It is further a notification pattern, i.e. subscribers can receive any number of published events based on a single subscription action, without the need for any participatory action before each individual receipt.

In FIG. 6, application components 240 and 250 send subscriptions 620 and 630 for a topic 610. They are now ‘subscribers’ to this topic. Topic 610 is here identified by a string, “newOrder”. It will be appreciated that this is only by way of example. The particular means of identification chosen in an embodiment may be any which is technically available within the technical environment in which the embodiment is implemented.

In FIG. 7, application component 220 sends a publication 710 to topic 610. Application component 220 fulfills the role of ‘publisher’.

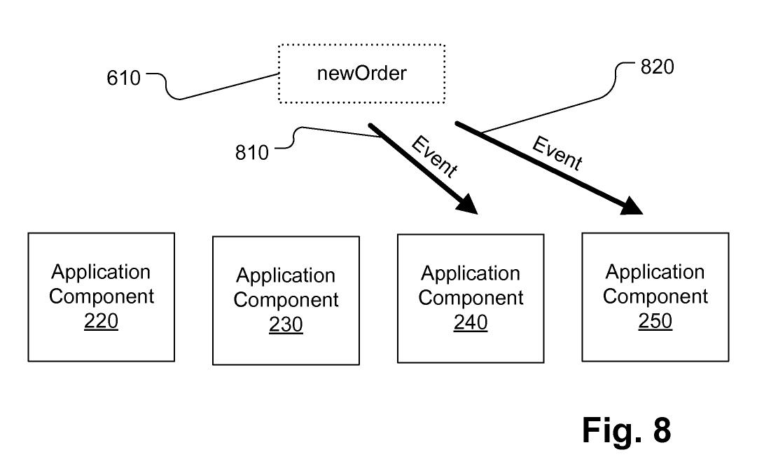

In FIG. 8, application components 240 and 250, which are subscribed to topic 610, receive events 810 and 820 based on the previous publication 710. Application components 220 and 230, which are not subscribers for this topic, do not receive events.

It will be appreciated that details of implementations of the Publish-and-Subscribe pattern depend on factors including the system or systems the participating application components are being executed on, the language or languages the application components are implemented in, the type or types of connecting mechanisms available, and the specifics of the events and the data sent and received as part of the publications and events.

It will further be appreciated that while here the Publish-and-Subscribe pattern is illustrated between application components which are comprised in a single application, this is only by way of example. The pattern may be employed in other environments. This includes using the Publish-and-Subscribe pattern where application components are part of different applications.

### Dealer

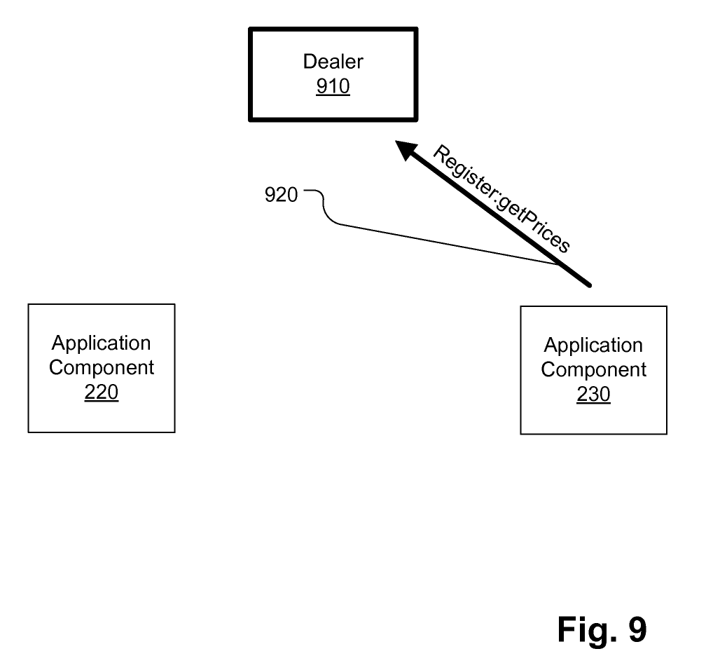

FIGS. 9-11 illustrate an implementation of the Call-and-Register pattern employing a dealer.

In FIG. 9, application component 230 sends a registration 920 to dealer 910. This registration informs dealer 910 that application component 230 offers a procedure as callable. The registration further informs the dealer that this procedure shall be identified by the ID “getPrices”. The procedure is now registered with dealer 910, under the identifier “getPrices”.

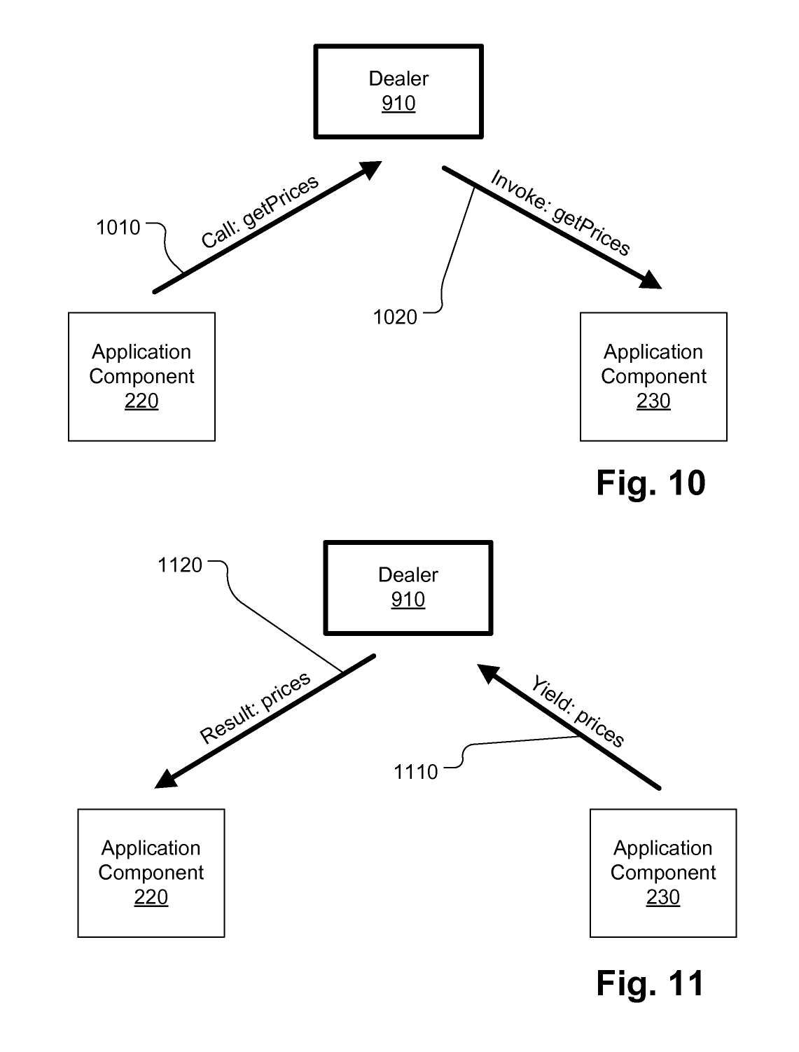

In FIG. 10, application component 220 issues a call 1010 for this procedure. Dealer 910 then in turn sends a call 1020 for this procedure to application component 230 (it “invokes” it). In FIG. 11, application component 230 has executed the called procedure and sends a return 1110 of the result to dealer 910 (it “yields” the result). Dealer 910 then sends a return 1120 of the result to the original caller, application component 220.

It will be appreciated that while here a single application component is shown registering a procedure, embodiments may allow for registration of a procedure by multiple application components. Scenarios where such multiple registrations may be employed include the dealer distributing subsequent calls to different application components (e.g. for load balancing), an additional second registration being used as a hot stand-by in case the application component with the primary registration disconnects, a call being issued to all registered components with a collection of the results being returned to the caller, or the registration containing additional information which allows routing of certain calls to certain registered application components (e.g. based on call arguments in the case of database sharding, where application components registering the same procedure each have access to subsets of a larger data set).

It will also be appreciated that here the messages which are part of a Call-and-Register pattern are shown functionally only. Implementations of messages in embodiments may depend on factors such as the system or systems the participating application components and the dealer are being executed on, the language or languages the application components and the dealer are implemented in, the type or types of connecting mechanisms available, specifics of the procedures called and the data sent and received as part of the Call-and-Register pattern. Depending on the type of procedure, the identification of the procedure as part of the call and invocation may be sufficient, e.g. for procedures that do not require any arguments to be passed to them. Other procedures may require such arguments to be passed.

It will further be appreciated that while here a single yielding and return of a result is illustrated, implementations of the Call-and-Register pattern calls may allow a set of these. For example, for a large set of data as the result of a procedure, the procedure may yield and the dealer return the set in smaller chunks, which enables the caller to e.g. display the results to a user incrementally instead of delaying processing and display until the entire set has been received. In these cases a mechanism needs to exist to signal that the last yield in the set completes the result for the call.

It will be then appreciated that when here dealer 910 is shown as a single object, this is a schematic functional illustration. A dealer is a set of functionality. In embodiments, a dealer may form part of a larger application as well as be its own application. Similarly, in embodiments the dealer functionality may be implemented by several components, and these in turn may be distributed across several computing devices of a computing system, while to callers and callees the dealer still presents as a single functional unit.

It should be appreciated that when here application components register a procedure for calling, calling said procedure is not limited to calls made by other application components. A component may itself call a procedure it registered, with the call being routed by an application router, instead of using a direct mechanism within the application component to effect such a call.

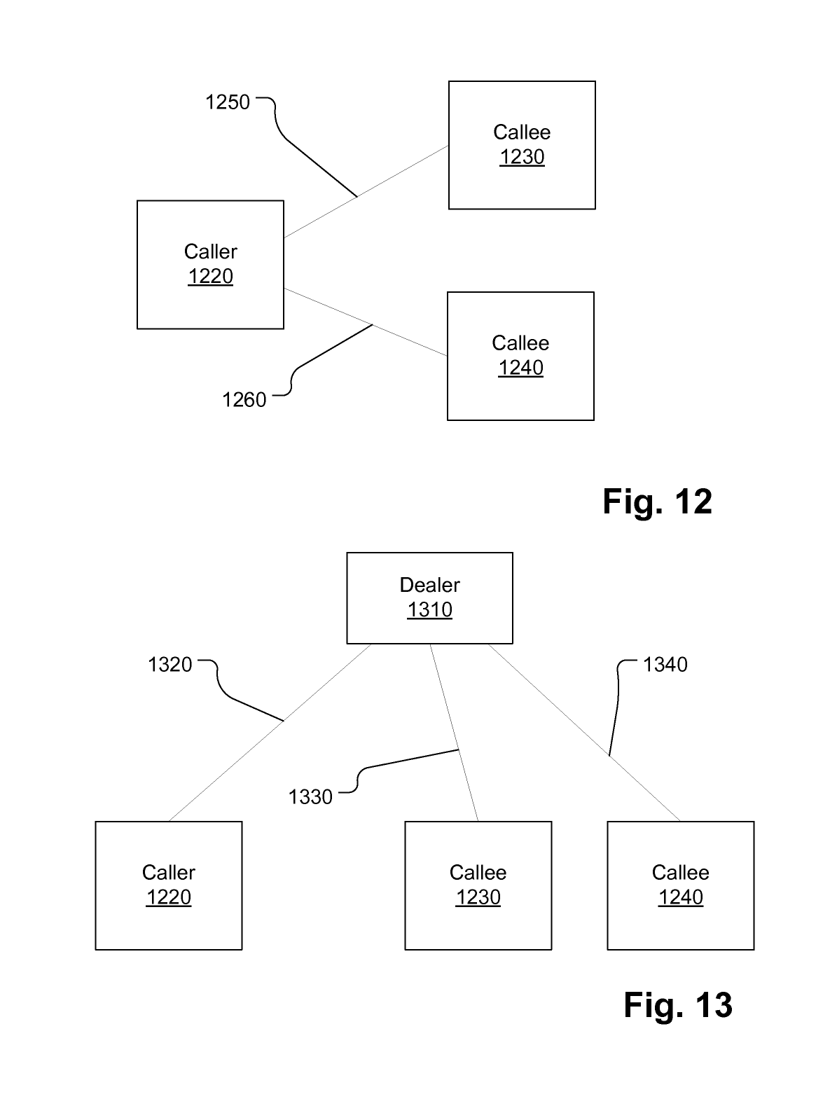

FIGS. 12 and 13 illustrate a caller and callee system with one caller and two callees, where FIG. 12 illustrates this without a dealer. Callee 1230 and 1240 each offer a procedure to call, and caller 1220 calls these. In FIG. 12, without a dealer, caller 1220 needs to establish a logical connection with each of the callees, connections 1250 and 1260. In FIG. 13, with a dealer 1310, caller 1220 only needs to establish a single logical connection (1320) with dealer 1310, which in turn is connected to callees 1230 and 1240 via logical connections 1330, 1340. With direct connections as in FIG. 12, the number of logical connections a caller needs to handle equals the number of callees he needs to call, and similarly, and vice versa. With routed calls as in FIG. 13, each caller and callee only needs to handle a single logical connection, that to the dealer, irrespective of how many callees it wishes to call or how many callers it needs to receive calls from. With direct connections, each caller needs to have information which callee offers which procedure, as well as information how to establish connections to them. With routed calls, callers and callees only need to have the knowledge necessary to connect to the dealer.

### Broker

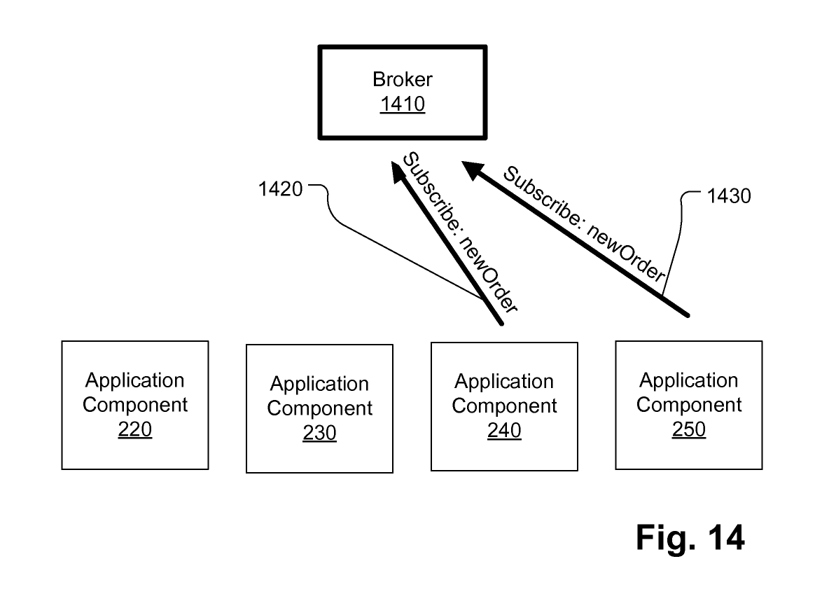

FIGS. 14-16 illustrate an implementation of the Publish-and-Subscribe pattern employing a broker.

In FIG. 14, application components 240 and 250 send subscription requests 1420 and 1430 to broker 1410. These subscription requests are for a topic “newClient”. Application components 240 and 250 are now subscribers to this topic.

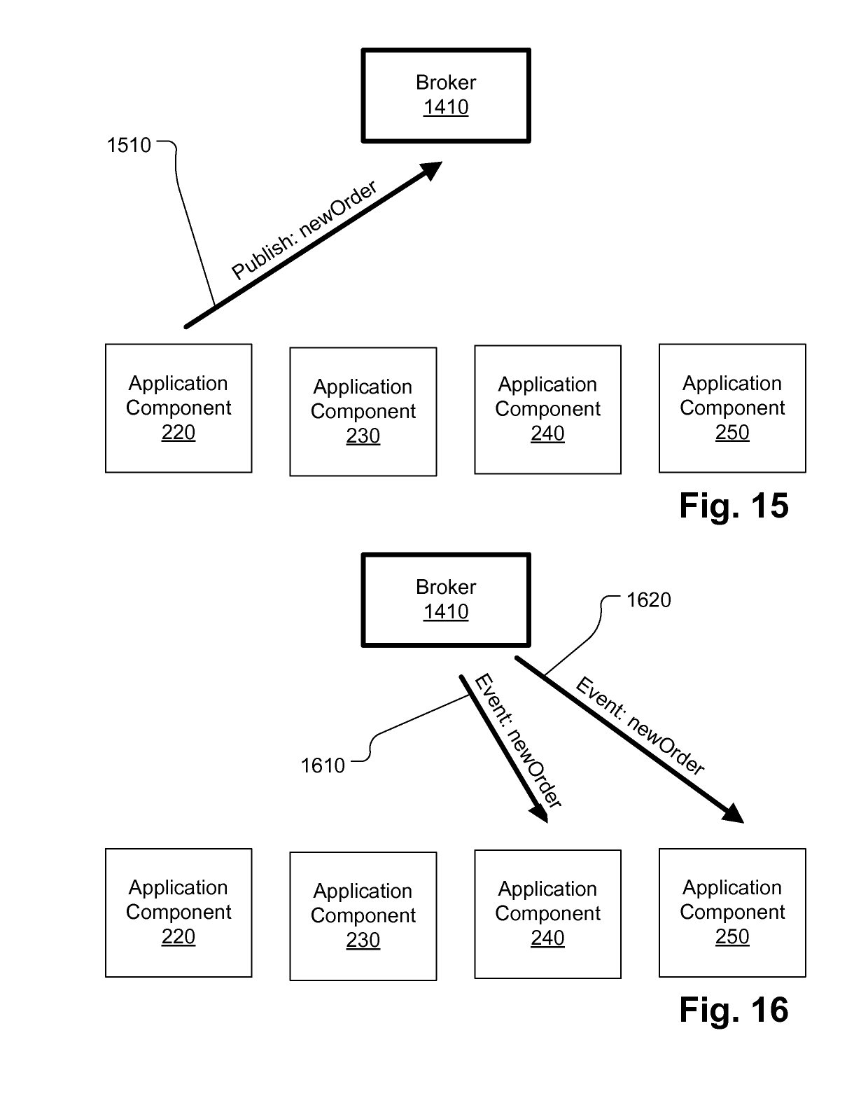

In FIG. 15, application component 220 publishes an event 1510 for topic “newClient” to broker 1410.

In FIG. 16, broker 1410 dispatches events 1610 and 1620 for topic “newOrder” to application components 240 and 250. It does not dispatch the event to application components 220 and 230, since neither of these are subscribers to the topic.

It will be appreciated that here the messages which are part of a Publish-and-Subscribe pattern are shown functionally only. Implementations of messages in embodiments may depend on factors such as the system or systems the participating application components and the broker are being executed on, the language or languages the application components and the broker are implemented in, the type or types of connecting mechanisms available, specifics of the topics allowed and used, and the data sent as part of the Publish-and-Subscribe pattern.

It will further be appreciated that when here broker 1410 is shown as a single object, this is a schematic functional illustration. A broker is a set of functionality. In embodiments, a broker may form part of a larger application as well as be an application which contains just broker functionality. Similarly, in embodiments the broker functionality may be implemented by several components, and these in turn may be distributed across several computing devices in a computing system, while to publishers and subscribers the broker still presents as a single functional unit.

It will also be appreciated that while here only application components other than the application component publishing to a topic are shown as receiving an event based on the publication, an event may also be dispatched to the publishing application component itself, if this component is subscribed to the topic of the publication. Such dispatch of an event may be configurable, and such configuration may be on a per-publication level.

### Application Router

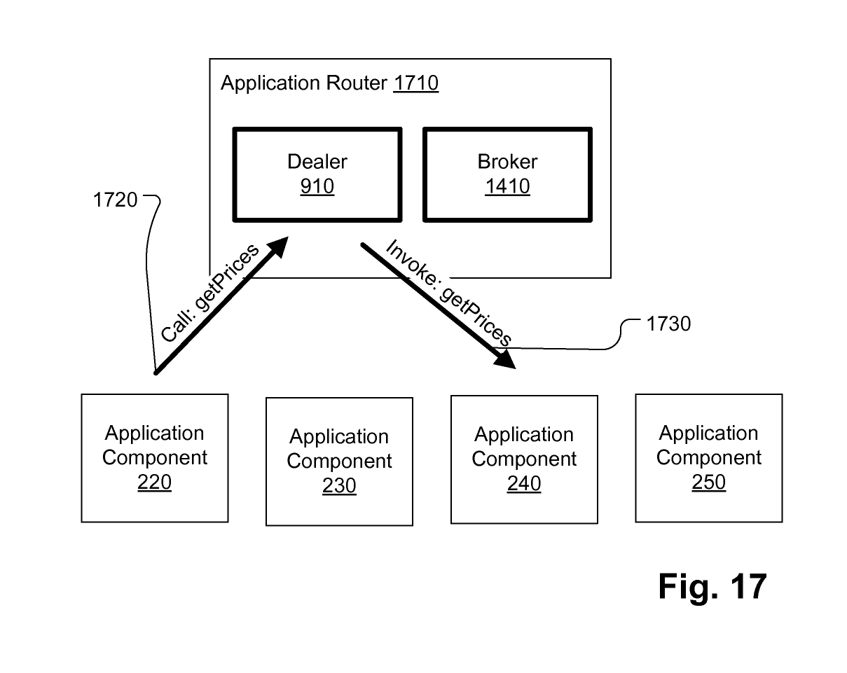

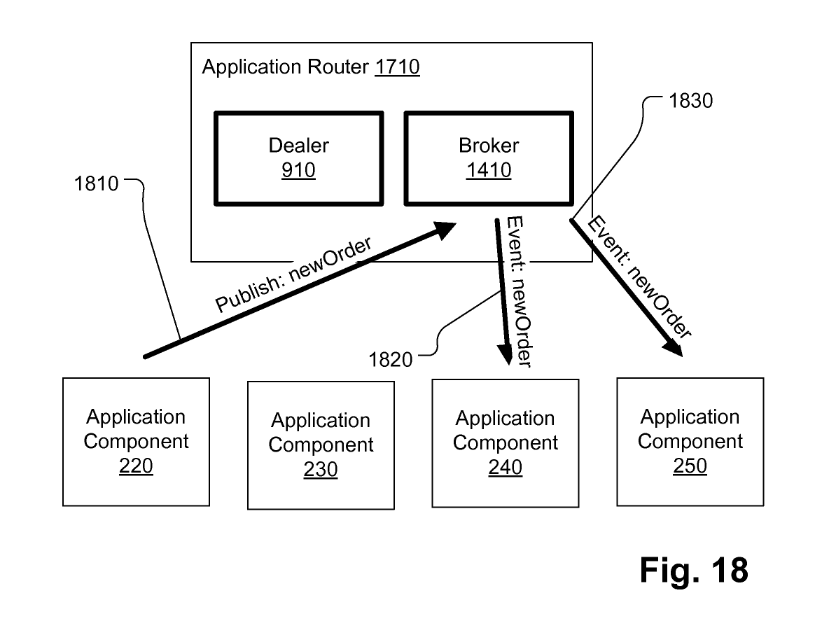

FIGS. 18 and 17 illustrate an application router as part of an embodiment, where the application router provides routing for application components using both a Call-and-Register and a Publish-and-Subscribe pattern.

In FIG. 17, an application router 1710 comprises a dealer 910 and a broker 1410. Application components 220, 230, 240 and 250 are connected to application router 1710. Application component 220 issues a call 1720 to application router 1710 for a procedure “getClients”. Within application router 1710, call 1720 is handled by dealer 910, which causes an invocation 1730 of the called procedure to be sent to application component 240. It will be appreciated that a previous registration of procedure “getClients” by application component 240, on which registration the invocation of the function is based, is not illustrated for briefness' sake.

In FIG. 18, application component 220 sends a publication 1810 for topic “newClient” to application router 1710. Within application router 1710, this publication is handled by broker 1410. Based on previous subscription requests by application components 240 and 250 (not illustrated), broker 1410 causes the dispatches of events 1820 and 1830 for the topic “newClient” to application components 240 and 250.

Different protocols may be employed for the Call-and-Register and the Publish-and-Subscribe messages. These then require one logical connection per protocol. It will be appreciated that when here logical connections are mentioned for different protocols, then this does not refer to physical connections or to base or encapsulating transport protocols over such a physical connection. A physical connection, such as a wired or wireless connection, may be used to transport several logical connections. The transport of these logical connections may use one or more layers of protocols underneath the protocol which is used for the logical connection which transports the Call-and-Register or Publish-and-Subscribe messages. Logical connections each come with their own resource overheads, which may include bandwidth requirements on the physical connection, latency increases on the physical connection or transport layers, and memory and processor requirements for handling the protocol of the logical connection.

Alternatively, the messages for both the Call-and-Register and the Publish-and-Subscribe pattern may be transmitted using a single protocol which provides functionality for both messaging patterns, and which requires a single logical connection.

It will be appreciated that when here application router 1710 is shown as a single object, this is a schematic functional illustration. An application router is a set of functionality. In embodiments, an application router may form part of a larger application as well as be an application which provides just application router functionality. Similarly, in embodiments the application router functionality may be implemented by several components, and these in turn may be distributed across several computing devices in a computing system, while to connected application components the application router still presents as a single functional unit.

It will further be appreciated that when here reference is made to application components which form part of a single application connecting to an application router, in embodiments several applications can connect to an application router and interact via routed messages.

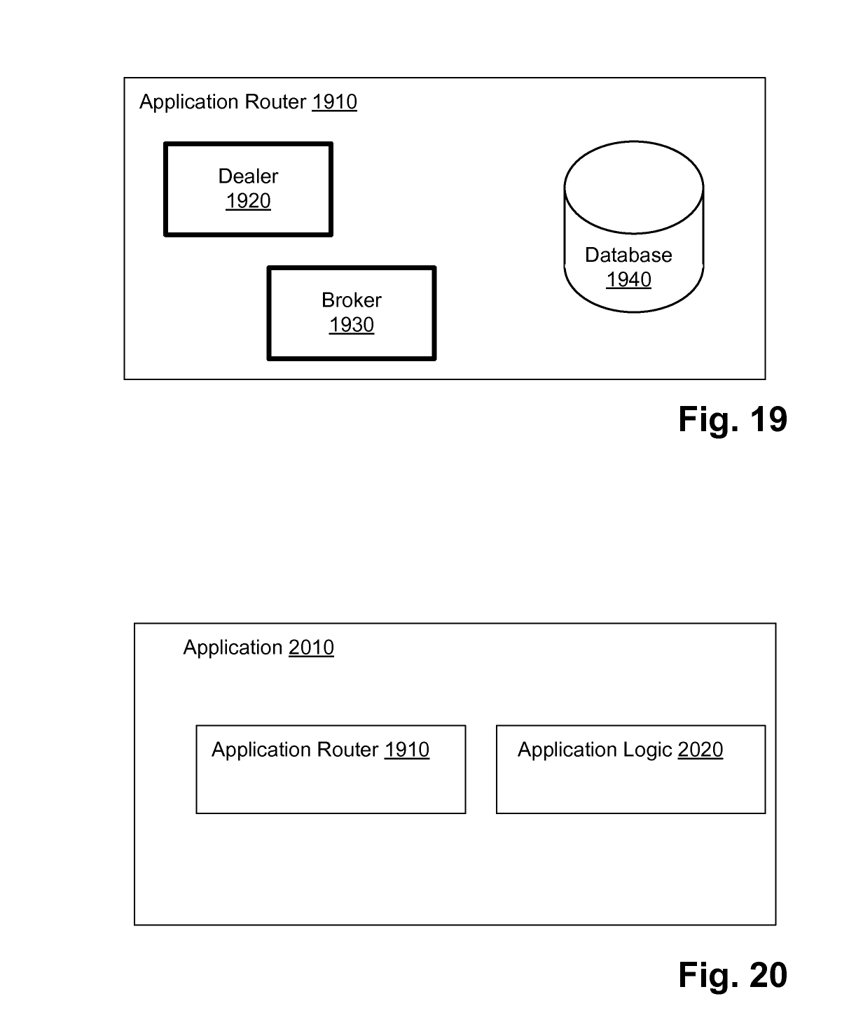

FIG. 19 illustrates an application router 1910 in an embodiment where application router 1910 comprises additional functionality beyond the broker and dealer functionality. It comprises a dealer 1920, a broker 1930 and a database 1940. While in operation, the configuration for application router 1910 is stored in working memory. The configuration comprises rules which may include information which determines which role application components which connects to application router 1910 are assigned, and what their permissions for registering and calling procedures, as well as subscribing and publishing to topics are based on these roles. When an application router is initially instantiated, such configuration information may be retrieved from database 1940, or via an external interface. Application router 1910 may store a working configuration in database 1940, and such a stored configuration may be retrieved at a later time, e.g. as part of a subsequent startup of application router 1910.

It will be appreciated that working memory can be RAM, flash memory, or any other storage medium which the computing system and the technology stack on which an application router such as 1910 is implemented provides and which can be accessed as working memory.

FIG. 20 illustrates an application router 1910 in an embodiment where application router 1910 is comprised in an application which comprises additional functionality. Application 2010 additionally comprises application logic 2020. Such application logic may contain various functionality, where such functionality may, as an example, include functionality for the determination whether an application component which attempts to connect to the application router is authorized to do so. It will be appreciated that the illustration of a single block of additional functionality is by way of example only.

It will also be appreciated that when here application 2010 is shown as a single object, this is a schematic functional illustration. An application is a set of functionality. In embodiments, an application may form part of a larger application. In embodiments the application functionality may be implemented by several components, and these in turn may be distributed across several computing devices in a computing system, while externally the application still presents as a single functional unit.

### Web Application Messaging Protocol (WAMP)

In an embodiment, the protocol which implements both a Call-and-Register and a Publish-and-Subscribe messaging pattern, and which is used as part of the connection between application components and an application router, is the Web Application Messaging Protocol (WAMP). WAMP is an open standard, with implementations for several different programming languages, created by a variety of implementers.

It will be appreciated that WAMP is given here as an example—other protocols may implement both a Call-and-Register and a Publish-and-Subscribe pattern, and be used in embodiments

It will further be appreciated that not all features of WAMP are described here. Embodiments may make use of additional features of WAMP not described herein.

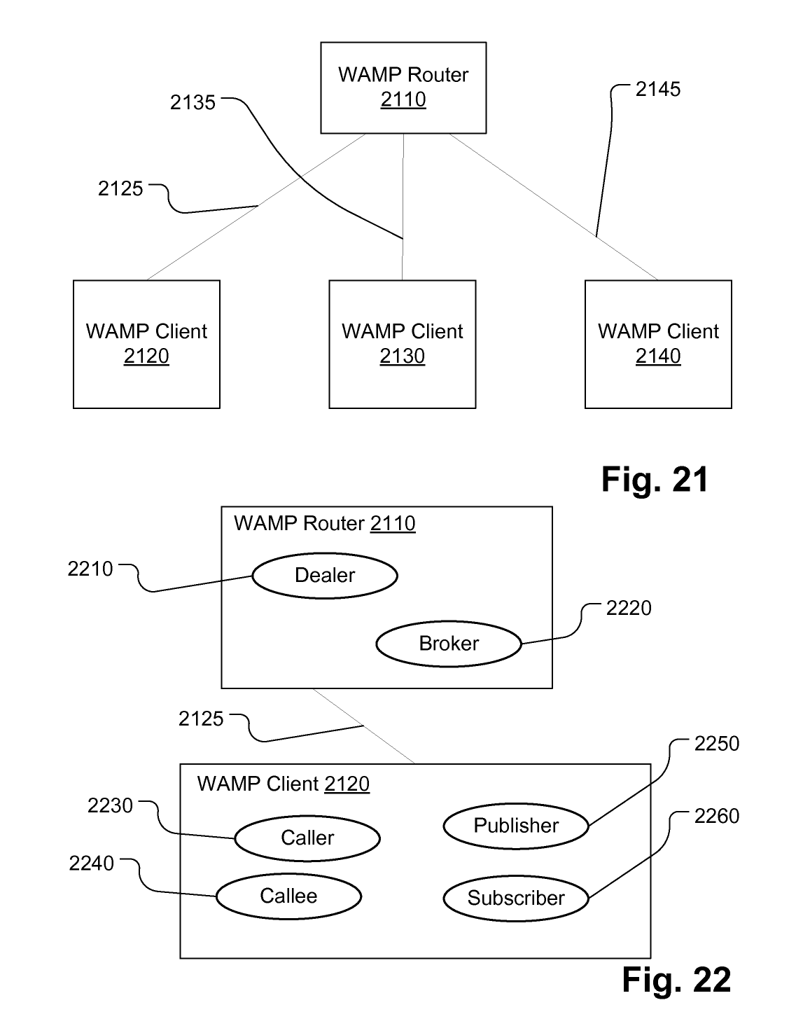

FIG. 21 is a diagram showing a WAMP router 2110 connected to three WAMP clients, 2120, 2130 and 2140, where said connections are WAMP connections. WAMP connections are always between a WAMP router and a WAMP client—there are no client to client connections. Such connections may be established and maintained using a wide number of technologies for aspects such as the physical connection, the transport and the serialization.

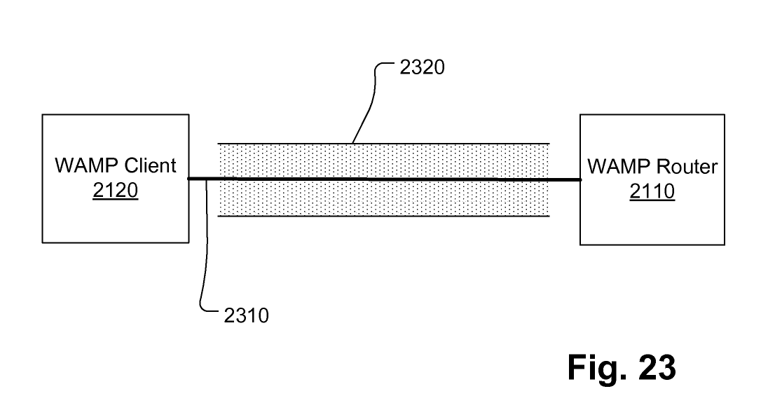

FIG. 22 is a diagram showing the roles which WAMP routers and WAMP clients can implement to enable them to participate in the Call-and-Register and Publish-and-Subscribe messaging patterns which WAMP provides.

For the Call-and-Register pattern, WAMP clients, such as WAMP client 2120, can both offer a procedure for calling (implement the role of ‘callee’, 2240) and call a procedure (implement the role of ‘caller’, 2230). A WAMP router, such as WAMP router 2110, can implement the role of dealer, 2210.

For the Publish-and-Subscribe pattern, WAMP clients, such as WAMP client, 2120, can both subscribe to a topic (implement the role of ‘subscriber’, 2260) and publish to a topic (implement the role of ‘publisher’, 2250). A WAMP router, such as WAMP router 2110, can implement the role of broker, 2220.

It will be appreciated that while here a WAMP client is shown which implements the roles of caller, callee, publisher and subscriber, WAMP clients may implement any subset of these roles. For example, a WAMP client may only implement the role of publisher, or may implement the roles of caller, callee and subscriber. Similarly, a WAMP router may implement only the role of broker or dealer.

FIG. 23 is a diagram illustrating elements of a WAMP connection between a WAMP router 2110 and a WAMP client 2120. The connection uses a transport 2320, and a session 2310 is established over this transport. Transport 2320 can be any transport which fulfills the requirements of being message-based, bi-directional, reliable and ordered. Examples for this are WebSocket or RawSocket.

It will be appreciated that a transport fulfilling the above requirements may in turn be implemented on another underlying transport layer, and that such transport layer need not fulfill all of the requirements. For example, for HTTP as another underlying transport layer, a polling solution can be used to provide bi-directionality, while for UDP as another underlying transport layer, an added retransmission mechanism can be used to provide reliability.

Contents of session 2310 are transmitted over transport 2320 in a serialization to octets. Serialization formats suitable for the serialization of WAMP messages need to comprise a set of data types which includes integers (non-negative), string (UTF-8 encoded Unicode), Boolean, list, dictionary with strings as keys. Examples of suitable serialization formats include JSON (Java Script Object Notation) and MsgPack.

Other aspects of sessions, such as session 2310, will be described further on this specification.

### Format of WAMP Messages

WAMP messages consist of an array where the first element is an integer giving the message type, and, depending on the message type, may contain a number of additional elements.

A sample WAMP message is
[32, 713845233, { }, “com.myapp.mytopic1”]

This is a subscription request, as identified by the initial integer value, “32”. The second through fourth list elements are message type specific. The second value is a request ID, which is assigned by the client sending the message. Request IDs are transmitted as part of the response to the request, and allow the requester to unambiguously correlate a response to the relevant request, e.g. if there is more than one request in flight at any given moment. The third value in the list is an options dictionary which here is empty. The last value in the list is a topic URI which identifies the topic to which the client wishes to subscribe.

WAMP uses URIs as identifiers to identify resources such as topics, procedures and errors. URIs are written starting with the top level domain, followed by the domain name and then the regular path, and with parts separated by dots. It will be appreciated that the URIs used here are by way of example only. It will further be appreciated that while URIs as used by WAMP can in principle be mapped to URIs on the World Wide Web (e.g. the above URI in a format understood by a browser would be “myapp.com/mytopic1”, and use the “http://” scheme), as URIs are used as identifies only within WAMP, there is no requirement that URIs can be resolved to actual resources on the Web.

### Call-and-Register Using WAMP

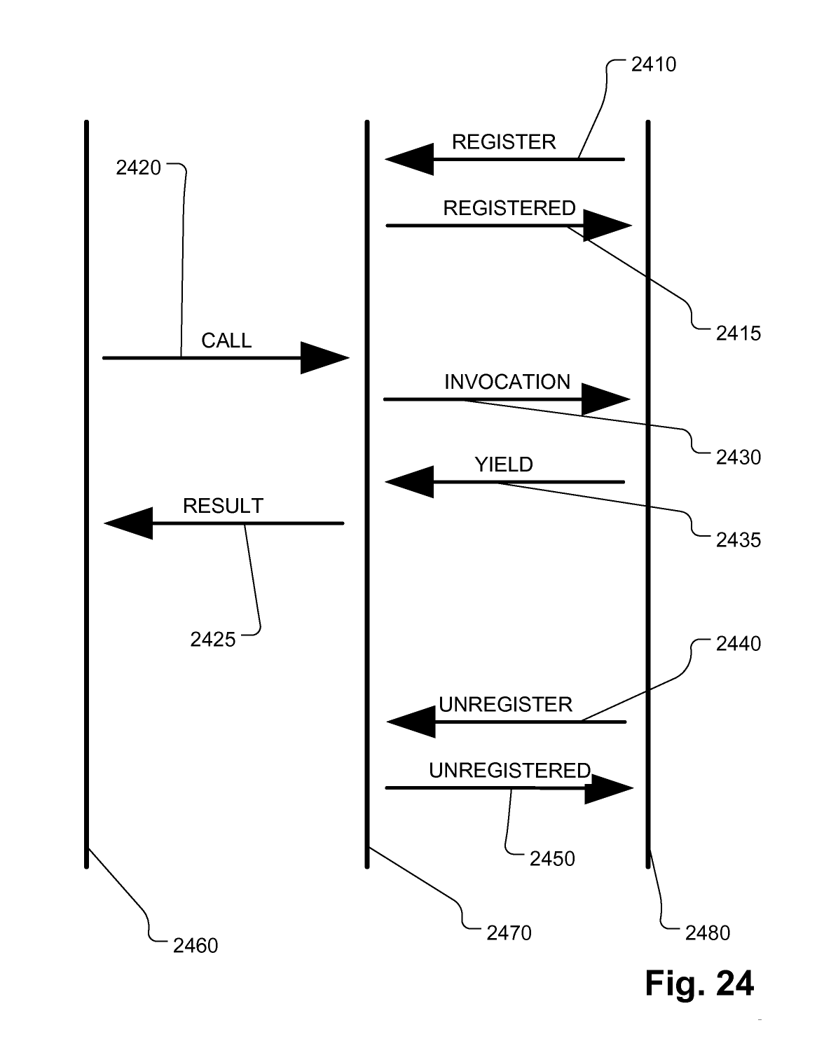

FIG. 24 is a message sequence chart for a sequence of WAMP messages using the Call-and-Register message pattern. Here, participants 2460 and 2480 are application components, while participant 2470 is an application router. Messages between participants are shown as arrows, and the sequence is read from top to bottom. Here, application component 2480 first sends a registration request 2410 for a procedure to application router 2470. The registration is successful, and application router 2470 sends a reply 2415. Subsequently, application component 2460 sends a call 2420 for a procedure to application router 2470. Based on the previous registration for said procedure by application component 2480, application router 2470 sends an invocation 2430 for the procedure to application component 2480. Application component 2480 then sends a yield 2435 for the procedure to application router 2470. Based on this yield, application router 2470 sends a result 2425 to application component 2460.

It will be appreciated that here only the success of messages is illustrated. Messages such as registration request 2410, call 2420 or invocation 2430 may fail for a variety of reasons. In case of failure, an error message is transmitted in reply.

Sample WAMP messages are listed below to further illustrate the sequence shown in the message sequence chart of FIG. 24. The WAMP messages are shown at the WAMP protocol level. Messages as send and received by an implementation of WAMP at the level of an implementation's API may have a different format. It will be appreciated that the details of the listed WAMP messages are given as examples only. It will also be appreciated that the serialized messages are in a different format, where the details depend on the serialization format chosen.

An example ‘REGISTRATION’ (2410) could be:
[64, 3920475965095936, { },“com.myapp.get_prices”]

The message is identified as a registration request by the message ID (‘64’). It contains a request ID (‘3920475965095936’), an empty options dictionary, and the URI under which the registered procedure is to be called.

An example ‘REGISTERED’ (2415) could be:
[65,3920475965095936,5770394984763434]

The message is identified as a registration success notification by the message ID (‘65’). It contains the request ID of registration request 2410, and a registration ID (‘5770394984763434’) which will be used to identify the procedure during invocations.

An example ‘CALL’ (2420) could be:
[48,48391302152192,{ }, “com.myapp.get_prices”]

The message is identified as a procedure call by the message ID ('48′). It contains a request ID (‘48391302152192’), an empty options dictionary and an URI for the procedure to be called.

It will be appreciated that calls can contain additional arguments for the procedure to be called. These can be sent as both an array and a dictionary. As an example, the above call with additional arguments could e.g. be
[48,48391302152192,{ },“com.myapp.get_prices”, [“dairy”, “meat”]]

with an array here containing identifiers for two groups of food items for which prices are requested.

It could also contain additional arguments such as

[48,48391302152192,{ }, “com.myapp.get_prices”, [ ], {status: “available”}]

with a dictionary which contains a key identifying a property of products for which to return prices, and a value for this property, i.e. here prices are requested for products which are currently available for sale.

It will be appreciated that combinations of arguments in an array and in a dictionary may be sent.

An example ‘INVOCATION’ (2430) could be:
[68,6862220984212394,5770394984763434, { }]

The message is identified as a procedure invocation by the message ID 68. It contains a request ID (‘6862220984212394’) and the registration ID (‘5770394984763434’) which was previously assigned for the procedure registered for the URI “com.myapp.get_prices”. It additionally contains an empty invocation details dictionary, and may just, like the call, additionally contain call arguments in the form of an array and/or a dictionary.

An example ‘YIELD’ (2435) could be:
[70,6862220984212394, { }, [ ],{banana: 12.45, veal: 34, milk: 8}}

The message is identified as a procedure yield by the message ID 70. It contains the request ID of procedure invocation 2430, an empty options dictionary, an empty arguments array, and an arguments dictionary. This contains the requested prices.

An example ‘RESULT’ (2425) would be:
[50,48391302152192, { },[ ], {banana: 12.45, veal: 34, milk: 8}]

The message is identified as a result by the message ID 50. It contains the request ID of call 2420. It additionally contains an empty details dictionary, an empty arguments array and a dictionary containing the results.

An example ‘UNREGISTER’ (2440) would be:
[66,788923562,5770394984763434]

The message is identified as an unregistration request by the message ID 66. It contains a request ID and the registration ID assigned during the registration of the procedure.

An example ‘UNREGISTERED’ (2450) could be:
[67,788923562]

The message is identified as an unregistration success notification by the message ID 67. It contains the request ID of the unregistration request.

### Publish-and-Subscribe using WAMP

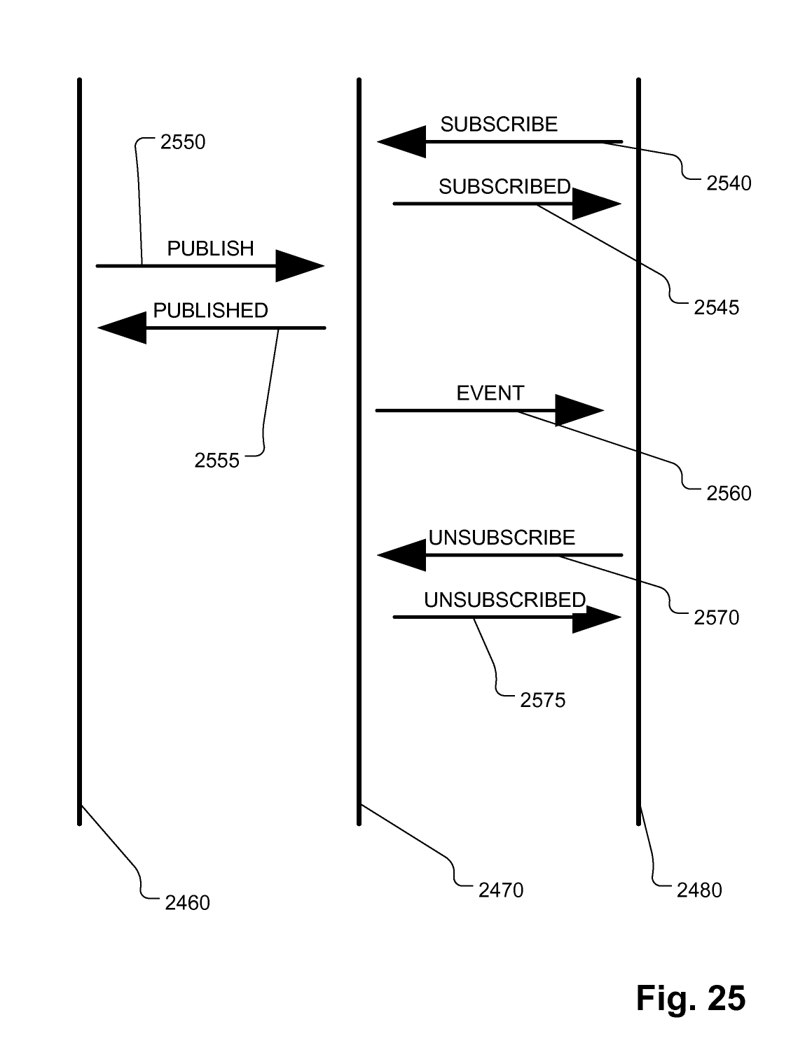

FIG. 25 is a message sequence chart for a sequence of WAMP messages using the Publish-and-Subscribe message pattern. Here, participants 2460 and 2480 are application components, while participant 2470 is an application router. Messages between participants are shown as arrows, and the sequence is read from top to bottom. Here, application component 2480 first sends a subscription request 2540 for a topic to application router 2470. The subscription request is successful, and application router 2470 sends a reply 2545. Subsequently, application component 2460 sends a publish 2550 for the topic previously subscribed to by application component 2480 to application router 2470. The publish is successful, and application router 2470 sends an acknowledgement 2555 of this success to application component 2460. It subsequently, based on the publish, sends an event 2560 to application component 2480. Application component 2480 sends an unsubscribe request 2570 to application router 2470, which is successful, and application router 2470 sends an acknowledge 2575 for this.

It will be appreciated that here only the success of messages is illustrated. Messages such as subscription request 2540 publish 2550 or unsubscribe request 2570 may fail for a variety of reasons. In case of failure, an error message is transmitted in reply.

It will be also appreciated that while here a reply by the broker to the publication is shown (the ‘PUBLISHED’) message, such a message may be optional and be configurable, where such configurability may be on a per-message basis.

It will further be appreciated that while here a reply by the broker to a publication is shown as preceding the dispatching of an event based on the publication, such a reply may be sent after the dispatch of an event, or, where several events are dispatched, after any one of these events.

Sample WAMP messages are listed below to further illustrate the sequence shown in the message sequence chart of FIG. 25. The WAMP messages are shown at the WAMP protocol level. Messages as send and received by an implementation of WAMP at the level of an implementation's API may have a different format. It will be appreciated that the details of the listed WAMP messages are given as examples only. It will also be appreciated that the serialized messages are in a different format, where the details depend on the serialization format chosen.

An example ‘SUBSCRIBE’ (2540) could be:
[32,4534838472212480, { }, “com.myapp.new_order”]

The message is identified as a subscription request by the message ID 32. It contains a request ID (‘4534838472212480’), an empty options dictionary, and the URI identifying the topic for the subscription.

An example ‘SUBSCRIBED’ (2545) could be:
[33,4534838472212480,3363201724375298]

The message is identified as a subscription success notification by the message ID 33. It additionally contains the request ID of subscription request 2540, and a subscription ID which is used to identify the subscription in events sent to a subscriber.

It will be appreciated that the subscription ID need not be unique to the subscription of a single subscriber, but that the same subscription ID may be assigned to all subscribers to a topic, or where the topic or topic pattern and some or all subscription options match.

It will further be appreciated that while here subscriptions based on matching a complete URI string are illustrated, subscriptions may also be for a URI pattern As one example, when a URI pattern “com.myapp.*” is used, events would be dispatched for all publishes with and URIs which contains “com.myapp.” as a prefix, e.g. a publish to “com.myapp.new_sale” and a publish to “com.myapp.new_order.product_75848” would both result in an event being dispatched to the subscriber, while there would be no dispatched event based on a publish to topic “com.myapp2.new_sale”. As another example, when a URI pattern “com.myapp.client.*.new_sale” is used, all publishes to topics where the identifying URI contains the above string, where “*” can be an arbitrary string, would lead to an event being dispatched. As examples, a publish to topic “com.myapp.client.2738.new_sale” and a publish to topic “com.myapp.client.checkout_1.new_sale” would both result in an event being dispatched to the subscriber, while there would no dispatched event based on a publish to topic “com.myapp.client_23123.new_sale”.

An example ‘PUBLISH’ (2550) could be:
[16,7782798513405952, { }, “com.myapp.new _order”,[ ],{item: “milk”, quantity: “12”}]

The message is identified as a publish by the message ID 16. It additionally contains a request ID (‘7782798513405952’), an empty options dictionary, an URI identifying the topic of the publish, an empty arguments array and a dictionary of arguments. Here the arguments identify the item ordered as well as the quantity for the order.

An example ‘PUBLISHED’ (2555) could be:
[16,7782798513405952, 1474927148218785]

The message is identified as a publication acknowledgement by the message ID 17. It contains the request ID of the publication request, and a publication ID.

An example ‘EVENT’ (2560) could be:
[36,3363201724375298,1474927148218785,{ },[ ], {item: “milk”, quantity: “12”}]

The message is identified as an event by the message ID 36. It contains the subscription ID which was previously assigned to the subscription, the publication ID of the publish based on which the event is dispatched, an empty details dictionary, an empty arguments array, and a dictionary containing the arguments contained in the publishes arguments dictionary.

An example ‘UNSUBSCRIBE’ could be:
[34,11127383982722,3363201724375298]

The message is identified as an unsubscribe by the message ID 34. It contains the subscription ID (‘3363201724375298’) which was previously assigned to the subscription.

An example ‘UNSUBSCRIBED’ could be:
[35, 11127383982722]

which is identified as an unsubscribe by the message ID 35, and contains the request ID of the unsubscribe request (‘11127383982722’).

### Sample Code for the Sending and Handling of WAMP Messages

Listed here is some sample code for the sending and handling of WAMP messages. The sample code is written in the JavaScript, Python, PHP and C++ programming languages. For each of these languages, WAMP functionality is provided by a library, and the sample code for each of the illustrated languages uses the specific API provided by a specific library. These libraries are:
Autobahn|JS for JavaScript
Autobahn|Pyton for Python
Autobahn|CPP for C++
Thruway for PHP

It will be appreciated that other implementations of WAMP functionality for the above programming languages may exist or be created, and that accessing WAMP functionality in these implementations may be via code which is different from the listed code. It will additionally be appreciated that implementations of WAMP functionality may exist or be created for other programming languages.

It will further be appreciated that the code samples here cover only a subset of WAMP functionality. Various subsets of WAMP functionality may be provided by implementations.

Code samples below are ordered first by functionality, i.e. registering a procedure, calling a procedure, subscribing to a topic and publishing to a topic, and then by language.

As an example for registering a procedure, a procedure which receives an array of two integers and returns the sum of the integers is registered by each of the code samples below for a WAMP session “session” and for the URI “com.myapp.add2”.

Code sample for registering a procedure in JavaScript:

function add2(args) {
return args[0] + args[1];
}
session.register(‘com.myapp.add2’, add2);

Code sample for registering a procedure in Python:

def add2 (x, y):
return x + y
session.register(add2, ‘com.myapp.add2’);

Code sample for registering a procedure in PHP:

$add2 = function ($args) {
return $args[0] + $args[1];
};
$session->register(‘com.myapp.add2’, $add2);

Code sample for registering a procedure in C++:

any add2(const anyvec&amp;amp; args, const anymap&amp;amp;
kwargs) {
return any_cast<uint64_t>(args[0]) +
any_cast<uint64_t>(args[1]);
}
session.provide(“com.myapp.add2”, &amp;amp;add2);

As an example for calling a procedure, the above registered procedure is called and the call result is logged by each of the code samples below.

Code sample for calling a procedure in JavaScript:

```
session.call(‘com.myapp.add2’, [2, 3]).then(
  function (result) {
    console.log(“Got result:”, result);
  }
);
```

Code sample for calling a procedure in Python:

result = yield from session.call(‘com.myapp.add2’, 2, 3)
print(“Got result: { }”.format(result))

Code sample for calling a procedure in PHP:

```
$session->call(‘com.myapp.add2’, array(2, 3))->then(
  function ($res) {
    echo “Got result: {$res}\n”;
  }
);
```

Code sample for calling a procedure in C++:

```
session.call(“com.mathservice.add2”, {2, 3}).then(
  [&amp;](future<any> f) {
    cout << “Got result: ” << any_cast<uint64_t>
(f.get( )) << endl;
  }
);
```

As an example for subscribing to a topic, a subscription for a topic “com.myapp.hello” is requested, and a handler which logs a received event for the topic is registered by each of the code samples below.

Code sample for subscribing to a topic in JavaScript:

function onhello(args) {
console.log(“Got event:”, args[0]);
}
session.subscribe(‘com.myapp.hello’ onhello);

Code sample for subscribing to a topic in Python:

def onhello(msg):
print(“Got event: { }”.format(msg))
yield from session.subscribe(onhello, ‘com.myapp.hello’)

Code sample for subscribing to a topic in PHP:

$onHello = function ($args) {
echo “Got event: {$args[0]}\n”;
};
$session->subscribe(‘com.myapp.hello’, $onHello);

Code sample for subscribing to a topic in C++:

void onhello(const anyvec&amp; args, const anymap&amp;
kwargs) {
cout << “Got event: ” << any_cast<string>(args[0]) <<
endl;
}
session.subscribe(“com.myapp.hello”, &amp;onhello);

As an example for publishing to a topic, a publish to a topic “com.myapp.hello” with a payload string of “Hello, world!” is made by each of the code samples below.

Code sample for publishing to a topic in JavaScript:
session.publish(‘com.myapp.hello’, [‘Hello, world!’]);

Code sample for publishing to a topic in Python:

session.publish(‘com.myapp.hello’, ‘Hello, world!’)

Code sample for publishing to a topic in PHP:
$session->publish(‘com.example.oncounter’, array(‘Hello, world!’));

Code sample for publishing to a topic in C++:
session.publish(“com.myapp.hello”, {string(“Hello, world!”)});

### Management Application

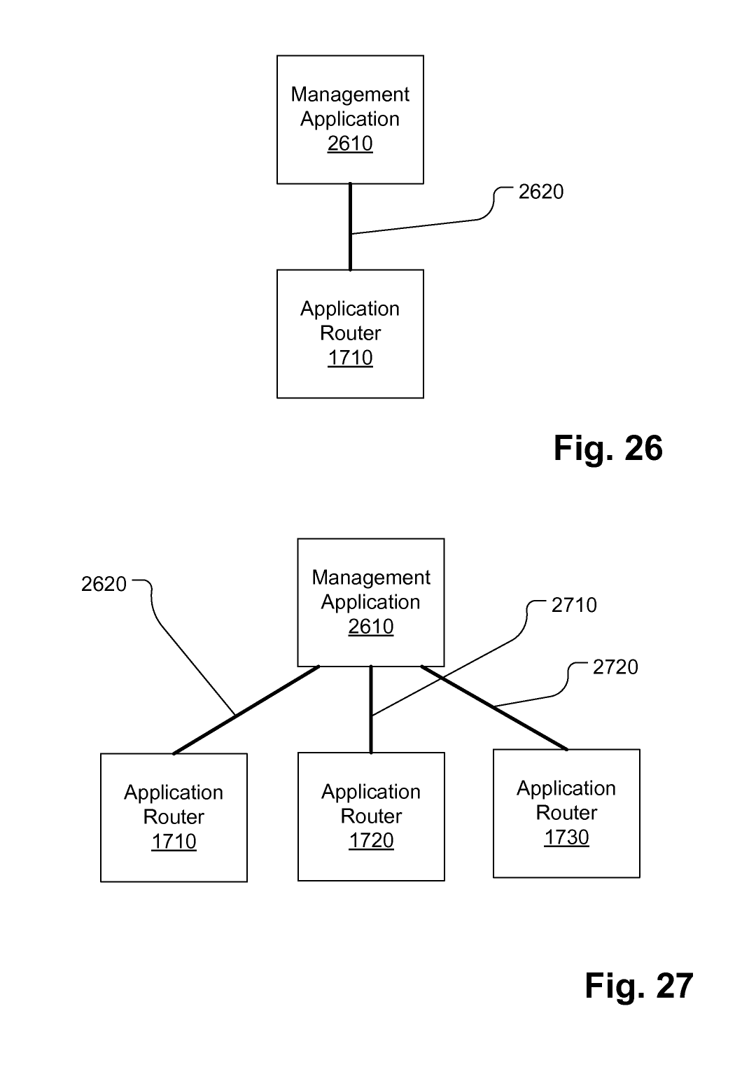

FIGS. 26 and 27 illustrate a management application. In FIG. 26, management application 2610 is connected to an application router 1710. In FIG. 27, management application 2610 is connected to multiple application routers 1710, 1720 and 1730. A management application provides the functionality to connect to one or more application routers and to issue instructions to and receive information from them. Such instructions may include instructions to configure an application router, to start monitoring the routing behavior of an application router, and to start debugging of application component messaging. Some of the functionality that a management application may contain is described in more detail below.

It will be appreciated that while here a direct connection between a management application and an application router is shown, such a connection may be via any mechanism which ensures that instructions from the management application are received by the application router, and that information from the application router reaches the management application. Such mechanisms may employ the use of one or more intermediaries. Messages between a management application and an application router may use the Call-and-Register and/or the Publish-and-Subscribe messaging patterns, and make use of dealers and/or brokers for routing messages. It will further be appreciated that when here application routers and intermediaries are described, that this is a functional view. An application router and one or more intermediaries, or a management application and one or more intermediaries may be technically implemented as part of a single application.

### User Interfaces and Controllers

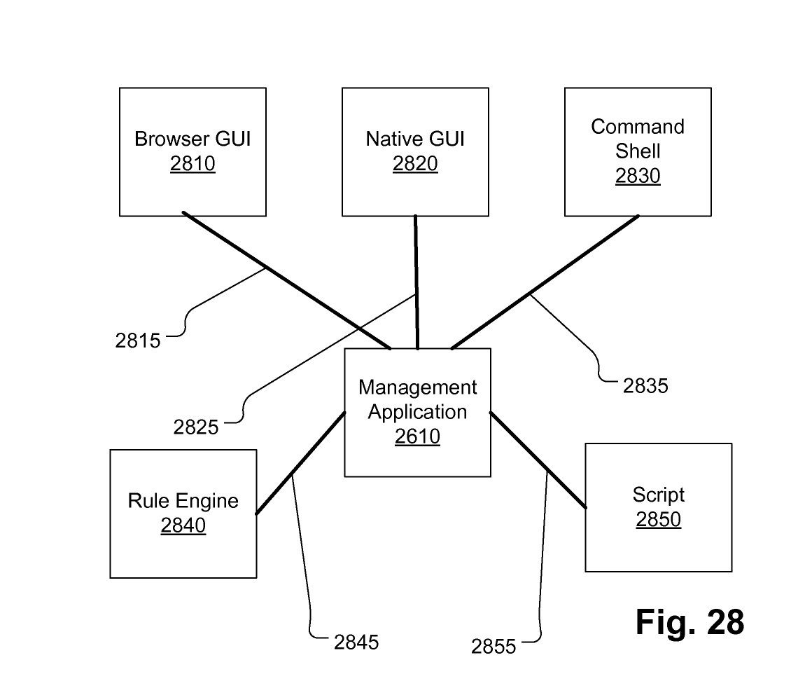

FIG. 28 shows different user interfaces and controllers connected to management application 2610. Interfaces and controllers can send input to the management application and receive output from it. Input can e.g. be a command to execute a particular piece of management functionality, which may additionally contain parameters to be used during the execution. Output can e.g. be information about the state of the management application, application routers managed by the management application, or application messaging traffic routed by such routers.

User interface 2810 is a browser GUI, i.e. a graphical user interface which is executed inside a Web browser. In embodiments the browser UI may be served by a Web server component within a management application. Browser interface 2810 can connect 2815 with management application 2610 using any mechanism or mechanisms which both the Web browser executing the GUI and the management application implement, including HTTP calls and WebSocket connections.

User interface 2820 is a native GUI, i.e. an application which executes directly as a native application on an operating system. Native GUI 2820 can connect 2825 to management application 2610 using any mechanism or mechanisms which both the system on which the application runs and the management application implement, including HTTP calls, WebSockets and RawSockets.

User interface 2830 is a command shell. Here interaction with management application is via typed commands, and feedback and other output from the management application is displayed as text. Command shell 2830 can connect 2835 to management application 2610 using any mechanism or mechanisms which both the implementation of the command shell and the management application support.

It will be appreciated that the illustrated user interfaces are only by way of example, and that other user interfaces may be implemented using technologies known in the art.

Additionally to user interfaces 2810, 2820 and 2830, which are man-machine interfaces, rule engine 2840 and script 2850 are connected (2845, 2850) to management application 2610.

Rule engine 2840 may be any kind of rule-based program or set of instructions. A rule engine may send input to management application 2610 based purely on internal factors, such as periodically initiating a restart of application routers managed by the management application, or periodically request logging information for the intervening time period. It may also act based on information received from external sources. Such external sources may include output from the management application as well as e.g. information from the general internet. A rule engine may thus e.g. receive information from the management application about the current processor load of a connected application router, and initiate the instantiation of an additional application router when this passes a certain threshold. Rule engine 2840 may be run in a variety of execution environments and such execution environments may connect to management application 2610 using any mechanism or mechanism which both the execution environment and the management application implement.

Script 2850 executes a series of instructions to the management application when executed. The series of instructions may include requests for information to the management application or other information sources, and alter the instructions sent as well as the arguments sent with these instructions based on this information. Script 2850 terminates after the processing of the series of instructions. Script 2850 may be run in a variety of execution environments, including in command shells, and such execution environments may connect to management application 2610 using any mechanism or mechanism which both the execution environment and the management application implement.

It will be appreciated that while here user interfaces and controllers are shown as external components connected to management application 2610, in embodiments a management application and a user interface or controller may be contained in a single component or application, and run on a single computing system. It will further be appreciated that while here the illustrated user interfaces and controllers are shown as separate components, in embodiments combinations of user interfaces and controllers may be implemented. For example, in an embodiment, a browser GUI may additionally execute a script on startup, and contain a rule engine.

The input sent by user interfaces and controllers to a management application, as well as the output received by them from a management application can be sent over the connections between user interfaces and controllers and a management application employing different protocols or other mechanisms. This may include using a protocol which implements both CallReg and PubSub functionality, and, more specifically, using WAMP.

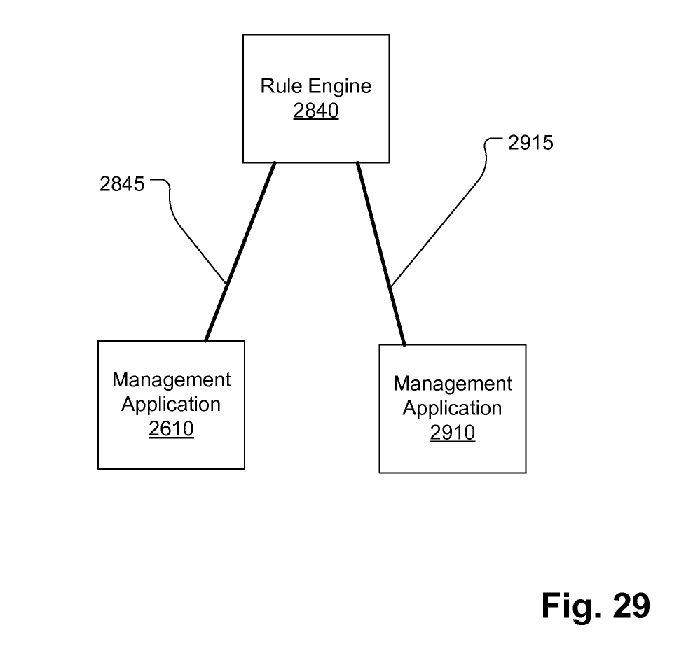

FIG. 29 shows a single controller, rule engine 2840, connected to two management applications, 2610 and 2910 via connections 2855 and 2915. Rule engine 2840 may contain separate rules concerning management applications 2610 and 2910, or rules which coordinate some or all instructions which rule engine 2840 issues to both management applications. It will be appreciated that while here a rule engine is shown connected to two management applications, a rule engine may be connected to larger numbers of management applications. It will further be appreciated that while here a rule engine is shown, other controllers as well as user interfaces may similarly connect to multiple management applications.

### Deployment Across Devices

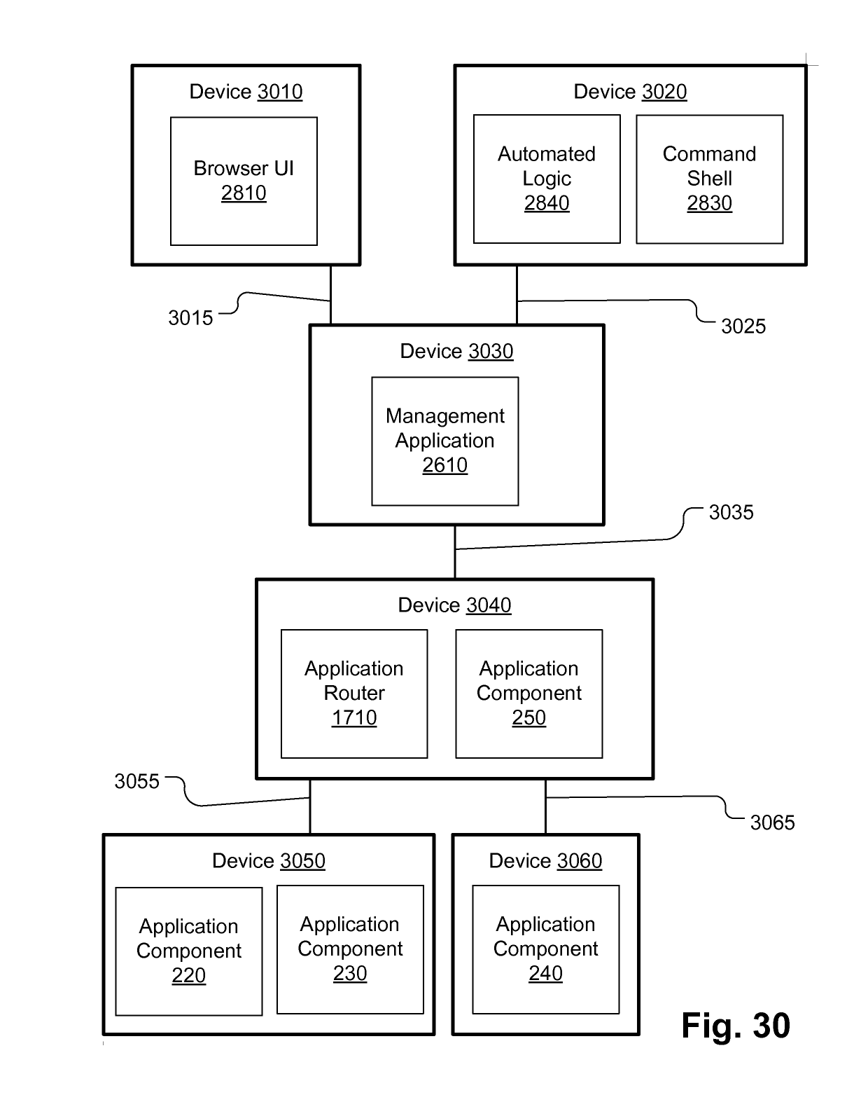

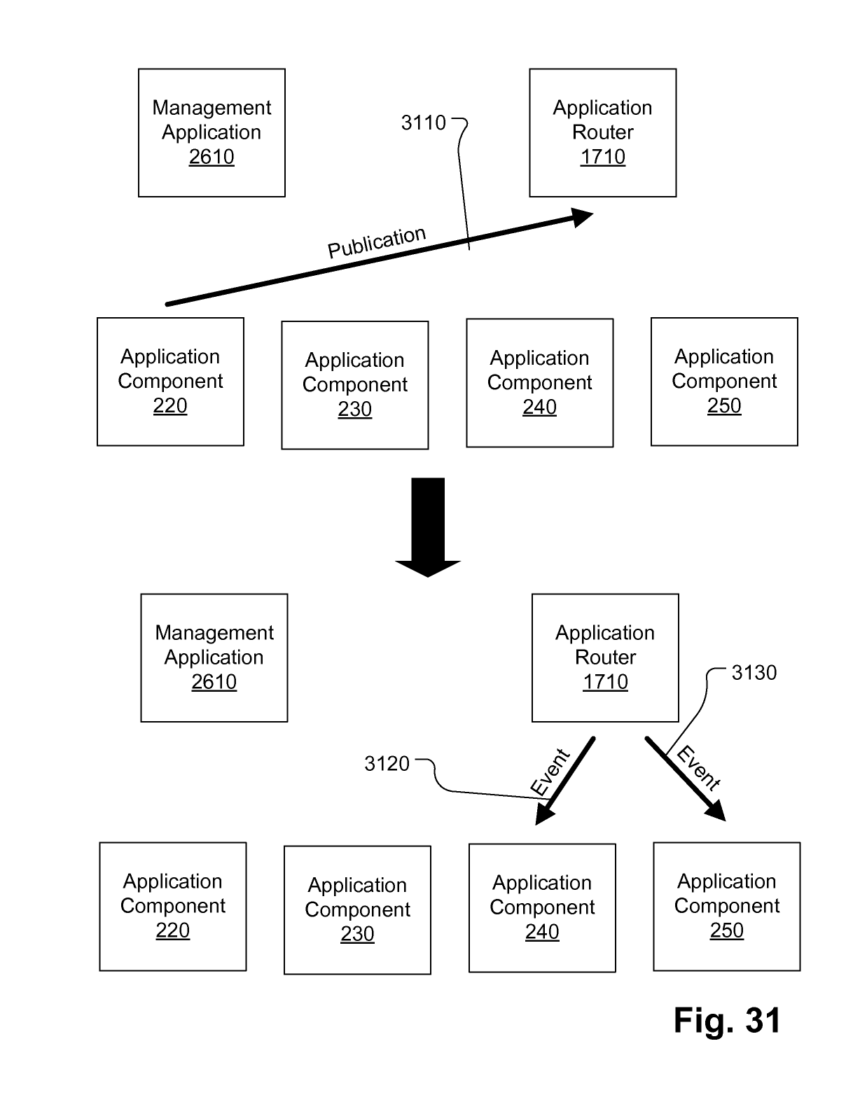

FIG. 30 illustrates a distribution of functionality across several computing systems in an example state of an embodiment. Application components 220, 230, 240 and 250 are distributed across three devices, with application components 220 and 230 being hosted on device 3050, application component 240 being hosted on device 3060, and application component 250 being hosted on device 3040. Device 3040 additionally hosts application router 1710. Management application 2610 is being hosted on device 3030. Browser UI 2810 is being hosted on device 3010. Device 3020 hosts both rule engine 2840 and command shell 2830.

It will be appreciated that when here application components, application routers, management applications, user interfaces or controllers are shown as being hosted on the same device, this co-hosting may be implemented in various ways. This includes them running as parts of a single process, a single application, and them running as separate applications.

It will be appreciated that illustrated connections 3015, 3025, 3035, 3055 and 3065 between devices can be implemented in a variety of ways. These include connections such as wired connections (e.g. Ethernet) and radio connections (e.g. Wi-Fi, 3G), and transport protocols such as TCP. Combinations of these and others as transport stacks may be used as long as it is possible to transport the protocol or protocols used to connect the illustrated participants to each other.

It will further be appreciated that the above distribution of functionality across devices is given as an example only. Other sets of functionality, devices and distribution of functionality across these devices are possible in embodiments.

### Management Operation Initiation Messages

The management of an application router through a management application comprises the management application issuing management operation initiation messages which contain information identifying a management operation. Such management operation initiation messages may be transmitted between a management application and an application router via a direct logical connection, or via mechanisms involving one or more intermediaries, where such intermediaries may include one or more routers, e.g. a WAMP router. The receiving intermediary, or any subsequent intermediary, may change the format of a management operation initiation message, add information to it, or make other changes. Such changes may allow an application router to receive process or properly interpret the content of the management operation initiation message.

Management operation initiation messages may be implemented using a variety of techniques. In an embodiment, management operation initiation messages comprise an identifier which identifies the management operation. Such identifier can be for the type of management operation. As an example, if strings are used as identifiers, a string “change_dispatch_rules” could be used to identify a type of management operation initiation message which initiates a change in the rules for dispatching events in an application router.

It will be appreciated that embodiments may use various data types and structures as identifiers, including strings, integers, arrays, dictionaries and binary data. In embodiments, URIs may be used as identifiers, e.g. “com.routermanagement.change_dispatch_rules” to identify the above mentioned operation changing the rules for dispatching in an application router.

Identifiers may also be used to identify operations for specific application routers. This may be achieved through various means. In embodiments, identifiers may be URIs which contain a mixture of parts identifying a type of procedure, and parts which identify a particular application router or application comprising a particular application router. For example, an URI for executing the above mentioned change of rules for dispatching in a particular application router could be “com.routermanagement.router_345.change_dispatch_rules”, where “router_345” is the information identifying a particular application router or application containing an application router.

In embodiments, information identifying a particular application router or application containing an application router which a management operation initiation message is intended for is contained elsewhere within said message.

A message may contain other additional information. For example, for the above management operation changing the rules for dispatching in an application router, information identifying the rule change or changes to be made is required. Additional information may be included in management operation initiation messages in a variety of ways.

### Configuration of an Application Router

FIGS. 31-33 are diagrams illustrating a sample sequence for a management application configuring an application router.

In the top view of FIG. 31, application component 220 sends a publication 3110 to application router 1710. In an example, application component 220 has a role of “frontend” and publication 3110 is for the topic “com.myapp.new_sale”. In the bottom view, application router 1710 dispatches events 3120, 3130 based on this publication, to application components 240 and 250. In an example, these application components had previously subscribed to the topic “com.myapp.new_sale” that publication 3110 was to.

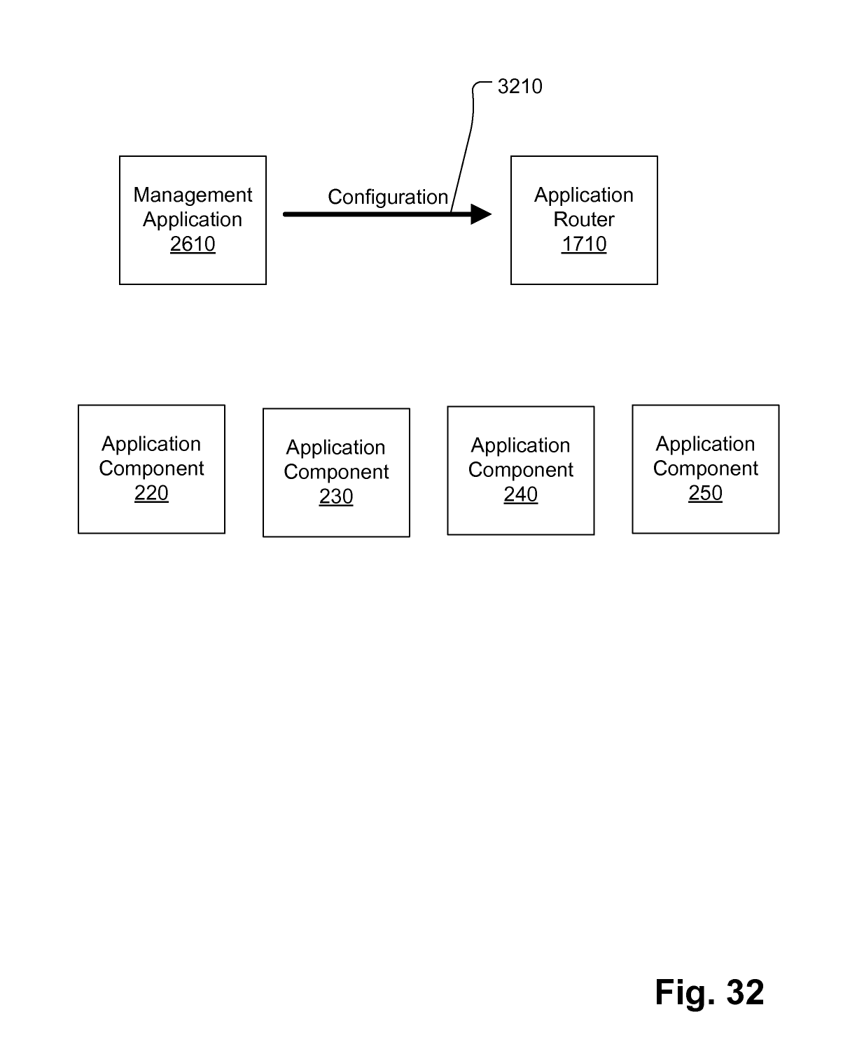

In FIG. 32, management application 2610 sends a configuration instruction 3210 to configure application router 1710. In an example, configuration instruction 3210 is to disallow publications to topic “com.myapp.new_sale” for application components of the role “frontend”.

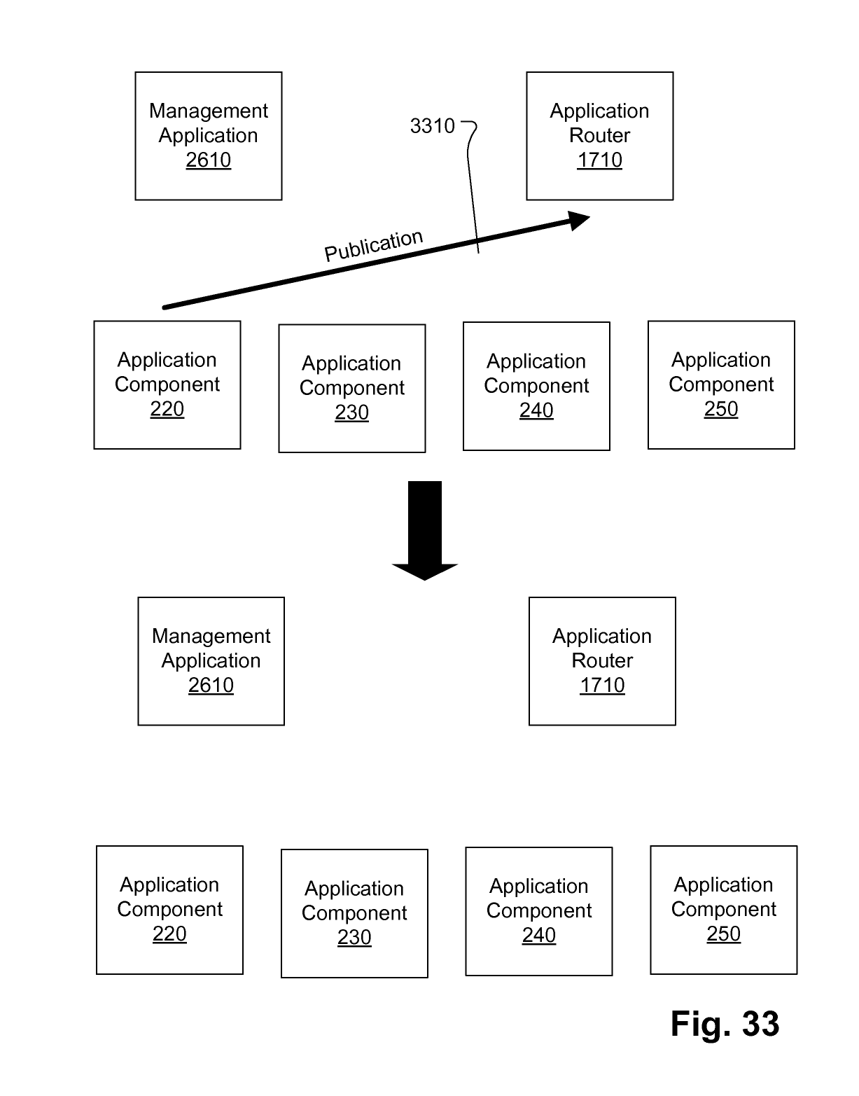

In FIG. 33, application component 220 sends a publication 3310 to application router 1710. In an example, publication 3310 is for the topic “com.myapp.new_sale”. In the bottom view, based on the configuration as changed based on configuration instruction 3210, application router 1710 does not dispatch any events to subscribers, since the application component 220 is not allowed to publish to this topic.

It will be appreciated that while here a configuration change which affects the permission of application components of a certain role to publish to a specific topic is illustrated, configuration changes based on other conditions and for other aspects of an application router may similarly be effected. Such other conditions include a URI in a message to an application router matching a certain pattern, e.g. having a certain prefix, or containing certain components, or a message payload matching a filter criterion. Other aspects include the ability to subscribe, to register and to call registered procedures.

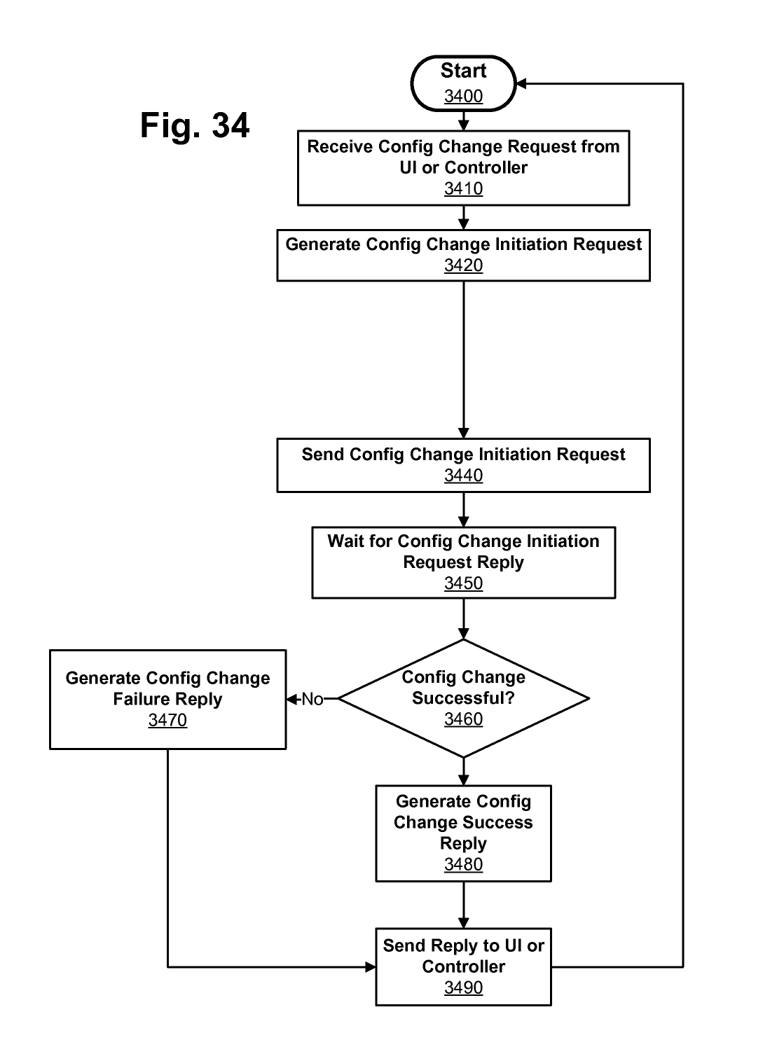

FIG. 34 shows an example flow with a management application, wherein said flow is part of the configuration of an application router by a management application.

The flow starts (3400) with the reception 3410 of a configuration change request which originates in a user interface or controller. The flow then generates 3420 a configuration change initiation request, which is subsequently sent 3440. The flow then waits 3450 for the reply to the configuration change initiation request. Once this reply has been received, the flow determines 3460 whether the configuration change request has been successful. In the case of failure, the flow generates 3470 a configuration change failure reply, in the case of success the flow generates 3480 a configuration change success reply. The flow then sends 3490 the generated reply (whether this is a configuration change failure reply or a configuration change success reply) to the user interface or controller from which the configuration change request originated.

The way the determination whether a configuration change initiation request was successful is achieved may differ in embodiments. Such a determination may e.g. be direct, based on a value contained in the configuration change initiation request reply. Such values may e.g. be a Boolean (where ‘true’ could indicate success) or one of a pair of strings (such as “success” and “failure”). Such a value may also take on more than two values, where e.g. multiple values could indicate failure, and provide further information about the cause of such a failure. A determination may also be made indirectly, e.g. when the reply contains data for the current state of the application router, and the management application compares this with the state the application router should have concerning aspects for which the request wanted to initiate change.

It will be appreciated that an application router may not immediately change its configuration once it receives the data identifying the desired changes contained in the configuration change initiation request, and that a positive configuration change initiation request reply may only indicate that the request has been received and will be processed at some point in the future, as opposed to having been denied. Cases where a configuration change is not executed immediately may include those where a configuration change requires a restart of the application router to take effect.

It will further be appreciated that a configuration change failure or success reply may be sent to user interfaces or controllers other than the user interface or controller where the configuration change request originated.

It will also be appreciated that while here a configuration change request is shown as being received from a user interface or a controller, such a request may similarly originate within a management application, e.g. based on rules running within the application. In this case the mechanism within the management application where the request originated may receive the configuration change failure or success reply.

It will further be appreciated that the flow shown in FIG. 34 is an example only. Various ways of implementing the functionality which the flow provides exist, and may be used in embodiments. Additionally, a flow implementing the functionality may contain steps which implement additional functionality.

It will also be appreciated that the necessary steps for the configuration of an application router, such as a configuration change request, may be effected using various mechanisms. One such mechanism, which serves as an example only, will be described further on.

### Monitoring of an Application Router

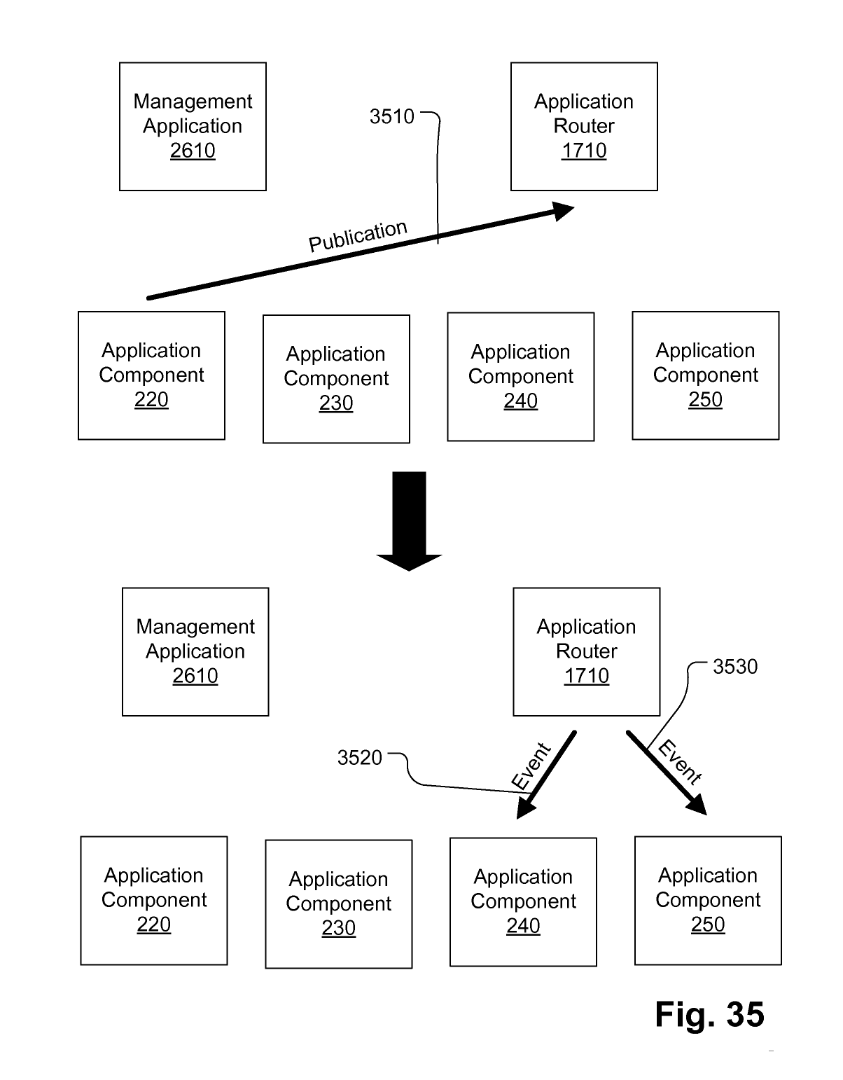

FIGS. 35-37 are diagrams illustrating a sample sequence for a management application monitoring an application router.

In the top view of FIG. 35, application component 220 sends a publication 3510 to application router 1710. In an example publication 3510 is for the topic “com.myapp.new_sale”. In the bottom view, application router 1710 dispatches events 3520, 3530 based on this publication, to application components 240 and 250. In an example, these application components had previously subscribed to the topic “com.myapp.new_sale” that publication 3510 was to. There is no sending of any data to management application 2610 based on the publication or the dispatching.

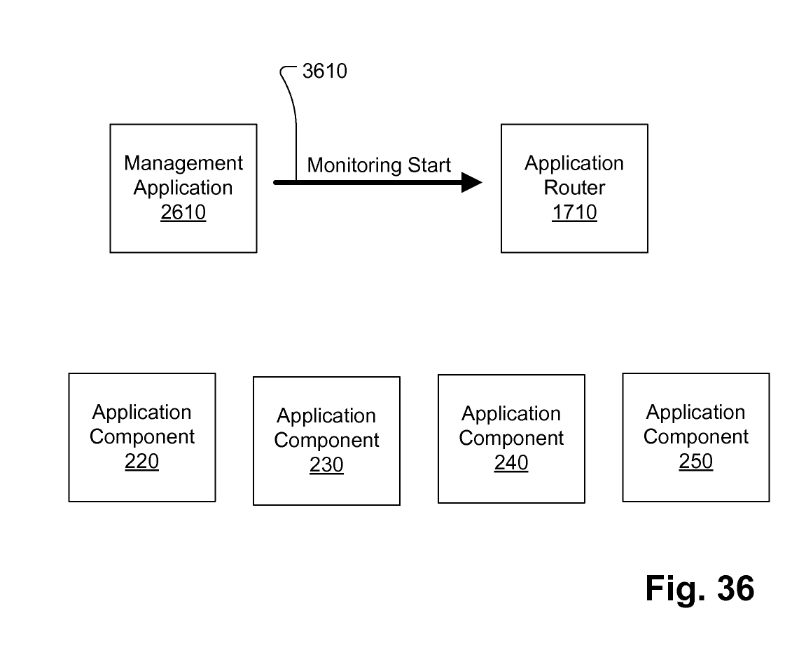

In FIG. 36, management application 2610 sends a monitoring start message 3610 to application router 1710. In an example, this monitoring start message contains data which identifies publications to topic “com.myapp.new_sale” as events for which monitoring data is to be transmitted to managing application 2610.

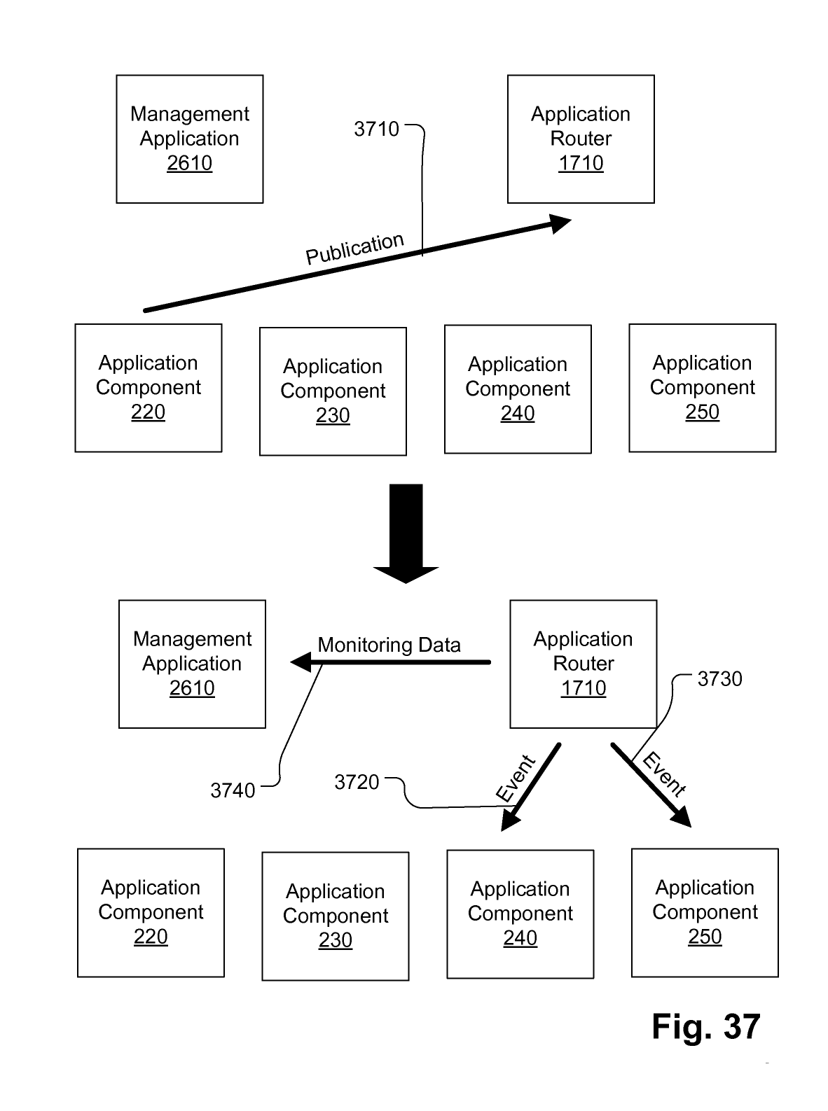

In FIG. 37, application component 220 sends a publication 3710 to application router 1710. In an example, publication 3710 is to the topic “com.myapp.new_sale”. In the bottom view, application router 1710 not only dispatches events 3720 and 3730 to application components 240 and 250 based on publication 3710, but also sends monitoring data 3740 to management application 2610. In an example, monitoring data 3740 contains the information that a publication to topic “com.myapp.new_sale” has occurred.

It will be appreciated that monitoring data can contain additional information, e.g. information about the publisher, such as the publisher's role, information about events dispatched based on the publication, and information about the subscribers.

It will further be appreciated that while here monitoring a publication is described, monitoring can occur for a large variety of data regarding the operation of an application router. Such data can include new subscriptions, registrations or calls, errors during publications, subscriptions, registrations and calls, other errors in the operation of the application router, data about publications, subscriptions, registrations and calls such as processing latency or payload size, or data about the application router itself and the system it is implemented on, such as memory usage or CPU load.

It will also be appreciated that while here a single instance of monitoring data being sent subsequent to a monitoring start message, monitoring may be persistent, i.e. monitoring data for the event or events requested by the monitoring start message may be sent until an event such as a monitoring stop message being received by the application router occurs.

It will also be appreciated that more than one aspect of the operation of an application router can be monitored at the same time, and that multiple aspects may be monitored with transmission as individual monitoring data, combined monitoring data or any combination thereof.

It will further be appreciated that monitoring data may be sent to the management application immediately once such data exists, or that the sending of several instances of such data may be combined. Such a combination may be based on factors including a minimum amount of monitoring data having been created, and a set time since the last sending of data having expired.

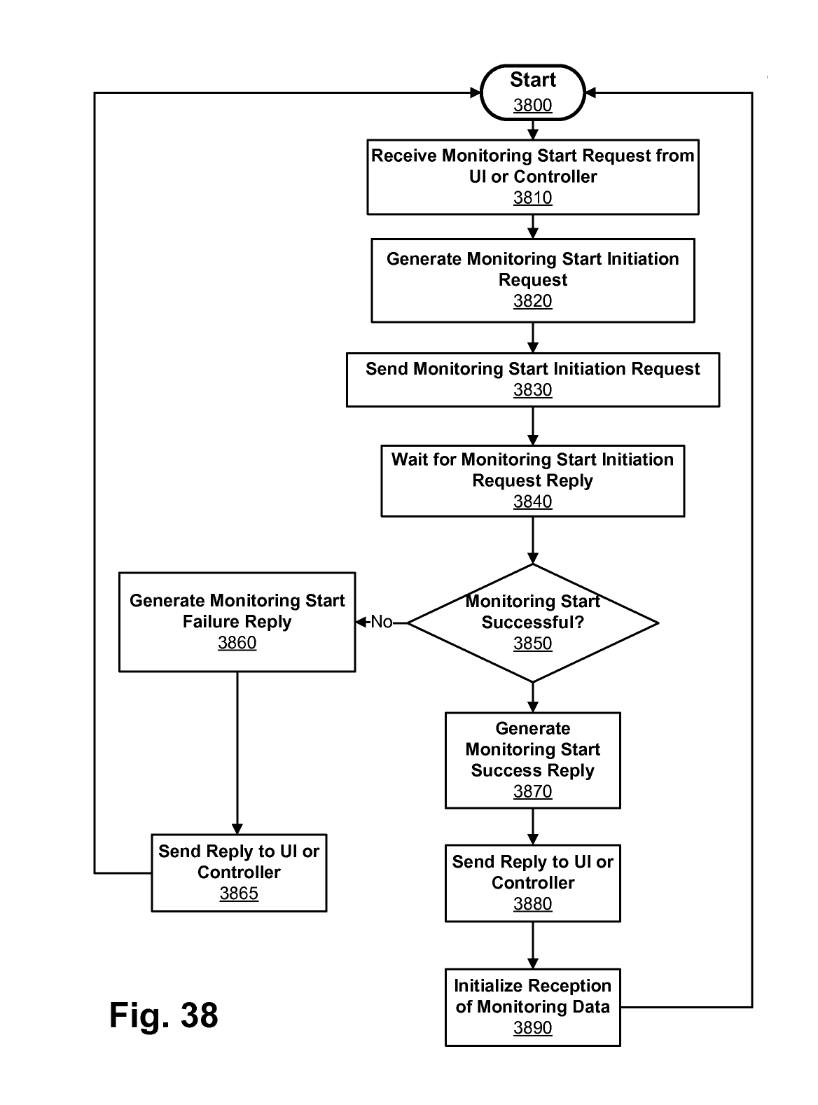

FIG. 38 shows a flow within a management application, where said flow is part of the monitoring of an application router by a management application.

The flow starts (3800) with the reception 3810 of a monitoring start request which originates in a user interface or controller. The flow then generates 3820 a monitoring start initiation request, which is subsequently sent 3830. The flow then waits 3840 for the reply to the monitoring start initiation request. Once this reply has been received, the flow determines 3850 whether the monitoring start initiation request has been successful. In the case of failure, the flow generates 3860 a monitoring start failure reply, which is subsequently sent 3865 to the UI or controller from which the monitoring start request originated. In the case of success the flow generates 3870 a monitoring start success reply. The flow then sends 3880 the generated reply to the user interface or controller from which the monitoring start request originated. After this sending, flow initializes 3890 a reception of monitoring data.

The way the determination whether a monitoring start request was successful is achieved may differ in embodiments. Such a determination may e.g. be direct, based on a value contained in the monitoring start initiation request reply. Such values may e.g. be a Boolean (where ‘true’ could indicate success) or one of a pair of strings (such as “success” and “failure”). Such a value may also take on more than two values, where e.g. multiple values could indicate failure, and provide further information about the cause of such a failure. A determination may also be made indirectly, e.g. when the reply contains data for the current state of the application router, and the management application compares this with the state the application router should have concerning aspects for which the request wanted to initiate monitoring.

It will be appreciated that an application router may not immediately initiate monitoring once it receives the data identifying the desired aspects to monitor in the monitoring start initiation request, and that a positive monitoring start initiation request reply may only indicate that the request has been received and will be processed at some point in the future, as opposed to having been denied. Cases where a monitoring is not commenced immediately may include those where starting the monitoring requires a restart of the application router.

It will further be appreciated that monitoring start failure or success reply may be sent to user interfaces or controllers other than the user interface or controller where the monitoring start request originated.

It will also be appreciated that while here a monitoring start request is shown as being received from a user interface or a controller, such a request may similarly originate within a management application, e.g. based on rules running within the application. In this case the mechanism within the management application where the request originated may receive the monitoring start failure or success reply.

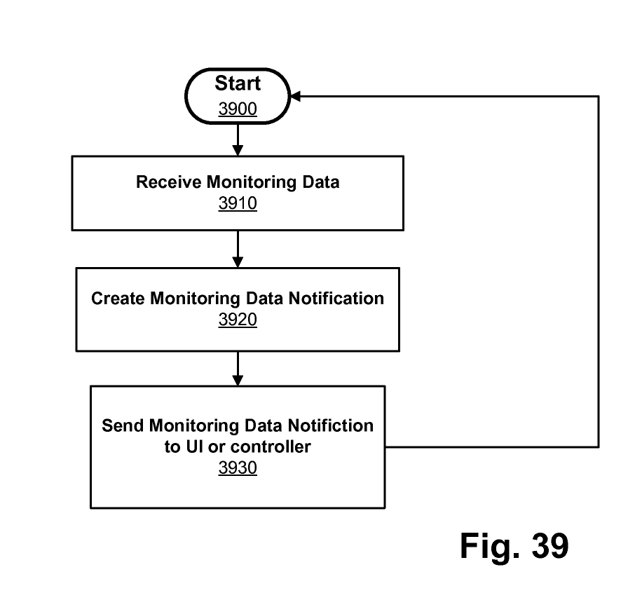

FIG. 39 shows a flow within a management application, wherein said flow is part of the handling of monitoring data by a management application. The flow starts 3900 with the reception 3910 of monitoring data. The flow then creates 3920 a monitoring data notification based on the received monitoring data. The flow then sends (3930) this monitoring data notification to one or more user interfaces or controllers.

It will be appreciated that while here the steps of creating of a monitoring data notification and the subsequent sending of this notification to one or more user interfaces or controllers are shown, additional steps may be executed by flows. Examples of these are the logging of monitoring data or the calculation of configuration changes based on the monitoring data.

It will be appreciated that the flows shown in FIGS. 38 and 39 are examples only. Various ways of implementing the functionality which the flows provide exist, and may be used in embodiments. Additionally, flows implementing the functionality may contain steps which implement additional functionality.

It will also be appreciated that the necessary steps for the monitoring of an application router, such as a monitoring start request, may be effected using various mechanisms. One such mechanism, which serves as an example only, will be described further on.

### Application of a Configuration Change

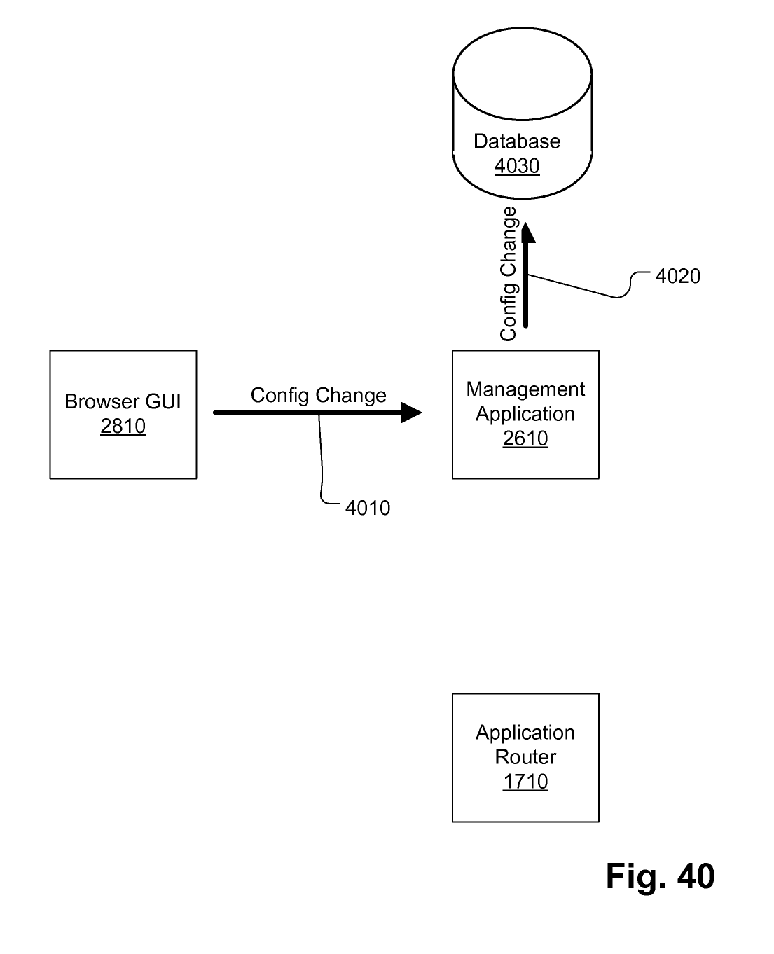

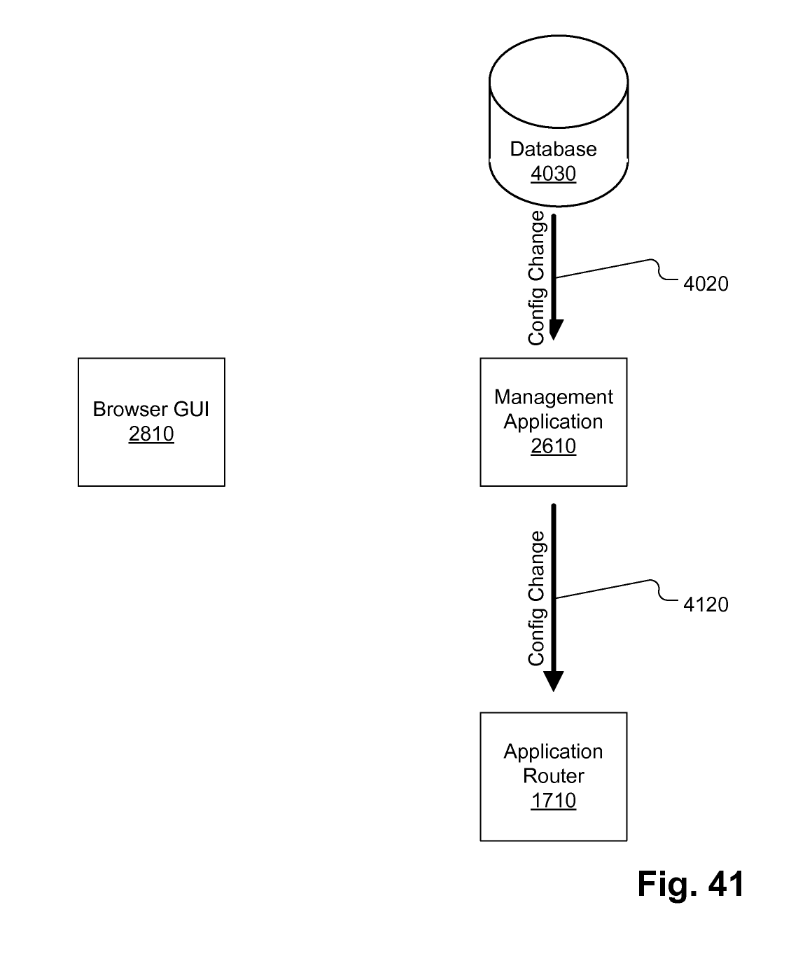

FIGS. 40 and 41 show a sequence for the application of a configuration change. A browser GUI 2810 initiates a change of the configuration of an application router 1710 by sending a configuration change set 4010 to a management application 2610. In response to this instruction, management application 2610 stores a change set 4020 in a database 4030. At a later time, management application 2610 reads change set 4020 from database 4030 and, based on this change set, sends a change set 4120 to application router 1710.

The time at which management application 2610 sends change set 4120 may be determined in various ways. Such transmission may e.g. be after an additional, explicit instruction to deploy changes made has been received from browser GUI 2810, automatically after a period for reversal of erroneous configuration changes has expired, or after a restart of application router 1710. It will be appreciated that transmission of change set 4120 can also occur simultaneously with the storing of change set 4020, or that no storing of change set 4020 may occur.

It will be appreciated that change sets 4010, 4020 and 4120 may contain different sets of information, and this information may be encoded in different formats. As an example, browser GUI may transmit only the difference between the current configuration of application router 1710 and the desired new configuration as change set 4010, while management application 2610 stores the full data for the desired configuration as change set 4020, and transmits the actual necessary changes to the configuration of 1710 at the time of the transmission to arrive at the new configuration. Change set 4010 may be transmitted e.g. via HTTP POST to management application 2610, and be encoded as JSON, while management application 2610 transmits and retrieves the information in database 4030 via a native database protocol, with the data being in plain text, and then transmits change set 4120 via WebSocket/WAMP in JSON encoding.

It will be appreciated that while here the settings are illustrated as being made via a browser GUI, settings may be made via any kind of user interface or controller in keeping with the above description.

### User Interface for Permissions

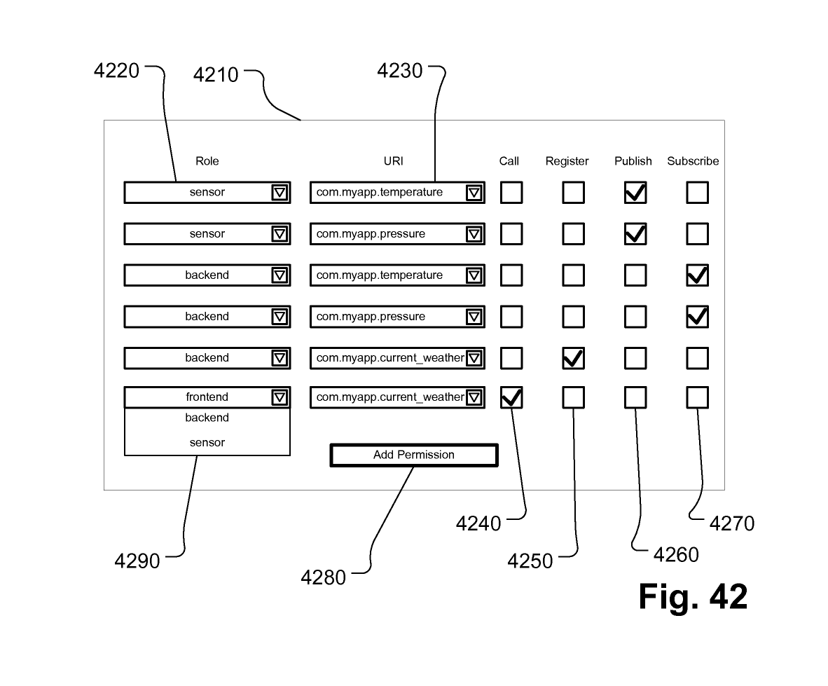

FIG. 42 illustrates a user interface for the management of permissions in an application router. Interface 4210 contains lines with elements where in each line the individual parts of a permission set are defined. Lines contains fields where the role for which a permission applies (such as 4220) and the URI to which a permission applies (such as 4230) are defined, as well as fields for the permissions regarding calling procedures (such as 4240) and registering procedures (such as 4250) using the given URI, and for the permissions regarding publishing to a topic using the given URI (such as 4260) and subscribing to such topics (such as 4270). User interface 4210 may contain additional elements, such as button 4280, which when operated adds a new, blank permission.

It will be appreciated that while here fields for the role and URI are illustrated as drop-down boxes, and fields for permission are illustrated as check boxes, other interface elements may be used for both. It will also be appreciated that while here the elements are arranged to form a single line per permission set, other arrangements are possible, e.g. only the roles could be displayed on a first level, with the URIs defined in combination with the role displayed on a second level, and the permissions for the combination or role and URI on a third level, and where the second and third level content is displayed after the selection of a respective element on the previous level.

It will further be appreciated that while here full URIs are illustrated, permissions may be based on URI pattern matching. As one example, when a URI pattern “com.myapp.*” is used, all URIs which contain “com.myapp.” as a prefix will be matched to this, e.g. “com.myapp.new_sale” and “com.myapp.new_order.product_75848” while “com.myapp2.new_sale” is not. As another example, when a URI pattern “com.myapp.client.*.new_sale” is used, all URIs which contain the above string, where “*” can be an arbitrary string, are matched, e.g. “com.myapp.client.2738.new_sale” and “com.myapp.client.checkout_1.new_sale” are matched, while “com.myapp.client_23123.new_sale” is not. It will be appreciated that other forms of URI matching may be used, e.g. more complex matching of URIs to URI patterns using regular expressions.

### Crossbar.io

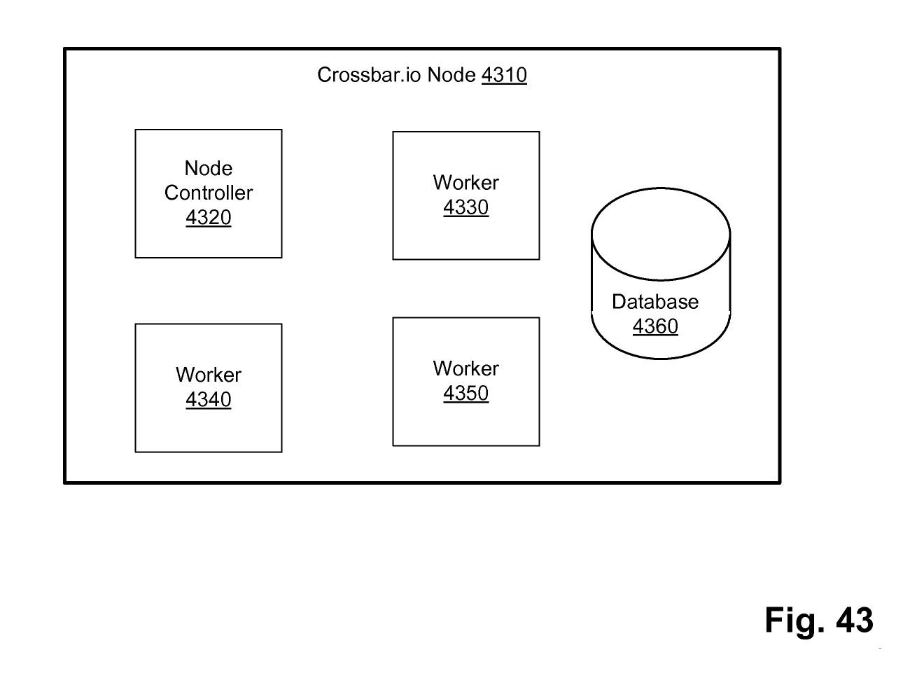

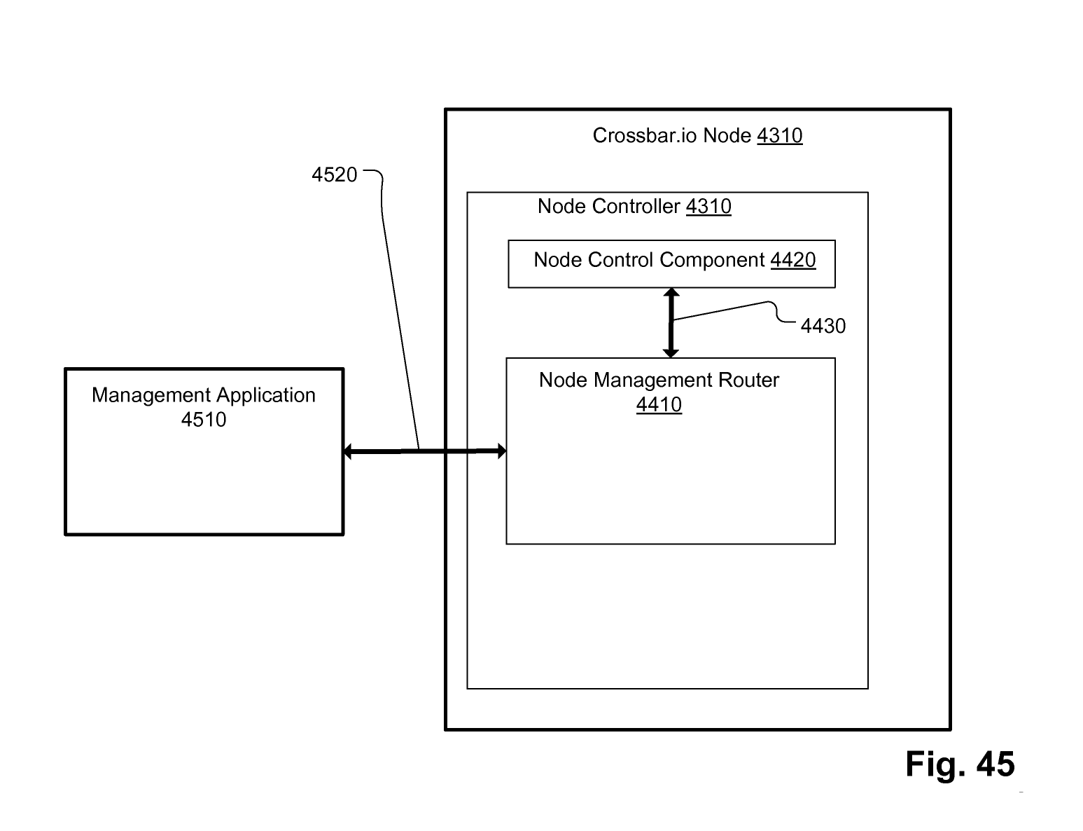

Crossbar.io is an application which comprises application router functionality. It is implemented in Python using the Twisted framework, and uses WAMP as a protocol for connections between application routers and application components. FIG. 43-52 illustrate the internal structure of embodiments of a Crossbar.io node, as well as messaging traffic which occurs in its management.

FIG. 43 is a diagram of a Crossbar.io node 4310 containing a node controller 4320, three workers (4330, 4340, 4350) and a database 4360. Each Crossbar.io node contains a single node controller. This is started on the instantiation of the Crossbar.io node. Additionally, a Crossbar.io node may contain one or more workers. Workers run in separate processes from the node controller, and the node controller manages their lifecycle, e.g. it can spawn workers and kill them.

There are two types of workers: native workers and guest workers. Native workers allow the execution of code which is written using the same technical basis as the containing node, e.g. at the time of filing Python 2.7 and the Twisted framework, and allow for deep control and integration. Guest workers are used to run code which is written using different technical bases, e.g. in an entirely different programming language (such as JavaScript, C#, C++, Objective-C, Java, PHP, Erlang), using a different version of the Python programming language, or without the use of the Twisted framework. There are less integration features for guest workers. These integration features include the node controller passing command line arguments to the code executed in the guest worker, setting the environment variables for it, passing in some initial data via the standard input, receiving the worker's standard output and errors, monitoring whether the process runs and receiving an exit code should it terminate and sending (Unix) signals to the worker.

In addition to workers, a Crossbar node may contain additional components, such as database 4360. A database, such as database 4360, may be used to store and retrieve information which is used or generated during the startup and running of the Crossbar.io node. Such information may include information on workers which are to be instantiated, connections which the node should establish to outside applications or components, logging of information on the lifecycle of workers and of messages that router workers route.

It will be appreciated that a database may be any kind of technical means which allows for the storage and retrieval of information and which has suitable technical aspects that allow the use in an embodiment. This includes databases such as SQLite, MySQL, PostgreSQL and flat files.

It will further be appreciated that while here only workers and a database are illustrated as being part of a Crossbar.io node, a Crossbar.io node may contain other functionality. This includes a Web server for static content, components for payload validation of CallReg and PubSub messages, adaptors to translate calls and messages received using other protocols or communication mechanisms to WAMP calls as well as the reverse.

It will also be appreciated that a Crossbar.io node may be implemented in various ways, e.g. it may run as a single application on a single computing device or it may be implemented in the form of components spread across several computing devices in a computing system.

### Node Controller

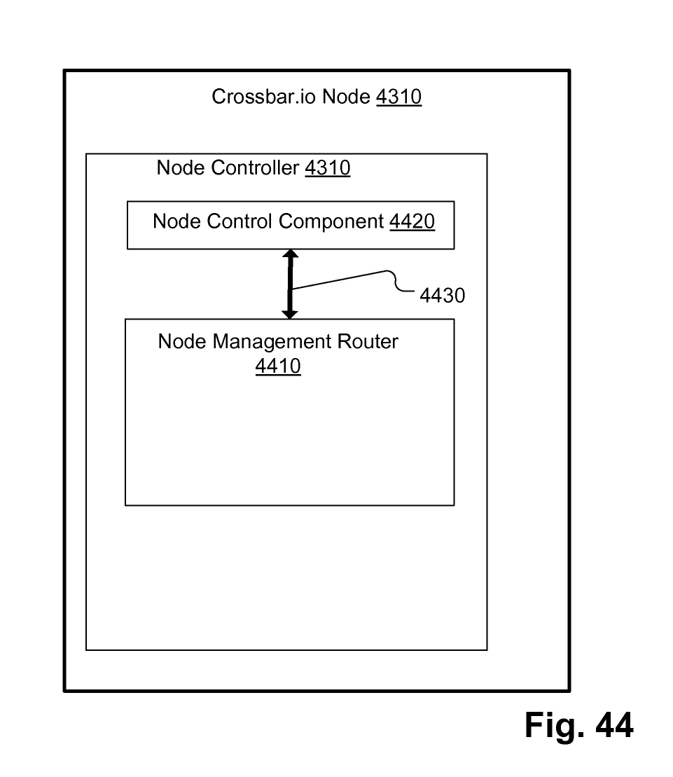

FIG. 44 illustrates the structure of a Crossbar.io node without any workers. The node comprises a Node Controller 4310. Node Controller 4310 comprises a Node Control Component 4420 and a Node Management Router 4410. The Node Controller is instantiated on startup of a Crossbar.io node, and each node contains only one Node Controller. Node Management Router 4410 is a WAMP router, and Node Controller Component 4420 connects to Node Management Router 4410 over a WAMP connection 4430. Node Controller Component 4420 then registers procedures for node management which it provides with Node Management Router 4410. It will be appreciated that from a functional view, Node Controller Component 4420 is an application component, and Node Management Router 4410 an application router.

Such procedures may include procedures for providing information about the node state, stopping the node, starting and stopping workers of different types, and providing process monitoring for workers.

It will be appreciated that when here the use of procedures which are called is described for management actions that this is by way of example only. In embodiments, management actions may be triggered by PubSub events, e.g. where the component, such as the Node Controller Component, which is to execute an action is subscribed to a specific topic for the action, and the component, such as the Management Application, is in turn subscribed to a topic for the result or error return for the action.

It will be appreciated that there are several ways in which the WAMP connection between a Node Controller Component and a Node Management Router can be established. In embodiments, this can occur via WAMP over function calls, WAMP over the system standard inputs and outputs, or WAMP over loopback TCP.

Fig. CF illustrates a management application connected to a Crossbar.io node. Management Application CF10 connects to Node Management Router 4410 within Crossbar Node 4310 via WAMP connection CF20.

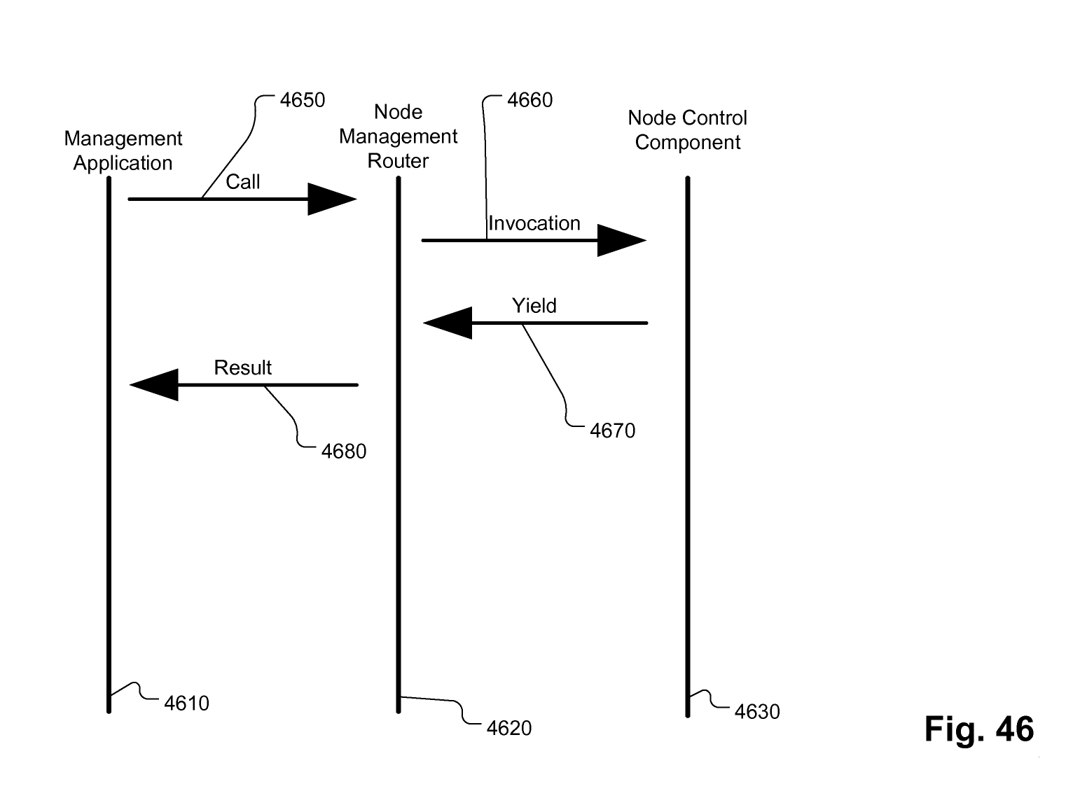

FIG. 46 is a message sequence chart illustrating a management action call from a management application to a Crossbar.io node, where the management action call is received by the Node Controller Component. Management Application 4610 issues a call 4650 for a management action. This is a WAMP call, and is received by Node Management Router 4620. Node Controller 4630 has previously registered the procedure called by Management Application 4610, so Node Management Router 4620 sends an invocation 4660 for the procedure to Node Controller Component 4630. Node Controller Component 4630 executes the procedure and, once the procedure has been completed, sends a yield 4670 with some indication that the procedure has been completed, and optionally some additional feedback to Node Management Router 4620. Node Management Router 4620 then sends result 4680 to Management Application 4610.

### Sample Wire Traffic

Following are descriptions of sample wire-level traffic between a management application and a node management router for the management actions of instantiating a native worker of type router, a native worker of type container, and a guest worker.

It will be appreciated that this wire-level traffic is given as an example only, and that the examples are chosen to illustrate the management actions which lead to the instantiation of the native workers and guest worker described further on.

### Instantiate Worker of Type Router

For the instantiation of a native worker of type router, the Management application sends
[48,8964664373280768,“crossbarnode.node1.start_router”,[“router1”,{ }],{ }]

Here the call addresses the node controller component with an ID of “node1”, and on this calls the procedure “start_router” to start a native worker of type router. It further passes some arguments to this procedure, namely the ID of the router to be instantiated (“router1”).

In embodiments, the WAMP connection between the node management router and the node control component is via function calls, so that no serialization of the WAMP calls occurs, and there is no wire-level traffic. The WAMP calls themselves which occur are an invocation and a yield.

The Management Application receives the result
[50,8964664373280768,{ },[{“status”:“started”,“started”:“2014-12-05T13:57:56.489Z”,“who”:null,“id”:“router1”}]]

which contains information about the outcome, i.e. the router has successfully been started, and additional information such as the ID of the router (which would have been auto-assigned if none had been provided in the call) and the time of the instantiation of the native worker.

### Instantiate Worker of Type Container

For the instantiation of a native worker of type container, the Management Application sends
[48,6052389431803904,“crossbar.node.node1.start_container”,[“container1”,{ }],{ }]

Here the call addresses the node controller component with an ID of “node1”, and on this calls the procedure “start_container” to start a native worker of type container. It further passes some arguments to this procedure, namely the ID of the container to be instantiated (“container”).

The WAMP connection between Node Management Router 4410 and Node Control Component 4420 is via function calls, so that no serialization of the WAMP calls occurs, and there is no wire-level traffic. The WAMP calls themselves which occur are an invocation and a yield.

The management application receives the result
[50,6052389431803904,{ },[{“status”:“started”,“started”:“2014-12-05T15:26:00.825Z”,“who”:null,“id”:“container1”}]]

which contains information about the outcome, i.e. the container has successfully been started, and additional information such as the ID of the container (which would have been auto-assigned if none had been provided in the call) and the time of the instantiation of the native worker of type container.

### Instantiate Guest Worker

For the instantiation of a guest worker, the Management Application sends
[48,6052389431803904,“crossbar.node.node1.start_guest”,[“phpworker1”,{“executable”:“php”,“arguments”:[“../client.php”]}]]

Here the call addresses the node controller component with an ID of “node1”, and on this calls the procedure “start_guest” to start a guest worker with the ID “phpworker1”. The guest worker is instantiated and a file “client.php” is executed, using the executable determined to match “php”. The executable can be given as an absolute or relative path, or be determined via the environment variables. It will be appreciated that while here the instantiation of a guest worker in which a component written in PHP is executed is described, guest workers may run components in other languages.

The WAMP connection between Node Management Router 4410 and Node Control Component 4420 is via function calls, so that no serialization of the WAMP calls occurs, and there is no wire-level traffic. The WAMP calls themselves which occur are an invocation and a yield.

The management application receives the result
[50,6052389431803904,{ },[{“status”:“started”,“started”:“2014-12-05T15:26:00.825Z”,“who”:null,“id”:“phpworker1”}]]

which contains information about the outcome, i.e. the container has successfully been started, and additional information such as the ID of the container (which would have been auto-assigned if none had been provided in the call) and the time of the instantiation of the native worker of type container.

### Native Worker of Type Router

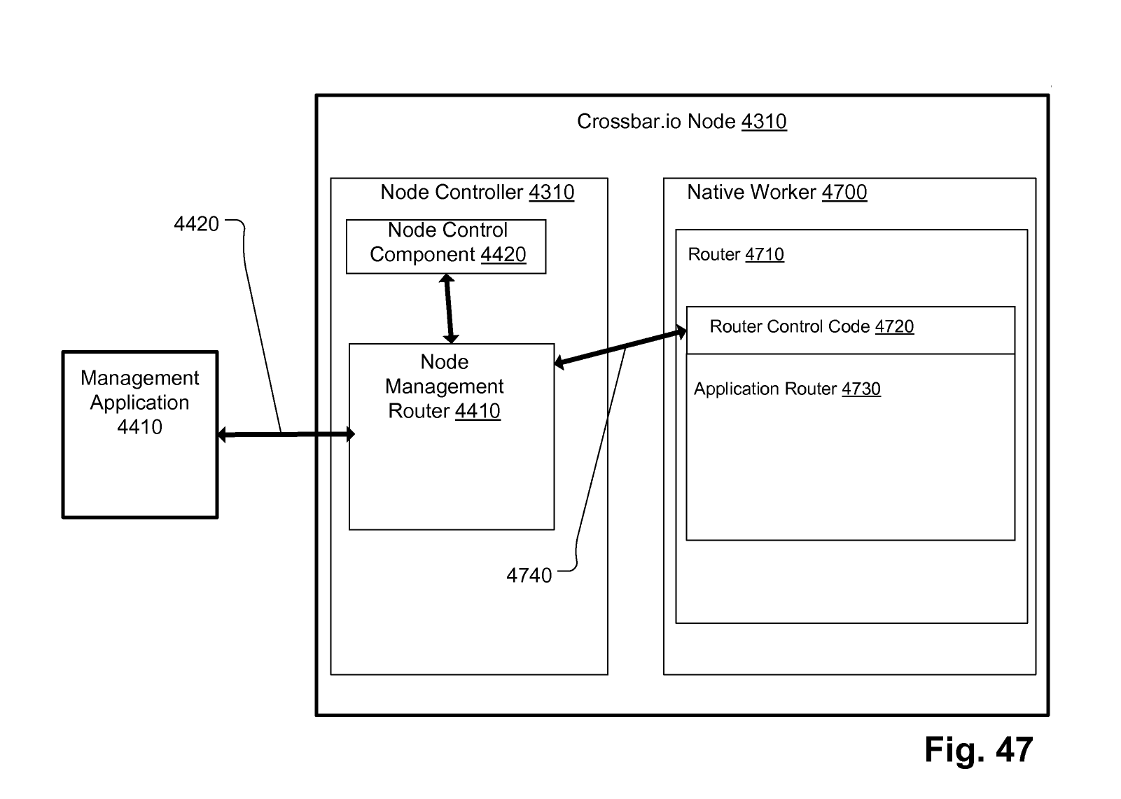

FIG. 47 illustrates a Crossbar.io node in which a native worker of type router has been instantiated. Node Controller 4310 has previously received a management instruction from Management Application 4510 which requested the instantiation of a native worker of type router. Based on this, Node Controller 4310 has instantiated the native worker of type router, Native Worker 4700. Native Worker 4700 comprises an Application Router 4730 which is coupled with Router Control Code 4720. Router Control Code 4720 connects to Node Management Router 4410 via WAMP connection 4740. It will be appreciated that on a functional level, Router Control Code 4720 here is an application component, and Node Management Router 4410 an application router.

It will be appreciated that while such instantiation of workers (native workers and guest workers) may occur based on the reception of management instructions from a management application or other component, they may equally be based on the Node Controller reading a configuration file during the startup of the Crossbar.io node, where such configuration file contains information about workers to be instantiated.

It will further be appreciated that there are several ways in which the WAMP connection between a Router Control Code and a Node Management Router can be established. In an embodiment, this occurs via the system standard inputs and outputs. Alternatively, the connection could be established via loopback TCP.

Upon its creation, Router Control Code 4720 registers procedures for management of the router which it provides with Node Management Router 4410. These procedures may include the starting and stopping of realms, of components, transports and links. Once all registrations are completed, Router Control Code 4720 notifies the Node Controller Component that it is operational, and based on this notification Node Controller Component 4420 can yield the result of the management action call which led to the instantiation of Native Worker 4700.

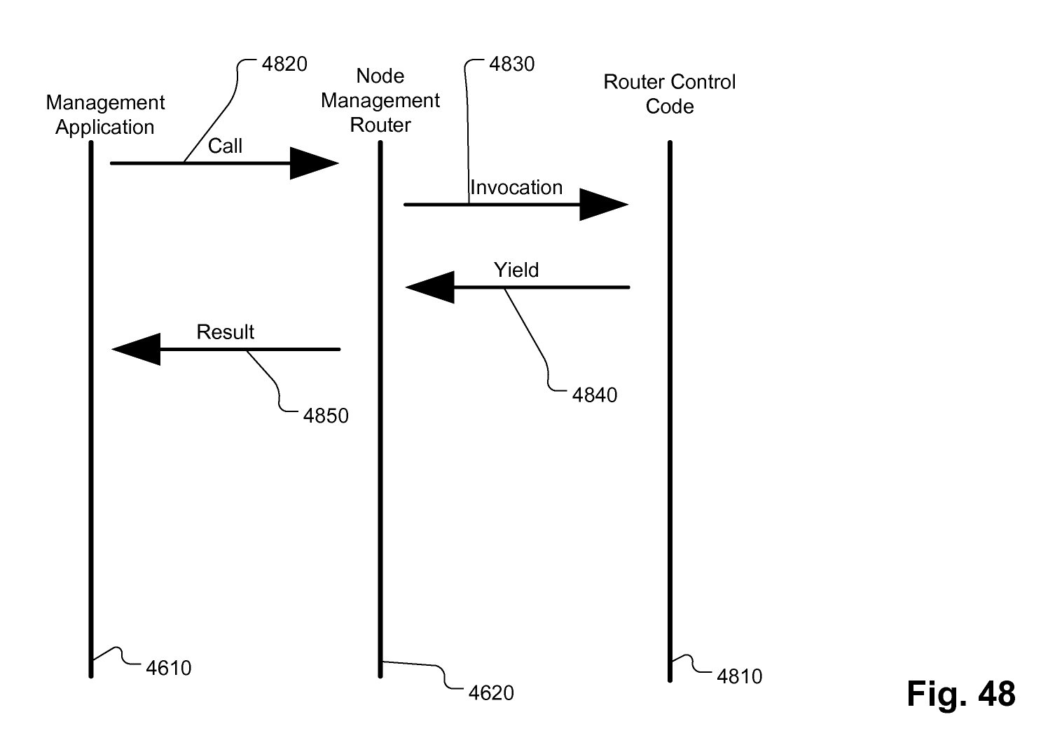

FIG. 48 is a message sequence chart illustrating a management action call from a management application to a Crossbar.io node, where the management action call is intended to effect a change in a worker router. Management Application MS10 issues a call 4820 for a management action. This is a WAMP call, and is received by Node Management Router MS20. Router Control Code 4810 has previously registered the procedure called by Management Application MS10, so Node Management Router MS20 sends an invocation 4830 for the procedure to Router Control Code 4810. Router Control Code 4810 executes the procedure and, once the procedure has been completed, sends a yield 4840 with some indication that the procedure has been completed, and optionally some additional feedback to Node Management Router MS20. Node Management Router MS20 then sends result 4850 to Management Application MS10.

### Sample Wire Traffic

Following are descriptions of wire-level traffic between a management application, a node management router and a router control code for the management action of changing a role in an application router.

For the changing of the role in the application router, the Management Application sends
[48,6052389431831783,“crossbar.node.node1.worker.router1.modify_router_realm_role_permission”,[“realm1”,“frontend”,“com.myapp.new_sale”,{“publish”:false,“subscribe”:true,“call”:false,“register”:true]]

Here the call addresses the worker with an ID of “router1” which is running as part of a Crossbar.io node with an ID of “node1”, and on this calls the procedure “modify_router_realm_role_permission” to modify an existing role in a particular realm. It further passes some arguments to this procedure, namely the name of the realm to which the role is attached (“realm1”), the name of the role to be modified (“frontend”), an URI or URI pattern, and the set of permissions for the URI pattern. In this case, publications to the URI “com.myapp.new_sale” are now not allowed for the role. It will be appreciated that the modification of a role may equally modify the permissions for an existing URI or URI pattern, or add a URI pattern.

Based on this call, the node management router issues an invocation:
[68,32523339431831000,887474837,{ },[“realm1”,“frontend”,“com.myapp.new_sale”,{“publish”:false,“subscribe”:true,“call”:false,“register”:true]]

where the integer “887474837” is the ID the node management router assigned to the procedure when the router control code previously registered the procedure.

The router control code yields:
[70, 32523339431831000,{ }]

which acknowledges the successful outcome of the modification.

The management application then receives the result
[50,6052389431831783,{ }]

which acknowledges the successful outcome of the modification.

Following are descriptions of wire-level traffic between a management application, a node management router and a router control code for the management action of starting monitoring in an application router.
[48,4738743874837487384,“crossbar.node.node1.worker.router1.set_process_stats_monitoring”, [1]]

Here the call addresses the worker with an ID of “router1” which is running as part of a Crossbar.io node with an ID of “node1”, and on this calls the procedure “set_process_stats_monitoring” to initiate the sending of process statistics for monitoring purposes. It further passes an array containing an integer. This integer determines the frequency of sending of process statistics, set in seconds. A value of “0” stops the sending.

invocation+yield

Based on this call, the node management router issues an invocation:
[68,83523189431211034,665474234,{ },[1]]

where the integer “887474837” is the ID the node management router assigned to the procedure when the router control code previously registered the procedure.

The router control code yields:

[70, 83523189431211034,{ }]

which acknowledges the successful outcome of the modification.

The management application then receives the result

[50, 4738743874837487384, { }]

which acknowledges the successful start of the monitoring.

Subsequently, the management application receives a PubSub event once every second

[36,3839893923990,88998372882992,{ }, [{“reads”:2345}]]

This is received based on a previous subscription of the management application to the topic “on_process_stats”, to which the router control code publishes, and which has been assigned the subscription ID “3839893923990”. Here the current amount of reads of the file system are shown. It will be appreciated that in embodiments other information about the state of the process may be transmitted, including the processor load, memory usage, and the type of system.

### Native Worker of Type Container

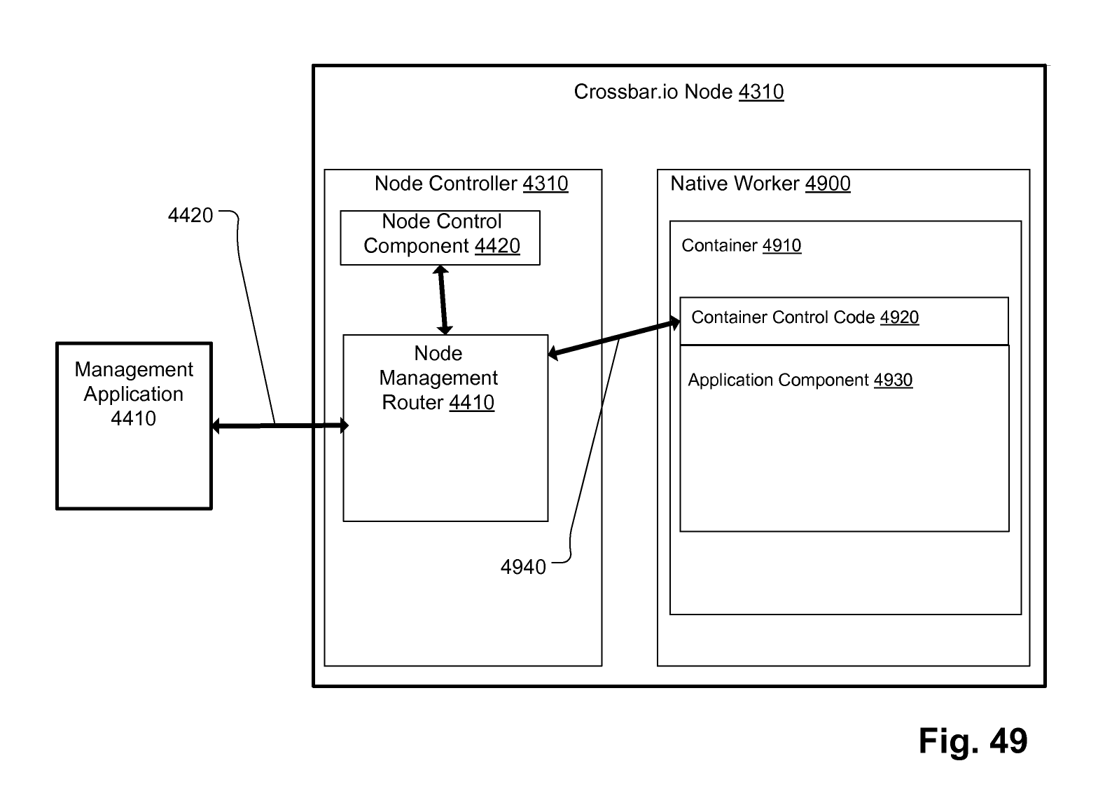

FIG. 49 illustrates the structure of a Crossbar.io node in which a native worker of type container has been instantiated. Node Controller 4310 has previously received a management instruction from Management Application 4510 which requested the instantiation of a native worker of type container. Based on this, Node Controller 4310 has instantiated the native worker of type container, Native Worker 4900. Native Worker 4900 comprises a Container 4910. Container 4910 comprises an application component 4930 which is coupled with Container Control Code 4920. Container Control Code 4720 connects to Node Management Router 4410 via WAMP connection 4940. It will be appreciated that from a functional view, Container Control Code 4720 is an application component, and Node Management Router 4410 an application router.

It will further be appreciated that there are several ways in which the WAMP connection between a Container Control Code and a Node Management Router can be established. In an embodiment, this occurs via the system standard inputs and outputs. Alternatively, the connection could be established via loopback TCP.

Upon its creation, Container Control Code 4720 registers procedures for management of the router which it provides with Node Management Router 4410. These procedures may include the starting and stopping of components.

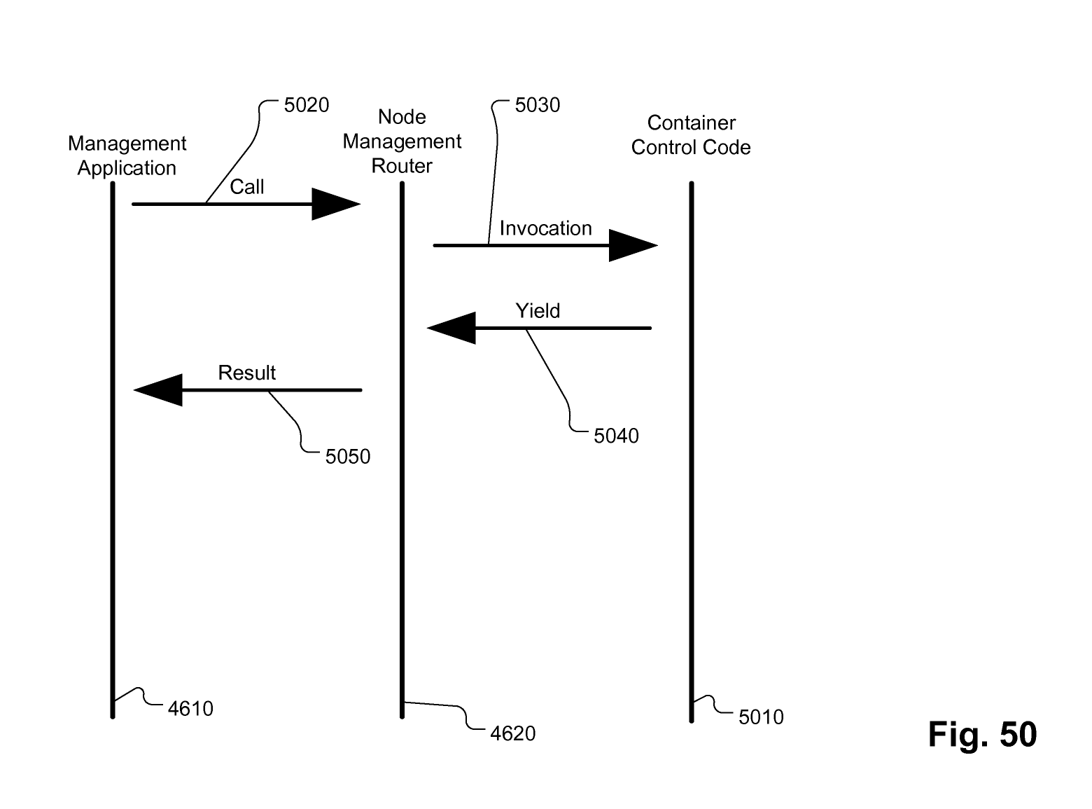

FIG. 50 is a message sequence chart illustrating a management action call from a management application to a Crossbar.io node, where the management action call is intended to effect a change in a native worker of type container. Management Application MS10 issues a call 5020 for a management action. This is a WAMP call, and is received by Node Management Router MS20. Container Control Code 5010 has previously registered the procedure called by Management Application MS10, so Node Management Router MS20 sends an invocation 5030 for the procedure to Container Control Code 5010. Container Control Code 5010 executes the procedure and, once the procedure has been completed, sends a yield 5040 with some indication that the procedure has been completed, and optionally some additional feedback to Node Management Router MS20. Node Management Router MS20 then sends result 5050 to Management Application MS10.

### Sample Wire Traffic

For a native worker of type container, monitoring can be initiated similarly to that of a native worker of type router.

### Native Worker in a Router Worker

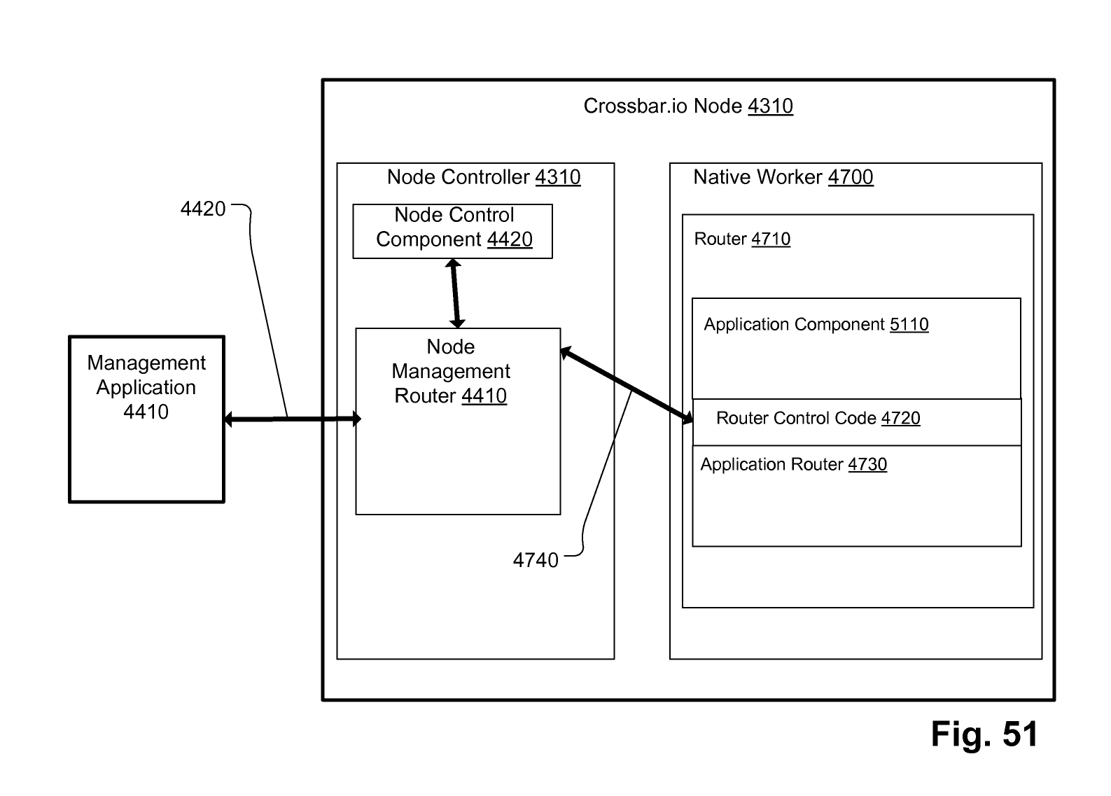

FIG. 51 is an illustration of an application component running side-by-side within a native worker of type router. Application Component 5110 could equally run within a native worker of type container, but is here run within Native Worker 4700, which is of type router. Here Router Control Code 4720 additionally fulfills the role of container control code. Just as with native workers of type container, Application Component 5110 does not itself establish a WAMP connection to Node Management Router 4410, but uses the capabilities provided by Router Control Code 4720. Additionally, Application Component 5110 establishes a WAMP connection to Application Router 4730. This WAMP connection is via function calls.

### Guest Worker

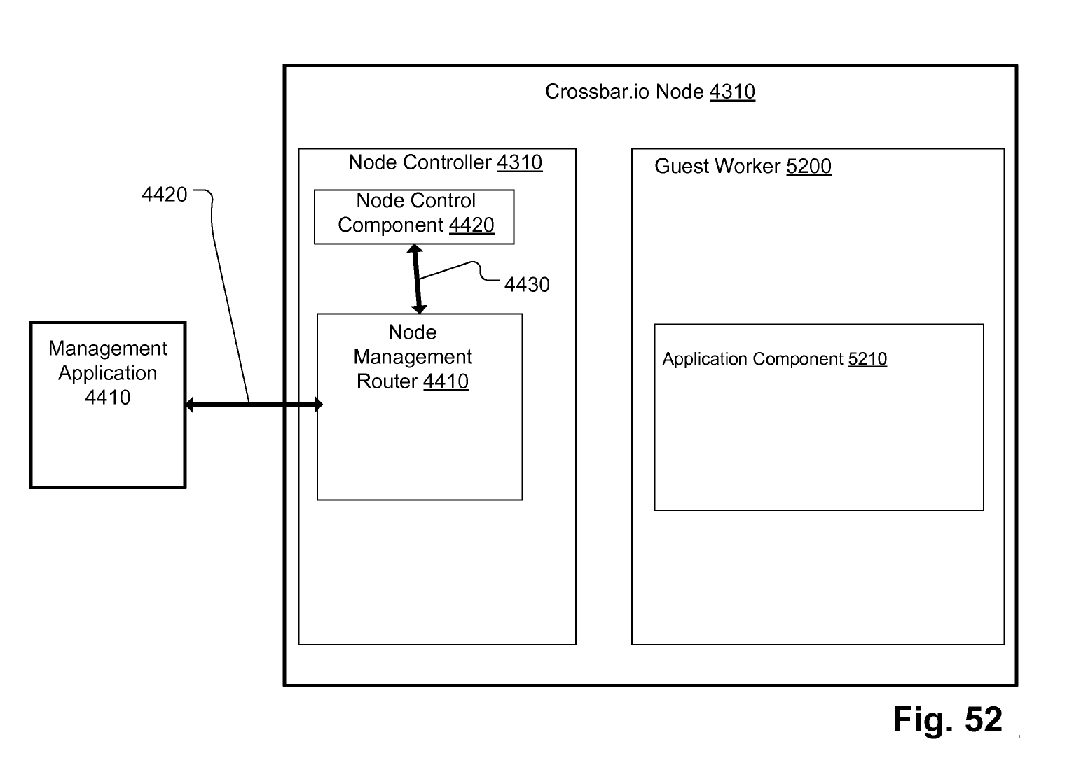

FIG. 52 illustrates the structure of a Crossbar.io node in which a guest worker has been instantiated. Node Controller 4310 has previously received a management instruction from Management Application 4510 which requested the instantiation of a guest worker. Based on this, Node Controller 4310 has instantiated the guest worker, Guest Worker 5200. Guest Worker 5200 comprises an application component 5210.

While here a guest worker is shown which runs an application component 5210 (and the connection of this application component to an application router via a WAMP connection is described further on), guest workers can be used to run any code for which there is support on the system which the node is running on, and are not limited to running application components. A guest worker may e.g. be used to run code which is part of an application's functionality without being an application component which connects via WAMP. An example of this would be a guest worker which monitors a directory to which an application component stores images, and uploads new images to a backup service.

### Alternative Connections from the Management Application

Elsewhere WAMP messages which are sent by a Management Application, for management actions executed by a Node Control Component, Router Control Code or Container Control Code, and are routed by a Node Management Router via direct WAMP connections to both the Management Application and Node Control Component, Router Control Code or Container Control Code are described. In embodiments, messages may be relayed to the intended recipient by different routes. Two such routes are described below as examples. It will be appreciated that when a Node Control Component or a Container Control Code are described as recipients and senders or messages, this is by way of example only, and that other components which register management action procedures can similarly be part of such routing.

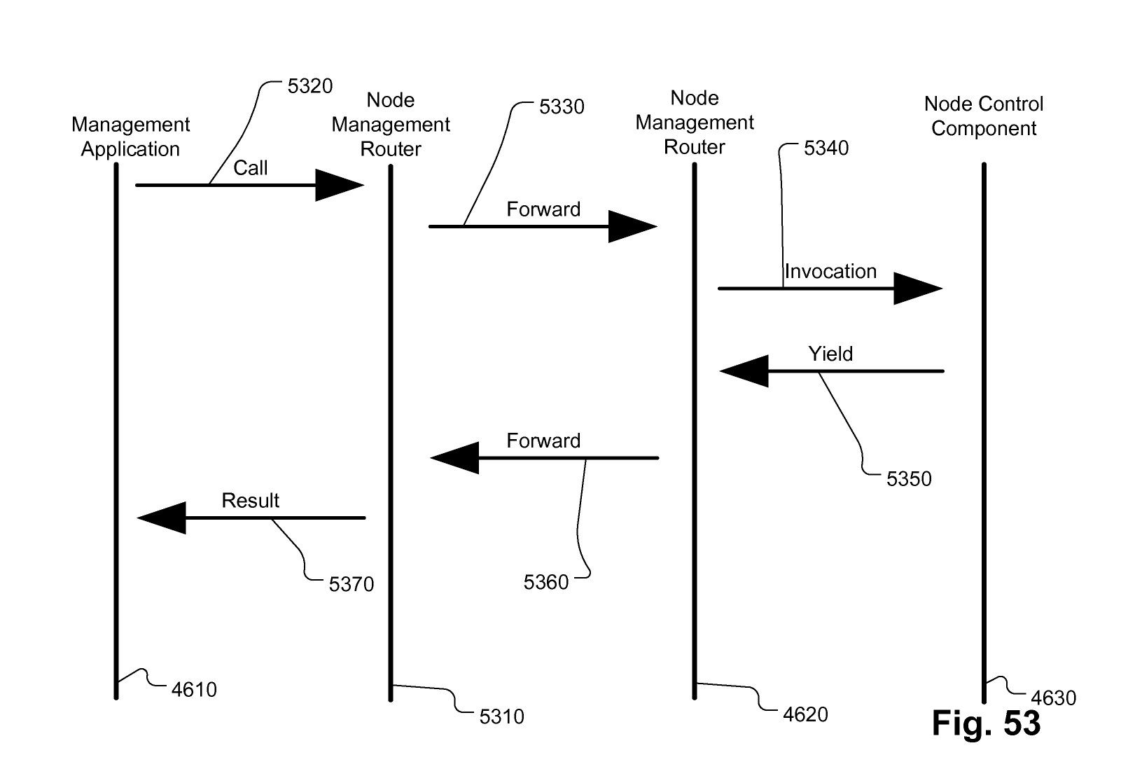

FIG. 53 is a message sequence chart illustrating a management action call from a management application for a management action which is executed by a Node Control Component. Other than in FIG. 50, there is no direct WAMP connection between Management Application MS10 and Node Management Router MS20 on which Node Control Component MS30 has registered the called procedure. Management Application MS10 is instead connected to Node Management Router 5310, and issues the call 5320 to it. Node Management Router 5310 then forwards (5330) this call to Node Management Router MS20, which in turn invokes (5340) the procedure on Node Controller MS30. The yielded result (5350) is then forwarded (5360) by Node Management Router MS20 to Node Management Router 5310, which returns the result (5370) to Management Application MS10. The forwarding occurs as a form of router-to-router messaging. Router-to-router messaging may be implemented using various mechanisms, including using a WAMP connection where the WAMP protocol may contain specific message types that effect such forwarding. Forwarding of messages may occur using various mechanisms, including wrapping all or the contents of a message, or the creation of a message which contains the contents as well as information for reconstituting the original message. While here forwarding is shown as a single additional step, it will be appreciated that forwarding may occur across multiple steps, i.e. several Node Management Routers may be involved. Various mechanisms may be employed by a Node Management Router which receives either a call which requires forwarding or a forwarded call which requires additional forwarding (since there is no registration for the called procedure with the Node Management Router itself) to determine which Node Management Router or Routers to forward a call to. Such mechanisms may include forwarding the call to all connected Node Management Routers, or to use previously established routing table information.

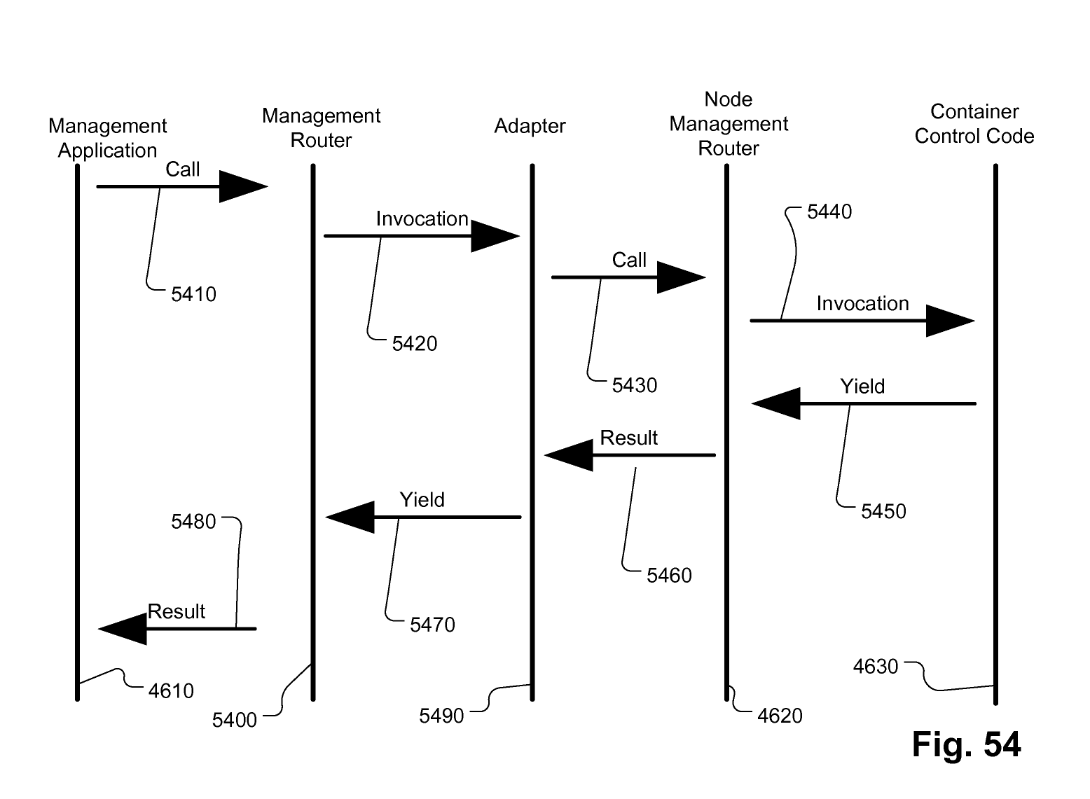

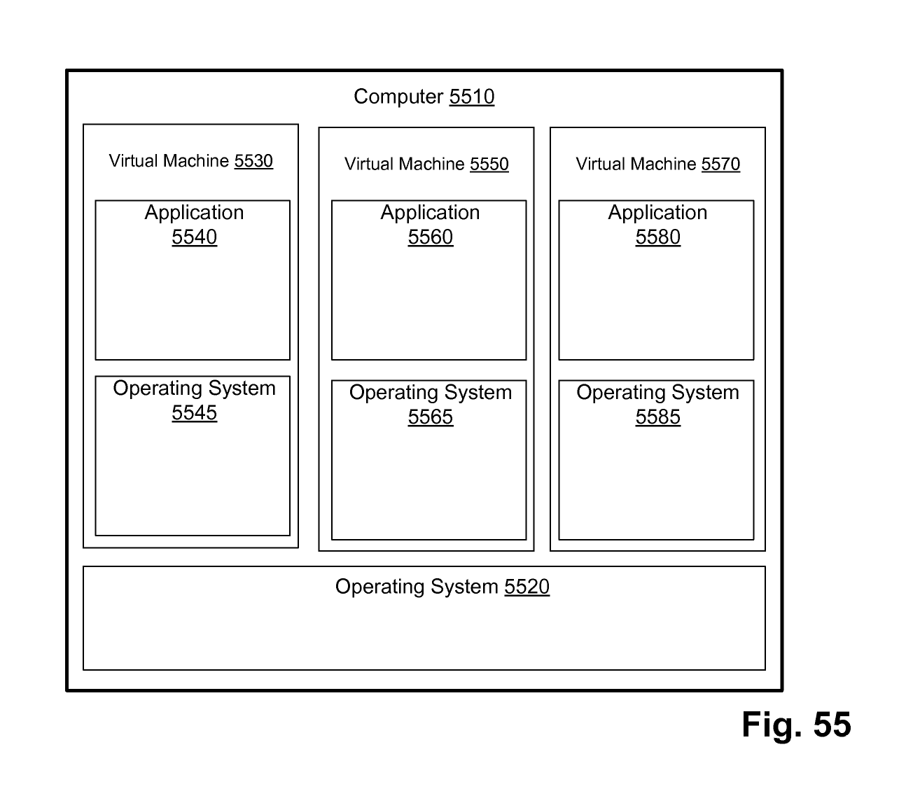

FIG. 54 is a message sequence chart illustrating a management action call from a management application for a management action which is executed by a Container Control Code. Other than in Fig. Mu, there is no direct WAMP connection between Management Application MS10 and Node Management Router MS20 on which Container Control Code MS30 has registered the called procedure. Management Application MS10 and Container Control Code MS30 are connected to different WAMP routers, Management Router 5400 and Node Management Router MS20 respectively. Adapter 5490 is connected to both WAMP routers as a WAMP client. When Container Control Code MS30 initially registered the called procedure, Adapter 5490 received notification of this, and in turn registered the called procedure with Management Router 5400. Management Application MS10 issues the call to Management Router 5400. Management Router 5400 invokes (5420) the procedure on Adapter 5490. In reaction to the received invocation 5420, Adapter 5490 issues a call 5430 to Node Management Router MS20, where said call is identical in content to call 5410. Node Management

Router MS20 invokes (5440) the procedure on Node Controller MS30. Node Controller MS30 yields (5450) the result, which Node Management Router MS20 sends (5460) to Adapter 5490. Adapter 5490 then yields (5470) the received result (MS60) to Management Router 5400, which sends (5480) the result to Management Application MS10. In embodiments, Adapters such as Adapter 5490 may be implemented as part of a Crossbar.io node. Adapters may further be technically implemented in a single component together with a Node Controller Component.

It will be appreciated that here management of Crossbar.io, both regarding the configuration and the monitoring, via WAMP is shown as an example embodiment. Management of application routers, including Crossbar.io, may alternatively or additionally be via other protocols, where these other protocols may implement both Call-and-Register and Publish-and-Subscribe patterns.

### Containerization

Traditionally, applications have run on hardware computing systems, with an operating system providing fundamental system functionality. Fig. OC is a diagram of applications running in virtual machines. With virtual machines, such as virtual machines 5530, 5550 and 5570, a computing system is emulated, and the full stack of software, i.e. an operating system (5545, 5565, 5585) and an application (5540, 5560, 5580), are run within the emulated computing system. There are various ways in which virtual machines can be implemented on a computing system such as computer OC10. These range from the emulation of an entire computing system as it is visible to the software within the virtual machine to solutions where there is mediated access to the actual underlying hardware. An operating system, such as Operating System 5520, on which virtual machines run, can be an operating system used for other purposes, such as MICROSOFT WINDOWS® or Linux, or a specialized system solely intended for the running of virtual machines (which may be referred to as a bare-metal hypervisor). The operating system which is run within a virtual machine can differ from that which is run on the computing system the virtual machine is run on.

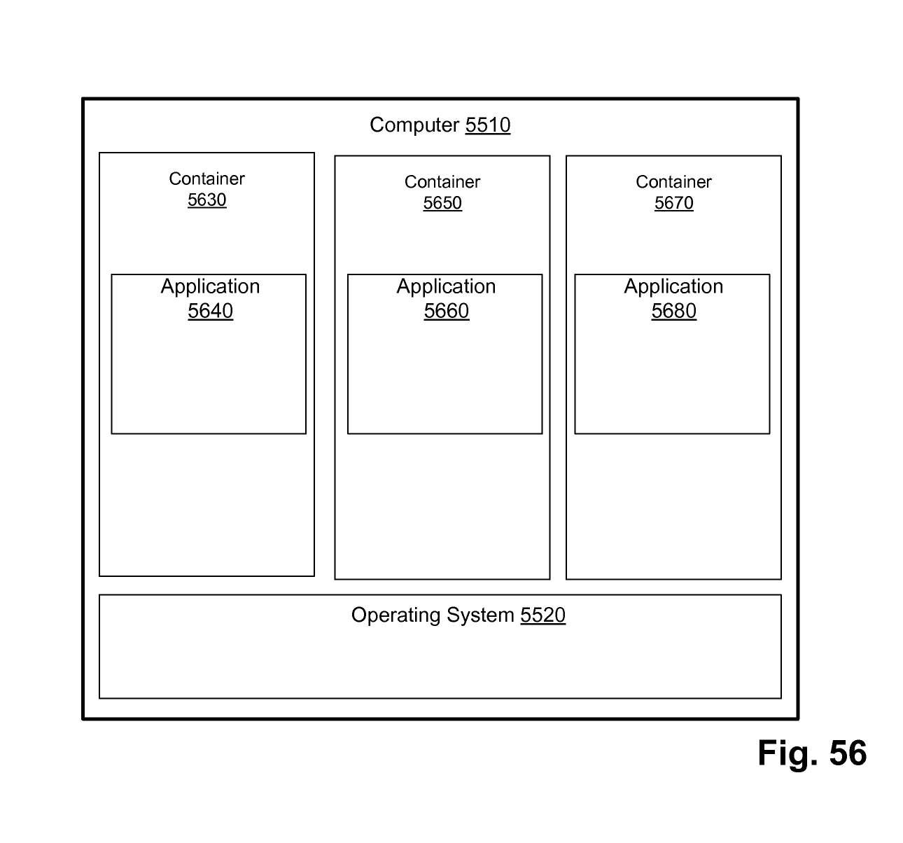

FIG. 56 is a diagram of applications running in containers. With containers, there is no emulation of a computing system. Within containers such as containers 5630, 5650 and 5670 software such as applications 5640, 5660 and 5680 access the underlying operating system (such as 5520) and computing system (such as OC10). The containers provide isolation such that software running in one container cannot interact or interfere with software running in another container. Additionally, containers may provide for further differences between them, such as different stacks of dependencies, e.g. different versions of a system library. There are various ways in which containerization can be implemented, and various degrees to which the isolation can be implemented. Implementations in use include FreeBSD jails and Docker containers.

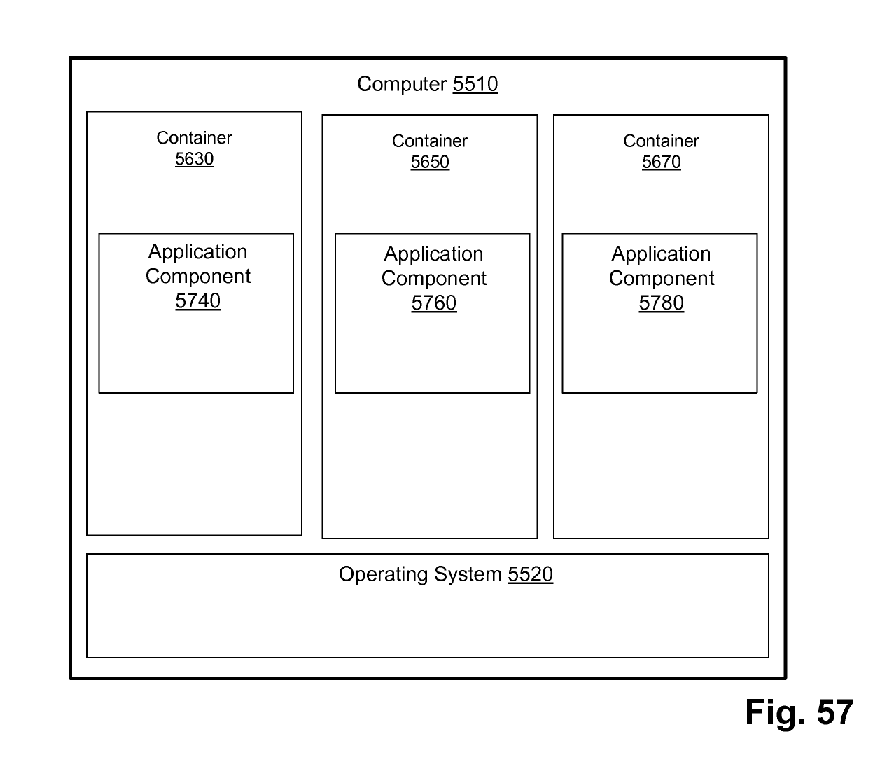

FIG. 57 is a diagram of application components running in containers. Here application components 5740, 5760 and 5780 run in a container each (5630, 5650, 5670). This allows e.g. to run an application component 5740 which may require Python 2.7 to be run on the same system as application component 5760 which may require Python 3.3.

It will be appreciated that application components such as the illustrated ones running in containers on a single computing system may belong to a single application or to multiple applications. It will further be appreciated that any types of application components, including application components running directly on operating systems, application components running in virtual machines, application components running in containers and application components implemented directly on a computing system may be combined within an application.

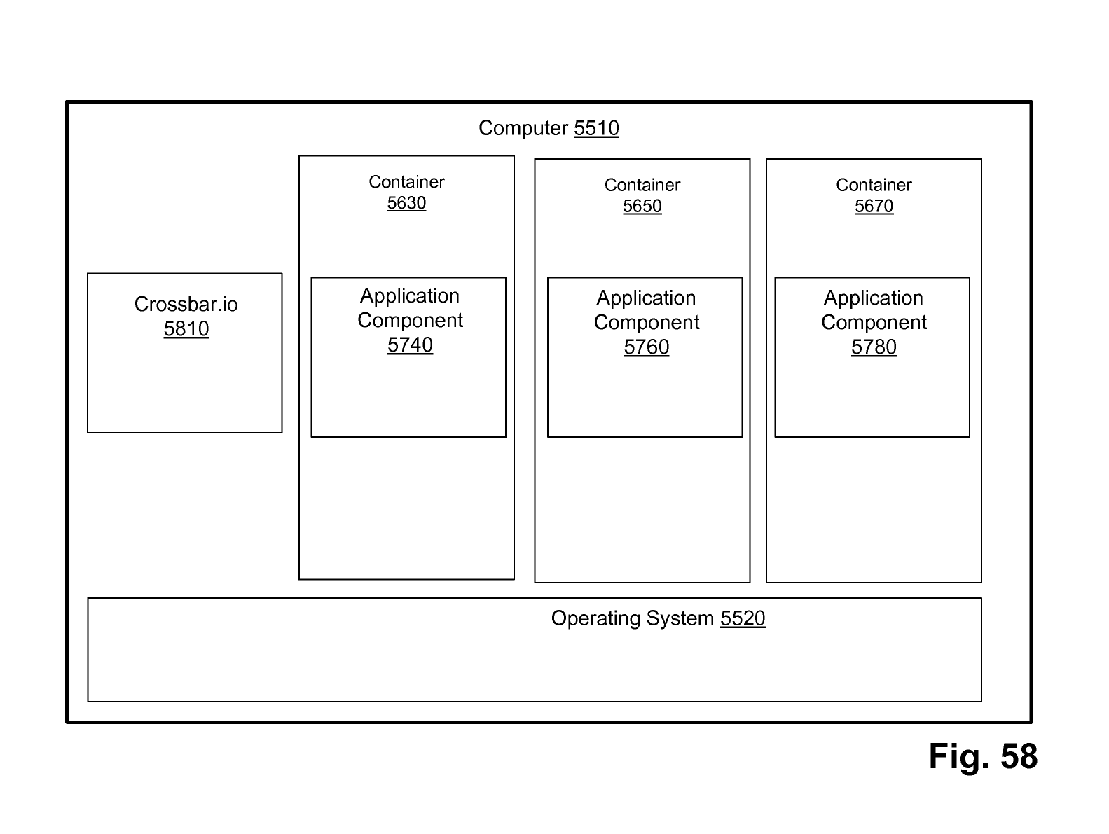

FIG. 58 is a diagram of Crossbar.io running on a computing system with application components running inside containers. A Crossbar.io node 5810 runs on computing system OC10. This Crossbar.io node router the WAMP messages for application components, such as application components 5740, 5760, 5780. Additionally, Crossbar.io node 5810 may be able to manage application components and containers. Similarly to instantiating a guest worker, Crossbar.io node 5810 may be able to instantiate a container, and launch an application component 5740 within it. This may extend to additional setup within the container, e.g. installing and configuring dependencies for the application component.

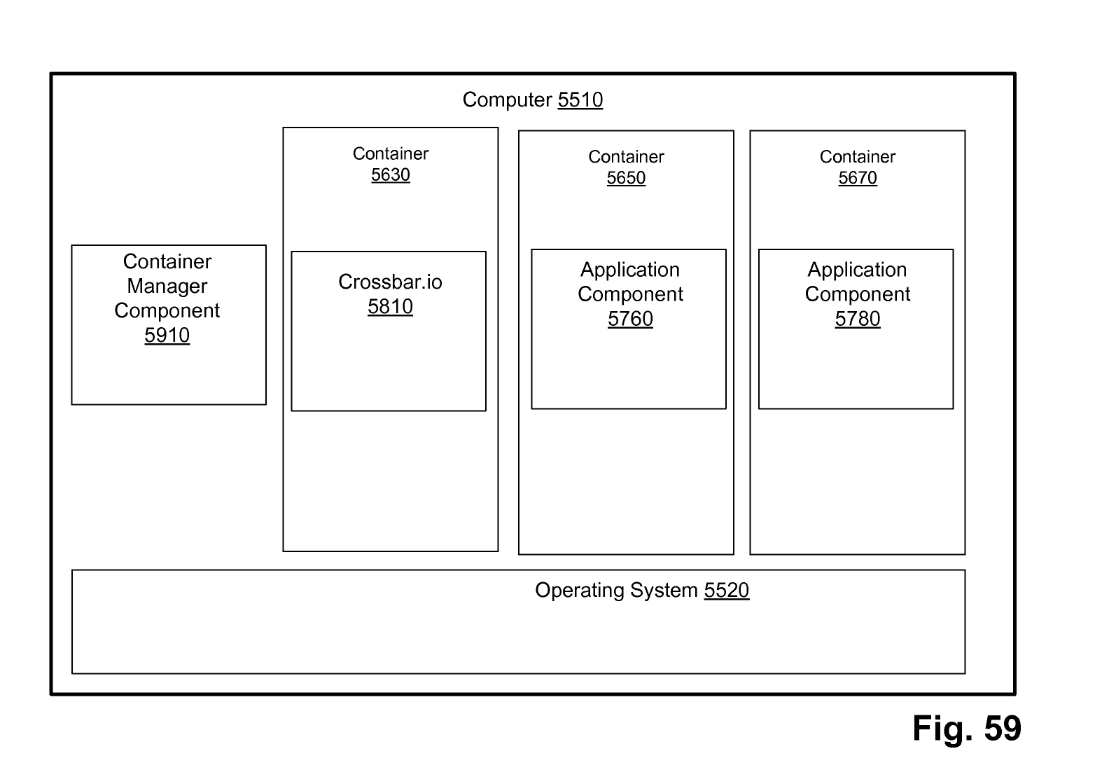

FIG. 59 is a diagram of a Crossbar.io node and application components running inside containers, with a container management component running directly within the computing system. Here Container Management Component 5910 is a WAMP client and connected to Crossbar.io node 5810 running in container 5630. The connection is not with an application router running inside node 5810, but with the node management controller. Here Container Management Component 5910 handles the instantiations of containers and the launching of application components. It will be appreciated that a container management component such as Container Management Component 5910 and a Crossbar.io node which it is connected to need not run on the same computing system, that a single Crossbar.io node may be connected to several container manager components on several computing systems, and that a single container management component may be connected to several Crossbar.io nodes.

### Workers Connecting to an Application Router

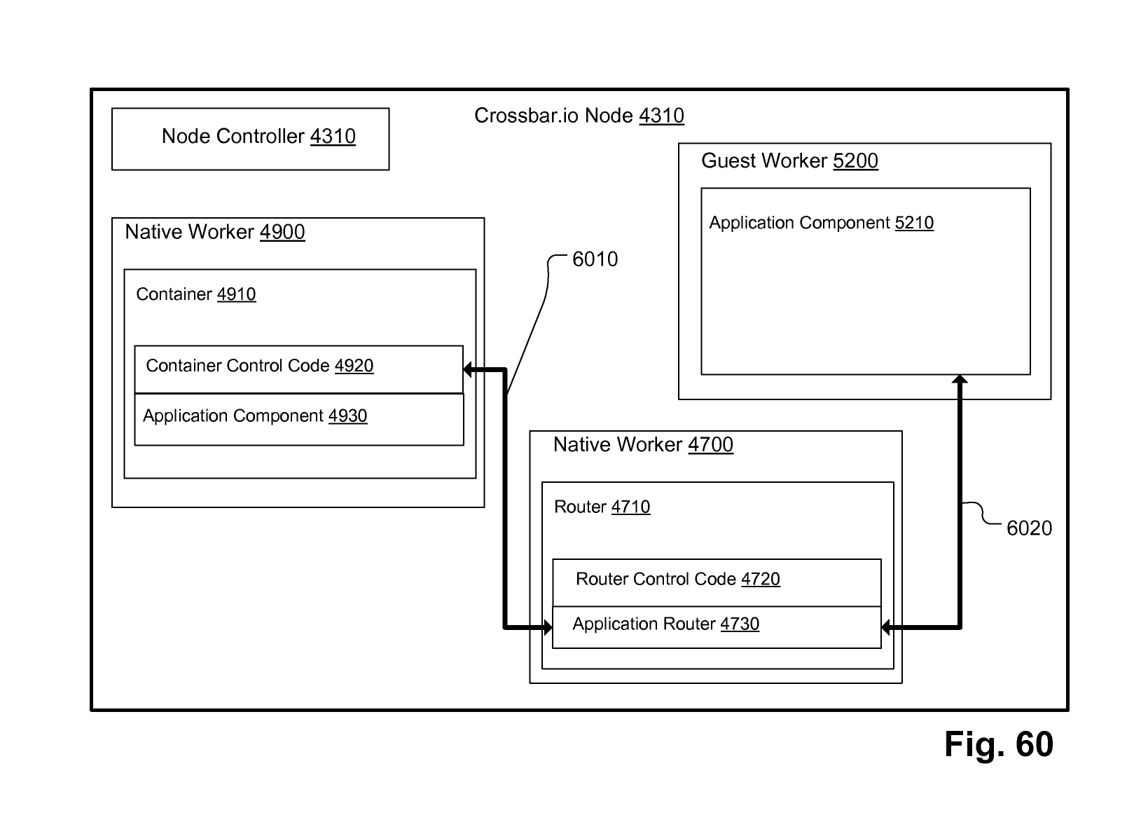

FIG. 60 illustrates WAMP connections from a native worker of type container and a guest worker to an application router running in a native worker of type router. Both Application Component 4930 running in Native Worker 4900 and Application Component 5210 running in Guest Worker 5200 form part of applications whose application messaging occurs via WAMP.

Application Component 5210 connects to Application Router 4730 via a WAMP connection 6020. Application Component 5210 contains the necessary code to establish such a connection and to create and process WAMP messages. This support will usually be provided by a library that fits the used technology, e.g. AutobahnJS for application components written in JavaScript and running on Node.js, but can be implemented in the application component itself.

Application Component 4930 does not connect directly to Application Router 4730. Container Control Code 4920 both establishes a WAMP connection 6010 to the Node Management Router, and provides the functionality to establish WAMP connections and create and process WAMP messages to Application Component 4930. The WAMP connection which connects Application Component 4930 to Application Router 4730 is thus established via Container Control Code 4920.

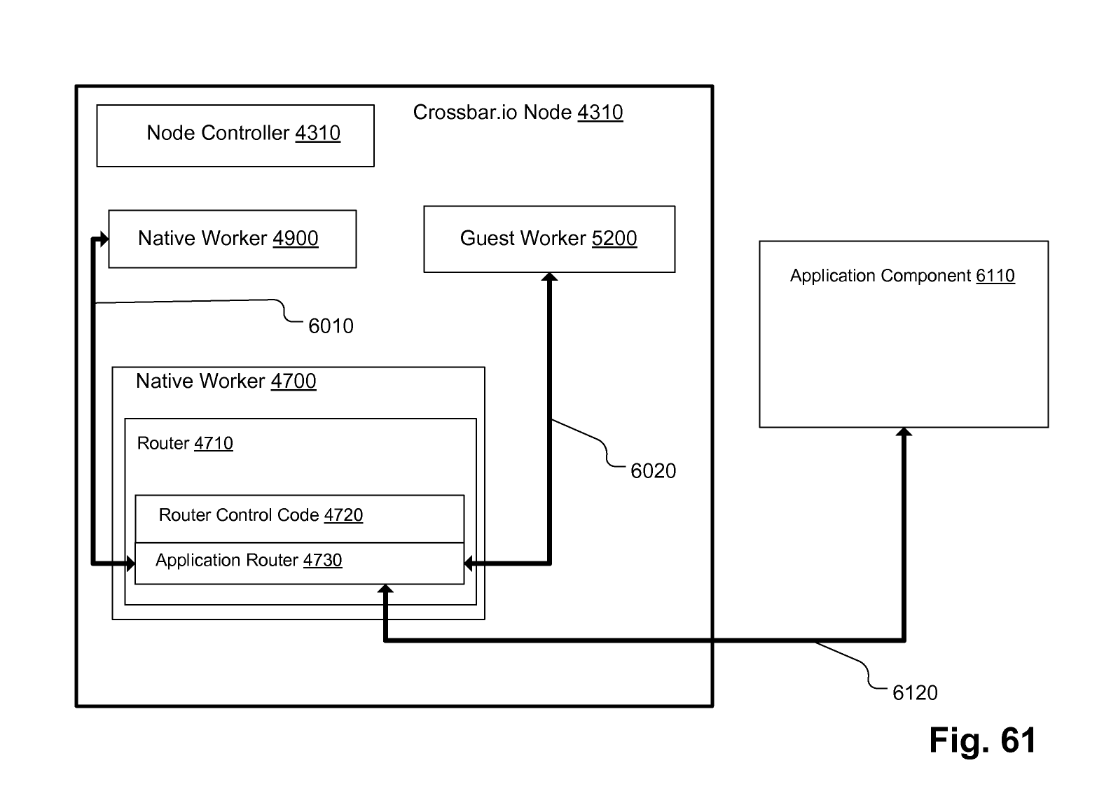

FIG. 61 illustrates an additional connection from an application component running externally to a Crossbar.io node to an Application Router 4730 within the Crossbar.io node. The connections from Native Worker 4900 and Guest Worker 5200 to Application Router 4730 remain as in FIG. 60, but internal details of the two former components have been omitted for reasons of space. Application Component 6110 connects to Application Router 4730 via a WAMP connection 6120. Application Component 6110 may be implemented in various ways, e.g. it may be implemented as code running directly on an embedded device without a separate operating system, may be a program running on a separate computing system to the one the Crossbar.io instance is running on, may be a program running on the same computing system as the Crossbar.io instance. Application Component 6110 may also form a part of a larger application.

### Configuration File

As previously mentioned, in addition to configuration by a management application via messages, a Crossbar.io node can be configured at startup by reading a configuration file. Changes to this configuration file only take effect when the file is next processed, i.e. at the next start of the node. Configuration changes via the configuration file thus require a restart of the node. As a convention, the configuration file is located in a subdirectory “.crossbar” of the Crossbar.io node base directory. If no argument containing the location of a specific Crossbar.io configuration file is passed when Crossbar.io is started, Crossbar.io searches the current working directory for this “.crossbar” subdirectory and uses a configuration file “config.json” if found therein.

Below is a sample configuration file, as well as some sample parts of configuration files.

```
{
  “controller”: {
  },
  “workers”: [
  ]
}
```

The configuration file has two main sections: configuration data for the node controller and for any workers.

A sample configuration for a controller may look like:

```
“controller”: {
    “id”: “node1”,
    “transport”: {
      “type”: “websocket”,
      “endpoint”: {
        “type”: “tcp”,
        “port”: 9000
      }
    }
}
```

Here a node name which can be used to distinguish between several nodes is given, and a transport is initiated. The node controller can receive and send management messages via the transport. Here the transport is of type WebSocket, and uses TCP as the underlying transport protocol for the WebSocket messages, with the TCP connection using port 9000.

A sample configuration for a native worker of type router could be:

```
“workers”: [
    {
      “type”: “router”,
      “realms”: [
        {
          “name”: “realm1”,
          “roles”: [
            {
              “name”: “anonymous”,
              “permissions”: [
                {
                  “uri”: “*”,
                  “publish”: true,
                  “subscribe”: true,
                  “call”: true,
                  “register”: true
                }
              ]
            }
          ]
        }
      ],
      “transports”: [
        {
          “type”: “web”,
          “endpoint”: {
            “type”: “tcp”,
            “port”: 8080
          },
          “paths”: {
            “/”: {
              “type”: “static”,
              “directory”: “..”
            },
            “ws”: {
              “type”: “websocket”
            }
          }
        }
      ]
    }
  ]
```

The workers configuration is an array, which here contains a single dictionary containing the configuration of a native worker of type router. For a router, a realm or realms need to be defined. Each connection from a WAMP client is attached to a realm. A realm defines a routing context, i.e. messages are only routed within a realm. A WAMP client may establish several connections to an application router, where these connections may be attached to different realms. For each realm, roles are defined. A WAMP client authenticates for a role, and permissions are defined for roles. Here a single role is defined, “anonymous”, which applies to all non-authenticated clients. The permissions on roles are based on URIs which identify the WAMP message. Here the wildcard “*” means that all URIs are matched, and all four WAMP actions, i.e. publishing, subscribing, registering and calling, are permitted. Effectively, this means that any WAMP client connecting to this router can act without any limitations. In deployment situations, more restrictive role definitions may be applied, e.g.

“roles”: [

```
  {
    “name”: “frontent”,
    “permissions”: [
      {
        “uri”: “com.myapp.new_sale ”,
        “publish”: true,
        “subscribe”: false,
        “call”: false,
        “register”: false
      }
    ]
  }
]
```

where a client which was authenticated as role “frontend” would only be allowed to publish to the topic “com.myapp.new_sale”. Such a client could not subscribe to any topic, and would thus not be able to receive events on “com.myapp.new_sale”.

In addition to the realm, a transport is defined. There are various types of transports. Here, one of type “web” is defined. This transport uses TCP as the transport layer, and works on port 8080. A web transport allows for multiple paths, which are accessed via HTTP URL components. Here a first path “/” is defined, which is accessed by any HTTP request to the IP of the machine on which the node runs, except for requests where the path is “web”. The configuration defines that for “/”, static Web content is to be served, and that the directory to serve this from is the base directory for the Crossbar.io node. For the “ws” path, a WebSocket can be accessed, and this allows WAMP clients to establish a WAMP over WebSocket connection to the router over the same transport on which Web content is served.

A WebSocket transport could also be defined separately:

```
{
  “type”: “websocket”,
  “endpoint”: {
    “type”: “tcp”,
    “port”: 8080
  }
}
```

It will be appreciated that additional options may be set up for a WebSocket transport, e.g. options concerning the specifics of the WebSocket protocol, such as a maximum frame size may be set. It will further be appreciated that a WebSocket transport could equally be configured to use Unix Domain Sockets as the transport layer.

It will be appreciated that other options may be configured for transports which use TCP as the transport layer, for example TLS encryption could be set up.

A configuration for a RawSocket transport could be

```
{
  “type”: “rawsocket”,
  “serializer”: “msgpack”,
  “endpoint”: {
    “type”: “unix”,
    “path”: “/tmp/mysocket1”
  }
}
```

This configuration uses Unix Domain Sockets as the transport layer, and defines msgpack as the serializer for the messages. For a WebSocket transport, the definition of a serializer is not required, since here a negotiation for supported serializers may take place.

A sample configuration for a native worker running side-by-side in the router could be

```
{
      “type”: “router”,
      “options”: {
        “pythonpath”: [“..”]
      },
      “components”: [
        {
          “type”: “class”,
          “realm”: “realm1”,
          “classname”: “hello.MySession”
        }
      ],
      // ... rest of router configuration ...
    }
```

Here the a Python class “MySession” in the file “hello” situated in the node root directory is executed side-by-side with the router code, i.e. as part of the same system process. This class is automatically connected to the router and this connection is attached to realm “realm1”. It will be appreciated that additional configuration options may be set, e.g. a role for which the component is to be authenticated, or optional data to be passed to the class on instantiation.

A configuration for a native worker of type container could be

```
{
        “type”: “container”,
        “options”: {
          “pythonpath”: [“..”]
        },
        “components”: [
          {
            “type”: “class”,
            “classname”: “hello.hello.AppSession”,
            “realm”: “realm1”,
            “transport”: {
              “type”: “websocket”,
              “endpoint”: {
                “type”: “tcp”,
                “host”: “127.0.0.1”,
                “port”: 8080
            },
            “url”: “ws://127.0.0.1:8080/ws”
          }
        }
      ]
    }
```

Here a class “AppSession” in the file “hello” in the subdirectory “hello” of the node root directory is instantiated. A connection to a router at “ws://127.0.0.1:8080/ws” over a WebSocket transport is established, and the connection is attached to realm “realm1”. Here the router is a router which is run within the same Crossbar.io node as the container, but it will be appreciated that a connection could similarly be established to a router running on a different node.

A configuration for a guest worker written in JavaScript and running under Node.js could be

```
{
      “type”: “guest”,
      “executable”: “node”,
      “arguments”: [“backend.js”],
      “options”: {
        “workdir”: “../node”,
        “watch”: {
          “directories”: [“../node”],
          “action”: “restart”
        }
      }
    }
```

Here the code contained in a file “backend.js” in the subdirectory “node” of the Crossbar.io node base directory is executed using Node.js. The executable for Node.js is inferred by Crossbar.io via the system environment variable for “node”, but may equally be set as a relative or absolute path which applies on the particular system the Crossbar.io node is run on. Additionally, here a watcher for the “node” directory is started, which restarts the code if a change to the file is detected.

A configuration for a guest worker written in PHP could be

```
{
    “type”: “guest”,
    “executable”: “php”,
    “arguments”: [“../client.php”]
  }
```

Here the code container in the file “client.php” in the Crossbar.io node base directory is executed using an installed PHP.

It will be appreciated that the features of Crossbar.io whose configuration is discussed in connection with configuration files can equally be configured by a management application.

### Management API Overview

A sample, non-exhaustive overview for a management API for management messages is listed below. This lists procedures which a management application can call, events to which a management application may subscribe, as well as error messages that may occur.

Controller
----------
Event: crossbar.on node ready
Procedure: crossbar.node.<node_id>.get_info
Procedure: crossbar.node.<node_id>.shutdown

Worker Information
Procedure: crossbar.node.<node_id>.get_workers
Procedure: crossbar.node.<node_id>.get_worker_log

Worker Control
Procedure: crossbar.node.<node_id>.start_router
Procedure: crossbar.node.<node_id>.stop_router
Procedure: crossbar.node.<node_id>.start_container
Procedure: crossbar.node.<node_id>.stop_container
Procedure: crossbar.node.<node_id>.start_guest
Procedure: crossbar.node.<node_id>.stop_guest

Basic
Procedure: crossbar.node.<node_id>.utcnow
Procedure: crossbar.node.<node_id>.started
Procedure: crossbar.node.<node_id>.uptime

Python—Garbage Collector
Procedure: crossbar.node.<node_id>.trigger_gc

Process Information
Procedure: crossbar.node.<node_id>.get_process_info
Error: crossbar.Error:.feature_unavailable

Process Statistics
Procedure: crossbar.node.<node_id>.get_process_stats
Error: crossbar.Error:.feature_unavailable
Procedure: crossbar.node.<node_id>.set_process_stats_monitoring
Error: crossbar.Error:.feature_unavailable
Event: crossbar.node.<node_id>.on_process_stats_monitoring_set
Event: crossbar.node.<node_id>.on_process_stats

Manhole
Procedure: crossbar.node.<node_id>.start_manhole
Error: crossbar.Error:.feature_unavailable
Error: crossbar.Error:.already_started
Error: crossbar.Error:.invalid_configuration
Error: crossbar.Error:.cannot_listen
Event: crossbar.node.<node_id>.on_manhole_starting
Event: crossbar.node.<node_id>.on_manhole_started
Procedure: crossbar.node.<node_id>.stop_manhole
Error: crossbar.Error:.feature_unavailable
Error: crossbar.Error:.not_started
Event: crossbar.node.<node_id>.on_manhole_stopping
Event: crossbar.node.<node_id>.on_manhole_stopped
Procedure: crossbar.node.<node_id>.get_manhole
Error: crossbar.Error:.feature_unavailable

Native Workers
----------
Event: crossbar.node.<node_id>.on_worker_ready

Basic
Procedure: crossbar.node.<node_id>.worker.<worker_id>.utcnow
Procedure: crossbar.node.<node_id>.worker.<worker_id>.started
Procedure: crossbar.node.<node_id>.worker.<worker_id>.uptime

Python Garbage Collector
Procedure: crossbar.node.<node_id>.worker.<worker_id>.trigger_gc

Python Path
Procedure: crossbar.node.<node_id>.worker.<worker_id>.get_pythonpath
Procedure: crossbar.node.<node_id>.worker.<worker_id>.add_pythonpath
Error: crossbar.Error:.invalid_argument
Event: crossbar.node.<node_id>.worker.<worker_id>.on_pythonpath_add

Process Information
Procedure: crossbar.node.<node_id>.worker.<worker_id>.get_process_info
Error: crossbar.Error:.feature_unavailable

Process Statistics
Procedure: crossbar.node.<node_id>.worker.<worker_id>.get_process_stats
Error: crossbar.Error:.feature_unavailable
Procedure: crossbar.node.<node_id>.worker.<worker_id>.set_process_stats_monitoring
Error: crossbar.Error:.feature_unavailable
Event: crossbar.node.<node_id>.worker.<worker_id>.on_process_stats_monitoring_set
Event: crossbar.node.<node_id>.worker.<worker_id>.on_process_stats

Process Control

CPU Affinity
Procedure: crossbar.node.<node_id>.worker.<worker_id>.get_cpu_affinity
Error: crossbar.Error:.feature_unavailable
Error: crossbar.Error:.runtime_Error:
Procedure: crossbar.node.<node_id>.worker.<worker_id>.set_cpu_affinity
Error: crossbar.Error:.feature_unavailable
Error: crossbar.Error:.runtime_Error:
Event: crossbar.node.<node_id>.worker.<worker_id>.on_cpu_affinity_set

Manhole
Procedure: crossbar.node.<node_id>.worker.<worker_id>.start_manhole
Error: crossbar.Error:.feature_unavailable
Error: crossbar.Error:.already_started
Error: crossbar.Error:.invalid_configuration
Error: crossbar.Error:.cannot_listen
Event: crossbar.node.<node_id>.worker.<worker id>.on_manhole_starting
Event: crossbar.node.<node_id>.worker.<worker_id>.on_manhole_started
Procedure: crossbar.node.<node_id>.worker.<worker_id>.stop_manhole
Error: crossbar.Error:.feature_unavailable
Error: crossbar.Error:.not_started
Event: crossbar.node.<node_id>.worker.<worker_id>.on_manhole_stopping
Event: crossbar.node.<node_id>.worker.<worker_id>.on_manhole_stopped
Procedure: crossbar.node.<node_id>.worker.<worker_id>.get_manhole
Error: crossbar.Error:.feature_unavailable

Routers
----------

Realms
Procedure: crossbar.node.<node_id>.worker.<worker_id>.get_router_realms
Procedure: crossbar.node.<node_id>.worker.<worker_id>.start_router_realm
Procedure: crossbar.node.<node_id>.worker.<worker_id>.stop_router_realm

Components
Procedure: crossbar.node.<node_id>.worker.<worker_id>.get_router_components
Procedure: crossbar.node.<node_id>.worker.<worker_id>.start_router_component
Procedure: crossbar.node.<node_id>.worker.<worker_id>.stop_router_component

Transports
Procedure: crossbar.node.<node_id>.worker.<worker_id>.get_router_transports
Procedure: crossbar.node.<node_id>.worker.<worker_id>.start_router_transport
Procedure: crossbar.node.<node_id>.worker.<worker_id>.stop_router_transport

Links
Procedure: crossbar.node.<node_id>.worker.<worker_id>.get_router_links
Procedure: crossbar.node.<node_id>.worker.<worker_id>.start_router_link
Procedure: crossbar.node.<node_id>.worker.<worker_id>.stop_router_link

Containers
----------

Components
Procedure: crossbar.node.<node_id>.worker.<worker_id>.get_container_components
Procedure: crossbar.node.<node_id>.worker.<worker_id>.start_container_component
Procedure: crossbar.node.<node_id>.worker.<worker_id>.stop_container_component

### Source Code for Crossbar.io

The source code for Crossbar.io is included with this filing in a file “crossbario_source_code.txt”. This file was created Dec. 19, 2014, and has a size of 683,866 bytes. Multiple source files have been combined into this single file. The contents of each original source file are prefixed with the file name and path in the source code folder structure, e.g. “_init_.py” indicates that the contents of a file “_init_.py” in the root folder are subsequently listed, while with “common\process.py” the source file “process.py” was located in the “process” subfolder of the root folder. A series of dashes (“----------”) has been added above and below the file name to ease readability. The majority of the files is in the Python programming language, which is indicated by the suffix “.py” to the respective file names. Other programming languages or file formats are indicated by the respective file name suffixes, e.g. “.js” for JavaScript files and “.html” files for HTML files. The contents of the above text file are hereby incorporated by reference into this specification.

1. A computing device, comprising:
one or more processors, a memory coupled to the one or more processors, and a network interface coupled to the one or more processors, the memory storing instructions that, when executed by the one or more processors, cause the one or more processors to send and receive messages over the network interface,
wherein said messages include
messages that initiate a management operation on an application router
messages that provide feedback on a management operation on an application router,
wherein said messages conform to a protocol which allows for
registering procedures,
calling procedures,
subscribing to topics and
publishing to topics
wherein said messages may be transmitted over a single transport,
and wherein said application router provides
routing of procedure calls by an application component to one or more application components which have previously registered the procedure, and returning of the result to the calling application component; and
dispatching events published by an application component to a topic to one or more application components which have previously subscribed to said topic.

2. The computing device of claim 1, wherein said protocol is used for messages between the application router and application components.

3. The computing device of claim 2, where the protocol is WAMP.

4. The computing device of claim 1, where access to said device is offered as a cloud service.
